(19) United States
(12) Patent Application Publication
(10) Pub. No.: US 2023/0299362 A1
(43) Pub. Date: Sep. 21, 2023

(54) ELECTROLYTE COMPOSITIONS FOR LITHIUM-ION BATTERY CELLS WITH ANODES COMPRISING A BLEND OF SILICON-CARBON COMPOSITE PARTICLES AND GRAPHITE PARTICLES

(71) Applicant: Sila Nanotechnologies, Inc., Alameda, CA (US)

(72) Inventors: Kostiantyn TURCHENIUK, Oakland, CA (US); Natasha TERAN, San Leandro, CA (US); William GENT, San Francisco, CA (US); Xiujun YUE, Redwood City, CA (US); Katherine HARRY, San Francisco, CA (US); Viacheslav IABLOKOV, Alameda, CA (US); Naoki NITTA, Alameda, CA (US); Gleb YUSHIN, Atlanta, GA (US)

(21) Appl. No.: 18/185,207

(22) Filed: Mar. 16, 2023

Related U.S. Application Data
(60) Provisional application No. 63/269,571, filed on Mar. 18, 2022.

(51) Int. Cl. H01M 10/0569; H01M 10/0525

(52) U.S. Cl. CPC H01M 10/0569; H01M 10/0525; H01M 2300/004; H01M 2300/0034

(57) ABSTRACT

An electrolyte for a lithium-ion battery includes a primary lithium salt and a solvent composition. In some implementations, the solvent composition includes fluoroethylene carbonate (FEC), at least one linear ester, and at least one branched ester. In some implementations, a mole fraction of the FEC in the electrolyte is in a range of about 2 mol. % to about 30 mol. %, a total mole fraction of the at least one linear ester and the at least one branched ester in the electrolyte is at least about 45 mol. %, a molar ratio of the at least one linear ester to the at least one branched esters is in a range of about 1:10 to about 20:1, and the electrolyte is substantially free of four-carbon cyclic carbonates. Lithium-ion batteries employing such electrolytes are also disclosed.

### CROSS-REFERENCE TO RELATED APPLICATIONS

The present application for patent claims the benefit of U.S. Provisional Application No. 63/269,571, entitled “ELECTROLYTE COMPOSITIONS FOR LITHIUM-ION BATTERY CELLS WITH ANODES COMPRISING A BLEND OF SILICON-CARBON COMPOSITE PARTICLES AND GRAPHITE PARTICLES,” filed Mar. 18, 2021, assigned to the assignee hereof, and expressly incorporated herein by reference in its entirety.

### BACKGROUND

### Field

Aspects of the present disclosure relate generally to energy storage devices, and more particularly to battery technology and the like.

### Background

Owing in part to their relatively high energy densities, relatively high specific energy, light weight, and potential for long lifetimes, advanced rechargeable batteries are desirable for a wide range of consumer electronics, electric vehicle, grid storage and other important applications.

However, despite the increasing commercial prevalence of batteries, further development of these batteries is needed, particularly for applications in low- or zero-emission, hybrid-electrical or fully electric vehicles, consumer electronics, wearable devices, energy-efficient cargo ships and locomotives, drones, aerospace applications, and power grids. In particular, further improvements are desired for various rechargeable batteries, such as rechargeable Li and Li-ion batteries, rechargeable Na and Na-ion batteries, and rechargeable K and K-ion batteries, to name a few.

A broad range of electrolyte compositions may be utilized in the construction of Li and Li-ion batteries and other metal and metal-ion batteries. However, for improved cell performance (e.g., low and stable resistance, high cycling stability, high-rate capability, good thermal stability, long calendar life, etc.), the optimal choice of electrolyte needs to be developed for specific types and specific sizes of active particles in both the anode and cathode, specific total battery cell capacities as well as the specific operational conditions (e.g., temperature, charge rate, discharge rate, voltage range, capacity utilization, etc.). In many cases, the choice of electrolyte components and their ratios is not trivial and may be counterintuitive.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries. Unfortunately, Li and Li-ion battery cells with such anodes and conventional electrolytes often require the use of such large amounts of conventional solid-electrolyte interphase (SEI)-building additives to maintain acceptable cycle stability that prevents their use at elevated or low temperatures or undesirably limits their calendar life or does not allow such cells to be charged to high voltages (e.g., above about 4.1-4.3 V). Performance of such battery cells may become particularly poor when the cells are charged to above about 4.3-4.4 V and even more so when the cells are charged to above about 4.5 V. Higher cell voltage, broader operational temperature window, and longer cycle life, however, are advantageous for most applications. Such cells may suffer from excessive capacity degradation (e.g., above about 5%), large volume expansion (e.g., above about 10%) and significant gassing (e.g., above about 10% thickness change) when exposed to high temperatures (e.g., above about 50-90° C.) in a fully charged state (e.g., state-of-charge, SOC of about 90-100%) for a prolonged time (e.g., about 12-168 hours). Passing such elevated temperature charging tests is required for most applications. Performance of such cells may also become particularly poor when the anode capacity loading (areal capacity) becomes moderate (e.g., about 2-4 mAh/cm2) and even more so when the areal capacity becomes high (e.g., about 4-12 mAh/cm2). Higher capacity loading, however, is advantageous for increasing cell energy density and reducing cell manufacturing costs.

In certain types of rechargeable batteries, charge storing anode materials may be produced as high-capacity (nano)composite powders (e.g., at least partially comprised of active material nanomaterials or nanostructures), which exhibit moderately high volume changes (e.g., about 8-180 vol. %) during the first charge-discharge cycle and moderate volume changes (e.g., about 5-50 vol. %) during the subsequent charge-discharge cycles. A subset of such charge-storing anode particles may include anode particles with an average size (e.g., diameter or thickness) in the range of about 0.2 to about 40 microns (micrometers). Such a class of charge-storing particles offers great promises for scalable manufacturing and achieving high cell-level energy density and other performance characteristics. Unfortunately, such particles are relatively new and their use in cells using conventional electrolytes may result in relatively poor cell performance characteristics and limited cycle stability. Performance of such battery cells may become particularly poor when the cells are charged to above about 4.1-4.3 V, more so when the cells are charged to above about 4.3-4.4 V and even more so when the cells are charged to above about 4.5 V. Higher cell voltage, broader operational temperature window and longer cycle life, however, are advantageous for most applications. Such cells may suffer from excessive capacity degradation (e.g., above about 5%), large volume expansion (e.g., above about 10%) and significant gassing when exposed to high temperatures (“high-temperature outgassing”) (e.g., about 50-90° C. or higher) in a fully charged state (e.g., state-of-charge, SOC, of about 90-100%) for a prolonged time (e.g., about 12-168 hours). Passing such elevated temperature charging tests is required for most applications. Cell performance may also become particularly poor when the high-capacity (nano)composite anode capacity loading (areal capacity) becomes moderate (e.g., about 2-4 mAh/cm2) and even more so when the areal capacity becomes high (e.g., about 4-12 mAh/cm2). Higher capacity loading, however, is advantageous for increasing cell energy density and reducing cell manufacturing costs. Similarly, cell performance may degrade when the porosity of such an anode (e.g., the volume occupied by the spacing between the (nano)composite active anode particles in the electrode and filled with electrolyte, exclusive of closed pores, if any, within the particles themselves that are inaccessible to electrolyte) becomes moderately small (e.g., about 25-35 vol. % after the first charge-discharge cycle) and more so when the porosity of the anode becomes small (e.g., about 5-25 vol. % after the first charge-discharge cycle) or when the amount of a binder and conductive additives in the electrode becomes moderately small (e.g., about 5-15 wt. %) and more so when the amount of the binder and conductive additives in the electrode becomes small (e.g., about 0.5-5 wt. %). Higher electrode density and lower binder and conductive additive content, however, are advantageous for increasing cell energy density and reducing cost. Lower binder content may also be advantageous for increasing cell rate performance.

Examples of materials that exhibit moderately high-volume changes (e.g., about 8-180 vol. %) during the first charge-discharge cycle and moderate volume changes (e.g., about 5-50 vol. %) during the subsequent charge-discharge cycles include (nano)composites comprising so-called conversion-type (which includes both so-called chemical transformation and so-called “true conversion” subclasses) and so-called alloying-type active electrode materials. In the case of metal-ion batteries (such as Li-ion batteries), examples of such conversion-type active electrode materials include, but are not limited to, metal fluorides (such as lithium fluoride, iron fluoride, copper fluoride, bismuth fluoride, their mixtures and alloys, etc.), metal chlorides, metal iodides, metal bromides, metal chalcogenides (such as sulfides, including lithium sulfide and other metal sulfides), sulfur, selenium, metal oxides (including but not limited to lithium oxide and silicon oxide), metal nitrides, metal phosphides (including lithium phosphide), metal hydrides, and others. In the case of metal-ion batteries (such as Li-ion batteries), examples of such alloying-type electrode materials include, but are not limited to, silicon, germanium, antimony, aluminum, magnesium, zinc, gallium, arsenic, phosphorous, silver, cadmium, indium, tin, lead, bismuth, their alloys, and others. These materials typically offer higher gravimetric and volumetric capacity than so-called intercalation-type electrodes commonly used in commercial metal-ion (e.g., Li-ion) batteries. Alloying-type electrode materials are particularly advantageous for use in certain high-capacity anodes for Li-ion batteries. Silicon-based alloying-type anodes may be particularly attractive for such applications.

An example of low swelling particles may comprise the mixture of conversion silicon anodes with graphite, so-called silicon-graphite blends. In such blended anode the Si-comprising anode particles (for example, in the form of nanocomposite or core-shell particles) may contribute from about 5% to about 98% by capacity (e.g., in some designs, from about 20% to about 80% by capacity), while the rest of the capacity may come from graphite or graphitic carbon materials. Such materials offer much higher volumetric and gravimetric energy density than the pure intercalation-type graphite or graphitic carbon electrodes commonly used in commercial Li-ion batteries. In addition, in such a blended anode, the graphite or graphitic carbon materials may be composed of natural, artificial or a mixture of natural and artificial graphites (or artificial soft or hard artificial graphitic carbon materials). In some designs, it may be more advantageous to use natural graphite or a mixture of natural and artificial graphites to reduce the overall anode swell in blends since such graphite particles may be able to accommodate stresses caused by the higher-swelling Si-comprising particles. Such properties of Si-comprising particles—graphitic carbon blends (which may be referred to as Si-graphite blends) may offer overall moderate volume changes during the first cycle and low volume changes during the subsequent charging cycles. Such properties may be advantageous for high-capacity loading anodes. The development of improved electrolytes and additives for such silicon-graphite blends may enhance the overall cell performance due to (i) slower capacity degradation due to lower swelling, (ii) reduced outgassing at high temperatures (“high-temperature outgassing”) (e.g., about 50-90° C. or higher) in a fully charged state (e.g., state-of-charge, SOC, of about 90-100%) for a prolonged time (e.g., about 12-168 hours), and/or (iii) reduced cell impedance due to the reduced use of additives, among other desirable characteristics.

Accordingly, there remains a need for improved electrolytes, additives, batteries, components, and other related materials and manufacturing processes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Embodiments disclosed herein address the above stated needs by providing improved electrolytes, batteries, components, and other related materials and manufacturing processes.

One aspect is directed to an electrolyte for a lithium-ion battery, comprising a primary lithium salt and a solvent composition. The solvent composition comprises fluoroethylene carbonate (FEC), at least one linear ester, and at least one branched ester. A mole fraction of the FEC in the electrolyte is in a range of about 2 mol. % to about 30 mol. % capacity (e.g., in some designs, in a range of about 4 mol. % to about 30 mol. %). A total mole fraction of the at least one linear ester and the at least one branched ester in the electrolyte is at least about 45 mol. %. In some designs, a molar ratio of the at least one linear ester to the at least one branched ester is in a range of about 1:10 to about 20:1 capacity (e.g., in some designs, in a range of about 1:1 to about 10:1 capacity). The electrolyte is substantially free of four-carbon cyclic carbonate.

Another aspect is directed to an electrolyte for a lithium-ion battery, comprising a primary lithium salt and a solvent composition. The solvent composition comprises fluoroethylene carbonate (FEC), at least one ester, and at least one non-FEC cyclic carbonate. A mole fraction of the FEC in the electrolyte is in a range of about 2 mol. % to about 30 mol. % (e.g., in some designs, in a range of about 4 mol. % to about 30 mol. %). A total mole fraction of the at least one ester in the electrolyte is at least 40 mol. %. A total mole fraction of the at least one non-FEC cyclic carbonate in the electrolyte is in a range of about 0.5 mol. % to about 30 mol. %. The electrolyte may advantageously be substantially free of four-carbon cyclic carbonate.

Yet another aspect is directed to an electrolyte for a lithium-ion battery, comprising a primary lithium salt and a solvent composition. The solvent composition comprises fluoroethylene carbonate (FEC) and at least one linear carbonate. A mole fraction of the FEC in the electrolyte is in a range of about 2 mol. % to about 20 mol. % (e.g., in some designs, in a range of about 4 mol. % to about 20 mol. %). A total mole fraction of the at least one linear carbonate in the electrolyte is at least 40 mol. %. The electrolyte may advantageously be substantially free of four-carbon cyclic carbonate. The electrolyte may advantageously be substantially free of any linear carbonate of molecular weight greater than 117.

Yet another aspect is directed to an electrolyte for a lithium-ion battery, comprising a primary lithium salt and a solvent composition. The solvent composition comprises at least one three-carbon cyclic carbonate and ethyl trimethylacetate (ET). The at least one three-carbon cyclic carbonate comprises ethylene carbonate (EC). A mole fraction of the ET in the electrolyte is at least about 50 mol. %. The electrolyte may advantageously be substantially free of four-carbon cyclic carbonate.

Yet another aspect is directed to a lithium-ion battery, including an anode, cathode, a separator interposed between the anode and the cathode, and any of the foregoing electrolytes ionically coupling the anode and the cathode.

Yet another aspect is directed to a lithium-ion battery, including an anode current collector, a cathode current collector, an anode disposed on and/or in the anode current collector, a cathode disposed on and/or in the cathode current collector, and any of the foregoing electrolytes ionically coupling the anode and the cathode.

Another aspect is directed to a battery pack or a device that utilizes at least one of such a lithium-ion battery cell comprising any of the foregoing electrolytes.

In an aspect, an electrolyte for a lithium-ion battery includes a primary lithium salt; and a solvent composition comprising fluoroethylene carbonate (FEC), at least one linear ester, and at least one branched ester; wherein: a mole fraction of the FEC in the electrolyte is in a range of about 2 mol. % to about 30 mol. %; a total mole fraction of the at least one linear ester and the at least one branched ester in the electrolyte is at least about 45 mol. %; a molar ratio of the at least one linear ester to the at least one branched ester is in a range of about 1:10 to about 20:1; and the electrolyte is substantially free of four-carbon cyclic carbonates.

In some aspects, the total mole fraction of the at least one linear ester and the at least one branched ester in the electrolyte is in a range of about 60 mol. % to about 75 mol. %.

In some aspects, the molar ratio of the at least one linear ester to the at least one branched ester is in a range of about 1:1 to about 2:1.

In some aspects, the at least one linear ester is selected from methyl acetate (MA), methyl propionate (MP), methyl butyrate (MB), ethyl acetate (EA), ethyl propionate (EP), ethyl butyrate (EB), propyl acetate (PA), propyl propionate (PP), propyl butyrate (PB), butyl acetate (BA), butyl propionate (BP), and butyl butyrate (BB).

In some aspects, the at least one branched ester is selected from methyl isobutyrate (MI), methyl trimethyl acetate (MT), methyl isovalerate (MIV), methyl 2-methylbutyrate (MMB), ethyl isobutyrate (EI), ethyl trimethylacetate (ET), ethyl isovalerate (EIV), ethyl 2-methylbutyrate (EMB), propyl isobutyrate (PI), propyl trimethylacetate (PT), propyl isovalerate (PIV), propyl 2-methylbutyrate (PMB), butyl isobutyrate (BI), butyl trimethylacetate (BT), butyl isovalerate (BIV), butyl 2-methylbutyrate (BMB), isopropyl acetate (IPA), isopropyl propionate (IPP), isopropyl butyrate (IPB), isopropyl isobutyrate (IPI), isopropyl trimethylacetate (IPT), isopropyl isovalerate (IPIV), isopropyl 2-methylbutyrate (IPMB), tert-butyl acetate (TBA), tert-butyl propionate (TBP), tert-butyl butyrate (TBB), tert-butyl isobutyrate (TBI), tert-butyl trimethylacetate (TBT), tert-butyl isovalerate (TBIV), tert-butyl 2-methylbutyrate (TBMB), isobutyl acetate (IBA), isobutyl propionate (IBP), isobutyl butyrate (IBB), isobutyl isobutyrate (IBI), isobutyl trimethylacetate (IBT), isobutyl isovalerate (IBIV), and isobutyl 2-methylbutyrate (IBMB).

In some aspects, the at least one linear ester is ethyl propionate (EP) and the at least one branched ester is ethyl isobutyrate (EI) and/or ethyl isovalerate (EIV).

In some aspects, the electrolyte is substantially free of diethyl carbonate, dimethyl carbonate, and ethyl methyl carbonate.

In some aspects, the primary lithium salt is LiPF₆.

In some aspects, a mole fraction of the primary lithium salt in the electrolyte is in a range from about 6 mol. % to about 20 mol. %.

In some aspects, one or more charge-transfer additives are selected from the following: lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB).

In some aspects, the one or more charge-transfer additives comprise the lithium difluorophosphate (LFO), the lithium tetrafluoroborate (LiBF₄), the lithium bis(fluorosulfonyl)imide (LiFSI), and the lithium difluoro(oxalato)borate (LiDFOB).

In some aspects, a mole fraction of the one or more charge-transfer additives in the electrolyte is in a range of about 0.1 mol. % to about 6 mol. %.

In some aspects, the mole fraction of the one or more charge-transfer additives is in a range of about 0.5 mol. % to about 1.5 mol. %.

In some aspects, one or more high-temperature storage additives are selected from adiponitrile, 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile, 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether, 3-(triethoxysilyl) propionitrile, succinonitrile, benzonitrile, 4-(trifluoromethyl) benzonitrile, 1,2,2,3-propanetetracarbonitrile, triisopropyl borate, 1-propene 1,3-sultone, 1,3-propanesultone, phenyl disulfide, sulfolane, N,N,N,N-tetraethyl sulfamide, succinic anhydride, maleic anhydride, tris(trimethylsilyl)phosphite, tris(trimethylsilyl)phosphate, dimethoxydiphenylsilane, tris(trimethylsilyl) borate, 3-(triethoxysilyl)propyl isocyanate, 1,3,2-dioxathiolane 2,2-dioxide (DTD), and methylene methanedisulfonate (MMDS).

In some aspects, a mole fraction of the one or more high-temperature storage additives in the electrolyte is in a range of about 0.1 mol. % to about 3 mol. %.

In some aspects, at least one non-FEC cyclic carbonate is selected from ethylene carbonate and vinylene carbonate.

In some aspects, a mole fraction of the at least one non-FEC cyclic carbonate in the electrolyte is in a range of about 0.5 mol. % to about 30 mol. %.

In some aspects, the mole fraction of the at least one non-FEC cyclic carbonate in the electrolyte is in a range of about 1 mol. % to about 6 mol. %.

In an aspect, a lithium-ion battery includes an anode current collector; a cathode current collector; an anode disposed on and/or in the anode current collector; a cathode disposed on and/or in the cathode current collector; and an electrolyte ionically coupling the anode and the cathode.

In some aspects, the anode comprises a mixture of (A) silicon-comprising particles comprising silicon and carbon, and (B) graphitic carbon particles comprising carbon and being substantially free of silicon; and a mass of the silicon is in a range of about 1.5 wt. % to about 60 wt. % of a total mass of the anode.

In an aspect, an electrolyte for a lithium-ion battery includes a primary lithium salt; and a solvent composition comprising fluoroethylene carbonate (FEC), at least one ester, and at least one non-FEC cyclic carbonate; wherein: a mole fraction of the FEC in the electrolyte is in a range of about 2 mol. % to about 30 mol. %; a total mole fraction of the at least one ester in the electrolyte is at least about 40 mol. %; a total mole fraction of the at least one non-FEC cyclic carbonate in the electrolyte is in a range of about 0.5 mol. % to about 30 mol. %; and the electrolyte is substantially free of four-carbon cyclic carbonates.

In some aspects, the total mole fraction of the at least one ester in the electrolyte is in a range of about 45 mol. % to about 70 mol. %.

In some aspects, a molar ratio of the at least one ester to the at least one non-FEC cyclic carbonate is in a range of about 1.5:1 to about 20:1.

In some aspects, the at least one ester is selected from methyl acetate (MA), methyl propionate (MP), methyl butyrate (MB), ethyl acetate (EA), ethyl propionate (EP), ethyl butyrate (EB), propyl acetate (PA), propyl propionate (PP), propyl butyrate (PB), butyl acetate (BA), butyl propionate (BP), butyl butyrate (BB), methyl isobutyrate (MI), methyl trimethyl acetate (MT), methyl isovalerate (MIV), methyl 2-methylbutyrate (MMB), ethyl isobutyrate (EI), ethyl trimethylacetate (ET), ethyl isovalerate (EIV), ethyl 2-methylbutyrate (EMB), propyl isobutyrate (PI), propyl trimethylacetate (PT), propyl isovalerate (PIV), propyl 2-methylbutyrate (PMB), butyl isobutyrate (BI), butyl trimethylacetate (BT), butyl isovalerate (BIV), butyl 2-methylbutyrate (BMB), isopropyl acetate (IPA), isopropyl propionate (IPP), isopropyl butyrate (IPB), isopropyl isobutyrate (IPI), isopropyl trimethylacetate (IPT), isopropyl isovalerate (IPIV), isopropyl 2-methylbutyrate (IPMB), tert-butyl acetate (TBA), tert-butyl propionate (TBP), tert-butyl butyrate (TBB), tert-butyl isobutyrate (TBI), tert-butyl trimethylacetate (TBT), tert-butyl isovalerate (TBIV), tert-butyl 2-methylbutyrate (TBMB), isobutyl acetate (IBA), isobutyl propionate (IBP), isobutyl butyrate (IBB), isobutyl isobutyrate (IBI), isobutyl trimethylacetate (IBT), isobutyl isovalerate (IBIV), and isobutyl 2-methylbutyrate (IBMB).

In some aspects, the at least one ester comprises the ethyl acetate (EA), the ethyl propionate (EP), the ethyl isobutyrate (EI), and/or the ethyl isovalerate (EIV).

In some aspects, the at least one ester comprises a mixture of the ethyl acetate (EA) and the ethyl propionate (EP).

In some aspects, the at least one non-FEC cyclic carbonate is selected from ethylene carbonate and vinylene carbonate.

In some aspects, the electrolyte is substantially free of diethyl carbonate, dimethyl carbonate, and ethyl methyl carbonate.

In some aspects, the primary lithium salt is LiPF₆.

In some aspects, a mole fraction of the primary lithium salt in the electrolyte is in a range from about 6 mol. % to about 20 mol. %.

In some aspects, the electrolyte further includes one or more charge-transfer additives selected from lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB).

In some aspects, the one or more charge-transfer additives comprise the lithium difluorophosphate (LFO), the lithium tetrafluoroborate (LiBF₄), the lithium bis(fluorosulfonyl)imide (LiFSI), and the lithium difluoro(oxalato)borate (LiDFOB).

In some aspects, a mole fraction of the one or more charge-transfer additives in the electrolyte is in a range of about 0.1 mol. % to about 6 mol. %.

In some aspects, the mole fraction of the one or more charge-transfer additives is in a range of about 0.5 mol. % to about 1.5 mol. %.

In some aspects, the electrolyte further includes one or more high-temperature storage additives selected from adiponitrile, 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile, 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether, 3-(triethoxysilyl) propionitrile, succinonitrile, benzonitrile, 4-(trifluoromethyl) benzonitrile, 1,2,2,3-propanetetracarbonitrile, triisopropyl borate, 1-propene 1,3-sultone, 1,3-propanesultone, phenyl disulfide, sulfolane, N,N,N,N-tetraethyl sulfamide, succinic anhydride, maleic anhydride, tris(trimethylsilyl)phosphite, tris(trimethylsilyl)phosphate, dimethoxydiphenylsilane, tris(trimethylsilyl) borate, 3-(triethoxysilyl)propyl isocyanate, 1,3,2-dioxathiolane 2,2-dioxide (DTD), and methylene methanedisulfonate (MMDS).

In some aspects, a mole fraction of the one or more high-temperature storage additives in the electrolyte is in a range of about 0.1 mol. % to about 3 mol. %.

In an aspect, a lithium-ion battery includes an anode current collector; a cathode current collector; an anode disposed on and/or in the anode current collector; a cathode disposed on and/or in the cathode current collector; and an electrolyte ionically coupling the anode and the cathode.

In some aspects, the anode comprises a mixture of (A) silicon-comprising particles comprising silicon and carbon, and (B) graphitic carbon particles comprising carbon and being substantially free of silicon; and a mass of the silicon is in a range of about 1.5 wt. % to about 60 wt. % of a total mass of the anode.

In some aspects, the anode comprises graphitic carbon particles comprising carbon and being substantially free of silicon.

In some aspects, the primary lithium salt is LiPF₆.

In an aspect, an electrolyte for a lithium-ion battery includes a primary lithium salt; and a solvent composition comprising fluoroethylene carbonate (FEC) and at least one linear carbonate; wherein: a mole fraction of the FEC in the electrolyte is in a range of about 2 mol. % to about 20 mol. %; a total mole fraction of the at least one linear carbonate in the electrolyte is at least 40 mol. %; the electrolyte is substantially free of four-carbon cyclic carbonates; and the electrolyte is substantially free of any linear carbonate of molecular weight greater than 117.

In some aspects, the at least one linear carbonate is selected from ethyl methyl carbonate and dimethyl carbonate; and the total mole fraction of the at least one linear carbonate in the electrolyte is in a range of about 60 mol. % to about 75 mol. %.

In some aspects, a mole fraction of the primary lithium salt in the electrolyte is in a range from about 6 mol. % to about 20 mol. %.

In some aspects, one or more charge-transfer additives selected from lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB).

In some aspects, the one or more charge-transfer additives comprise the lithium difluorophosphate (LFO), the lithium tetrafluoroborate (LiBF₄), the lithium bis(fluorosulfonyl)imide (LiFSI), and/or the lithium difluoro(oxalato)borate (LiDFOB)

In some aspects, a mole fraction of the one or more charge-transfer additives in the electrolyte is in a range of about 0.1 mol. % to about 6 mol. %.

In some aspects, the mole fraction of the one or more charge-transfer additives is in a range of about 0.5 mol. % to about 1.5 mol. %.

In some aspects, one or more high-temperature storage additives are selected from adiponitrile, 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile, 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether, 3-(triethoxysilyl) propionitrile, succinonitrile, benzonitrile, 4-(trifluoromethyl) benzonitrile, 1,2,2,3-propanetetracarbonitrile, triisopropyl borate, 1-propene 1,3-sultone, 1,3-propanesultone, phenyl disulfide, sulfolane, N,N,N,N-tetraethyl sulfamide, succinic anhydride, maleic anhydride, tris(trimethylsilyl)phosphite, tris(trimethylsilyl)phosphate, dimethoxydiphenylsilane, tris(trimethylsilyl) borate, 3-(triethoxysilyl)propyl isocyanate, 1,3,2-dioxathiolane 2,2-dioxide (DTD), and methylene methanedisulfonate (MMDS).

In some aspects, a mole fraction of the one or more high-temperature storage additives in the electrolyte is in a range of about 0.1 mol. % to about 3 mol. %.

In some aspects, the electrolyte further includes at least one non-FEC cyclic carbonate selected from ethylene carbonate and vinylene carbonate.

In some aspects, a mole fraction of the at least one non-FEC cyclic carbonate in the electrolyte is in a range of about 1 mol. % to about 30 mol. %.

In some aspects, the mole fraction of the at least one non-FEC cyclic carbonate in the electrolyte is in a range of about 15 mol. % to about 30 mol. %.

In an aspect, a lithium-ion battery includes an anode current collector; a cathode current collector; an anode disposed on and/or in the anode current collector; a cathode disposed on and/or in the cathode current collector; and an electrolyte ionically coupling the anode and the cathode.

In some aspects, the anode comprises a mixture of (A) silicon-comprising particles comprising silicon and carbon, and (B) graphitic carbon particles comprising carbon and being substantially free of silicon; and a mass of the silicon is in a range of about 1.5 wt. % to about 60 wt. % of a total mass of the anode.

In an aspect, an electrolyte for a lithium-ion battery includes a primary lithium salt; and a solvent composition comprising at least one three-carbon cyclic carbonate and ethyl trimethylacetate (ET); wherein: the at least one three-carbon cyclic carbonate comprises ethylene carbonate (EC); a mole fraction of the ET in the electrolyte is at least about 50 mol. %; and the electrolyte is substantially free of four-carbon cyclic carbonates.

In some aspects, the mole fraction of the ET in the electrolyte is in a range of about 50 mol. % to about 80 mol. %.

In some aspects, the primary lithium salt is LiPF₆.

In some aspects, a mole fraction of the primary lithium salt in the electrolyte is in a range from about 6 mol. % to about 20 mol. %.

In some aspects, a mole fraction of the at least one three-carbon cyclic carbonate in the electrolyte is in a range of about 20 mol. % to about 40 mol. %.

In some aspects, the at least one three-carbon cyclic carbonate comprises fluoroethylene carbonate (FEC) and/or vinylene carbonate.

In some aspects, the electrolyte is substantially free of linear carbonates.

In an aspect, a lithium-ion battery includes an anode current collector; a cathode current collector; an anode disposed on and/or in the anode current collector; a cathode disposed on and/or in the cathode current collector; and an electrolyte ionically coupling the anode and the cathode.

In some aspects, the anode comprises graphitic carbon particles comprising carbon and being substantially free of silicon.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the electrolytes, components, materials, methods, and other techniques described herein may be implemented.

FIG. 2 illustrates selected examples of cyclic carbonates that may be used in certain electrolytes.

FIG. 3 illustrates selected examples of linear carbonates that may be used in certain electrolytes.

FIGS. 4 and 5 illustrate selected examples of linear esters suitable for use in electrolytes.

FIGS. 6, 7, 8, 9, and 10 illustrate selected examples of branched esters suitable for use in electrolytes.

FIGS. 11, 12, 13, 14, and 15 illustrate selected examples of high-temperature storage additives suitable for use in electrolytes.

FIG. 16 shows a Table 1 which shows electrolyte composition data for electrolyte (ELY) #1, #2, #3, #4, #5, #6, #7, #8, #9, #10, #11, #12, #13, and #14.

FIGS. 17A, 17B, 17C, 17D, and 17E are graphical plots of the capacity retention (in % of initial capacity) as a function of cycle number, for Li-ion battery cells comprising ELY #1, #2, #3, #4, and #5, respectively. FIGS. 17F, 17G, 17H, 17I, and 17J are graphical plots of the estimated number of cycles to 80% of initial capacity as a function of cycle number, for Li-ion battery cells comprising ELY #1, #2, #3, #4, and #5, respectively. ELY #1, #2, #3, #4, and #5 are examples of ester-comprising electrolytes.

FIGS. 18A and 18B are graphical plots of the capacity retention (in % of initial capacity) as a function of cycle number, for Li-ion battery cells comprising ELY #6 and #7, respectively. FIGS. 18C and 18D are graphical plots of the estimated number of cycles to 80% of initial capacity as a function of cycle number, for Li-ion battery cells comprising ELY #6 and #7, respectively. ELY #6 and #7 are examples of ester-comprising electrolytes.

FIGS. 19A and 19B are graphical plots of the capacity retention (in % of initial capacity) as a function of cycle number, for Li-ion battery cells comprising ELY #8 and #9, respectively. FIGS. 19C and 19D are graphical plots of the estimated number of cycles to 80% of initial capacity as a function of cycle number, for Li-ion battery cells comprising ELY #8 and #9, respectively. ELY #8 and #9 are examples of linear carbonate-comprising electrolytes.

FIGS. 20A, 20B, 20C, 20D, 20E, and 20F show cycle life test results of Li-ion battery test cells comprising electrolytes ELY #10, 11, and 12. FIGS. 20A, 20B, and 20C are graphical plots of the capacity retention (in % of initial capacity) as a function of cycle number, for Li-ion battery cells comprising ELY #10, #11, and #12, respectively. FIGS. 20D, 20E, and 20F are graphical plots of the estimated number of cycles to 80% of initial capacity as a function of cycle number, for Li-ion battery cells comprising ELY #10, #11, and #12, respectively. ELY #10, #11, and #12 are examples of electrolytes comprising at least one cyclic carbonate and a branched ester.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternative embodiments may be devised without departing from the scope of the invention. Additionally, well-known elements of the invention may not be described in detail or may be omitted so as not to obscure other, more relevant details.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . 0%). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In some embodiments described below, certain parameters (e.g., temperature, state-of-charge (SOC), etc.) are defined in terms of relative terminology such as low, reduced, high, increased, elevated, and so on. With regard to temperature, unless otherwise stated, this relative terminology may be characterized relative to battery cell storage temperature or battery cell operating temperature, depending on the context of the relevant example. With regard to SOC, unless otherwise stated, a high SOC may be defined as higher than about 70% SOC (e.g., in some designs, about 70-80% SOC; in some designs, about 80-90% SOC; in some designs, about 90-100% SOC).

It will be appreciated that while in some illustrative examples, a Li or Li-ion battery is described due to prevalence of Li-ion batteries in the marketplace and their high energy characteristics, other metal or metal-ion batteries (e.g., Na and Na-ion, K or K-ion, Mg or Mg-ion, Ca or Ca-ion, various mixed metal-ion, etc. batteries) may be used instead with the disclosed electrolyte or electrolyte solvent compositions. In this case, one or more salts of Na, K or other metals may be used instead of or in addition to suitable salt(s) of Li. In this case, Na, K, Mg, Ca or other corresponding metals or their mixtures may be used instead of or in addition to Li in the cathode compositions. In this case, the blended anodes may also be designed to comprise a different composition (e.g., hard carbons or soft carbons may be used instead of or in addition to graphite, Sn or Sb may be used instead of or in addition to Si, etc.).

In one or more embodiments of the present disclosure, a preferred Li or Li-ion battery cell may include nickel (Ni), cobalt (Co), manganese (Mn), titanium (Ti) and/or iron (Fe)—comprising active cathode materials, including but not limited to: a lithium cobalt oxide (LCO), various lithium nickel cobalt manganese oxides (NCM), various lithium nickel cobalt aluminum oxides (NCA), various lithium nickel cobalt manganese aluminum oxides (NCMA), various lithium nickel oxides (NCO), various lithium manganese oxides (LMO), various lithium manganese nickel oxides (LNMO), to illustrate a few. Other illustrative examples of preferred or suitable Li-ion battery cathodes include, but are not limited to various olivine compounds (e.g., lithium iron phosphate, LFP, lithium manganese phosphate, LNP, lithium iron manganese phosphate, LMFP, lithium vanadium fluoro phosphate, LVFP, lithium iron fluoro sulfate, LFSFP, etc.), various high-voltage spinels (e.g., LNMO), various excess-Li material such as disordered rocksalts (e.g., transition metal oxides and oxy-fluorides such as those comprising Mn, Mo, Cr, Ti, and/or Nb, such as, for example, lithium molybdenum chromium oxides and oxy-fluorides, lithium manganese niobium oxides and oxy-fluorides, lithium manganese titanium oxides and oxy-fluorides, lithium nickel titanium molybdenum oxides and oxy-fluorides and many others), to illustrate a few.

In some of the preferred examples a cathode active material (e.g., LCO, NCM, NCA, NCMA, NCO, LMO, LNMO, LMFP, etc.) may be doped with one or more metals or semimetals (e.g., Mg, Ca, Sr, Ba, Sc, Y, La or lanthanoid, Ti, V, Cr, Ce, Zn, Zr, Nb, Mo, Tc, In, Sn, Sb, Si, Hf, Ta, W, Tl, etc.).

In some of the preferred examples a surface of the cathode active material (e.g., LCO, NCM, NCA, NCMA, NCO, LMO, LNMO, LMFP, etc.) may be coated with one or more layers of ceramic material having a distinctly different composition or microstructure. Illustrative examples of a preferred coating material for a preferred active cathode material may include, but are not limited to metal oxides that comprise one or more of the following metals: Ti, Al, Mg, Sr, Li, Si, Sn, Sb, Nb, W, Cr, Mo, Hf, Ta, B, Y, La, Ce, Zn, and Zr. Illustrative examples of such oxides may include, but are not limited to titanium oxide (e.g., TiO₂), aluminum oxide (e.g., Al₂O₃), magnesium oxide (e.g., MgO), silicon oxide (e.g., SiO₂), boron oxide (e.g., B₂O₃), lanthanum oxide (La₂O₃), zirconium oxide (e.g., ZrO₂) and other suitable metal or mixed metal oxides and their various mixtures and alloys.

In some designs, a preferred cathode current collector may comprise aluminum or an aluminum alloy. In some designs, a preferred anode current collector may comprise copper or a copper alloy.

In some designs, a preferred battery cell may include a polymer separator, a polymer-ceramic composite separator or a ceramic separator. In some designs, such a separator may be stand-alone or may be integrated into an anode or cathode or both. In some designs, a polymer separator may comprise or be made of polyethylene, polypropylene, or a mixture thereof. In some of the preferred examples a surface of a polymer separator may be coated with a layer of ceramic material. Examples of a preferred coating material for polymer separators may include, but not limited to titanium oxide (TiO₂), silicon oxide (SiO₂), aluminum oxide (Al₂O₃), aluminum hydroxide, zirconium oxide (ZrO₂), magnesium oxide (MgO), magnesium hydroxide, magnesium oxyhydroxide or their various alloys or mixtures.

In some designs, a preferred battery cell may include one or more of the following materials in its anode composition: (i) silicon (Si), including doped or heavily doped Si; (ii) silicon oxide (SiOₓ); (iii) silicon nitride or oxynitride; (iv) silicon phosphide; (v) silicon binary alloy or silicon ternary alloy or other silicon alloys (e.g., Si—Mg, Si—Al, Si—Al—Mg, Si—Fe, Si—Ge, etc.), (vi) a silicon-comprising or silicon alloy-comprising or silicon oxide-comprising or silicon nitride-comprising or silicon oxynitride-comprising composite or nanocomposite; (vii) silicon carbide or silicon oxycarbide; (viii) a composite or nanocomposite comprising both silicon and carbon atoms, such as a silicon-carbon (Si—C) nanocomposite (e.g., as used herein, a nanocomposite or (nano)composite is at least partially comprised of active material nanomaterials or nanostructures or nanoparticles, irrespective of whether the nanocomposite or (nano)composite itself is a nanomaterial; also note as used herein, a silicon-carbon (or Si—C) composite or nanocomposite may comprise elements other than Si and C as long as Si and C comprise a vast majority of elements with the total weight fraction of combined Si and C contributes to about 75-100 wt. % of the composite or nanocomposite); (ix) or natural or synthetic graphite; (x) soft carbon or hard carbon; and (xi) their various mixtures and combinations.

In some of the preferred examples, the anode material includes a mixture of silicon-carbon nanocomposite (sometimes abbreviated herein as Si—C nanocomposite) and one or more graphite (or hard or soft artificial carbon, etc.) (e.g., the graphite or artificial carbon being separate from the C-part of the Si—C nanocomposite). In some implementations, a Si—C nanocomposite comprises composite particles, which may include Si nanoparticles embedded in pores of a porous carbon scaffold particle. Such a porous carbon scaffold particle may comprise graphene material and/or graphite material. In some implementations, a Si—C nanocomposite may comprise micropores (sub-2 nm pores), mesopores (2-50 nm pores) and/or macropores (pores above 50 nm) in various ratios (for example, as in about 20-70-10 vol. % ratios or, for example, as in about 60-35-5 vol. % ratios or, for example, as in about 80-10-10 vol. % ratios or, for example, about 10-40-50 vol. % ratios), as determined by (e.g., nitrogen) sorption experiments or other suitable measurements known (electron microscopy, neutron scattering, x-ray scattering, x-ray imaging, etc.). In some preferred designs, at least some of such pores may be closed (e.g., inaccessible by nitrogen during nitrogen sorption experiments). In some preferred designs, at least some of such pores may be open (e.g., accessible by nitrogen during nitrogen sorption experiments).

In one or more embodiments of the present disclosure, a preferred battery cell may comprise a relatively high areal capacity loading in its electrodes (anodes and cathodes), such as from around 2.0 mAh/cm² to around 12 mAh/cm² (in some implementations, from about 2 to about 3.5 mAh/cm²; in other implementations, from about 3.5 to about 4.5 mAh/cm²; in other implementations, from about 4.5 to about 6.5 mAh/cm²; in other implementations, from about 6.5 to about 8 mAh/cm²; in other implementations, from about 8 to about 12 mAh/cm²).

While the description below may also describe certain examples of the material formulations in a Li-free state (for example, as in silicon-comprising nanocomposite anodes or metal fluoride cathodes), it will be appreciated that various aspects may be applicable to Li-containing electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent material properties (e.g., at particle level, at inter-particle level, at electrode level, etc.) may be assumed to be provided as if the active material particles are in the Li-free state.

During battery (such as a Li-ion battery) operation, conversion materials change (convert) from one crystal structure to another (hence the name “conversion”-type, e.g., an electrochemical reaction). This process is also accompanied by breaking chemical bonds and forming new ones. During (e.g., Li-ion) battery operation, Li ions are inserted into alloying type materials forming lithium alloys (hence the name “alloying”-type). Sometimes, “alloying”-type electrode materials are considered to be a subclass of “conversion”-type electrode materials.

In one or more embodiments of the present disclosure, a preferred anode for a battery cell may comprise a mixture of Si-comprising material (e.g., Si—C nanocomposite or other) (particles) and graphite (or soft or hard carbon) (particles) as the anode active material, a so-called blended anode. In some designs, the Si-comprising material (e.g., Si—C nanocomposite or other) (particles) contribute from about 5% to about 98% of the total anode capacity (in some designs, from about 5 to about 20%; in other designs, from about 20 to about 50%; in other designs, from about 50 to about 80%; in yet other designs, from about 80 to about 98%) with the rest of the anode capacity contributed by graphite (or soft or hard carbon) (particles).

In addition to the anode active material, an anode may comprise inactive material, such as binder(s) (e.g., polymer binder) and other functional additives (e.g., surfactants, electrically conductive additives). In some implementations, the anode active material may be in a range of about 88 wt. % to about 98 wt. % of the anode (not including the weight of the anode current collector); in other designs, in a range of about 90 wt. % to about 98 wt. % of the anode (not including the weight of the anode current collector). For example, the anode active material may be about 95.5 wt. % of the anode. In some implementations, blended anodes may comprise Si—C nanocomposites (e.g., particles) ranging from about 7 wt. % to about 50 wt. % of the anode and the graphite (or soft or hard carbon) making up the remainder of the mass (the weight) of the anode active material. In some implementations in which the anode active material is about 95.5 wt. % of the blended anode, the blended anode (including active material and inactive material) may comprise, for example, about 7 wt. % of Si—C nanocomposite and about 88.5 wt. % of graphite. In some implementations in which the anode active material is about 95.5 wt. % of the blended anode, the blended anode (including active material and inactive material) may comprise, for example, about 19 wt. % of Si—C nanocomposite and about 76.5 wt. % of graphite. In some implementations in which the anode active material is about 95.5 wt. % of the blended anode, the blended anode (including active material and inactive material) may comprise, for example, about 35 wt. % of Si—C nanocomposite and about 60.5 wt. % of graphite. In some implementations in which the anode active material is about 95.5 wt. % of the blended anode, the blended anode (including active material and inactive material) may comprise, for example, about 50 wt. % of Si—C nanocomposite and about 45.5 wt. % of graphite.

While the descriptions below may also describe certain examples of the blended anode formulations expressed as mass (wt. %) of Si—C nanocomposite, it will be appreciated that various aspects of this disclosure may be applicable to blended anode formulations expressed as wt. % of Si (as element) in the anode. In some implementations, a blended anode composition of about 7 wt. % of Si—C nanocomposite may correspond to about 3 wt. % of Si in the blended anode. In some implementations, a blended anode composition of about 19 wt. % of Si—C nanocomposite may correspond to about 8 wt. % of Si in the blended anode. In some implementations, a blended anode composition of about 35 wt. % of Si—C nanocomposite corresponds to about 15 wt. % of Si in the blended anode. In some implementations, a blended anode composition of about 50 wt. % of Si—C nanocomposite corresponds to about 21 wt. % of Si in the blended anode. In such and other implementations, blended anodes may be obtained in which the mass (weight) of the silicon (element) is in a range of about 1.5 wt. % to about 60 wt. % of a total mass of the anode; in other designs, in a range of about 3 wt. % to about 30 wt. % of a total mass of the anode. Herein, the “total mass of the anode” is the total mass of the anode excluding the mass of the anode current collector even if the anode is disposed on and/or in the anode current collector.

While the descriptions below may also describe certain examples of the blended anode formulations expressed as mass (wt. %) of Si—C nanocomposite, it will be appreciated that various aspects of this disclosure may be applicable to blended anode formulations attributing a fraction (e.g., %) of the total capacity of the blended anode to the capacity of the Si. In some implementations, about 25% of the total capacity of the blended anode is obtained from the Si—C nanocomposite in a blended anode composition of about 7 wt. % of Si—C nanocomposite. In some other implementations, about 50% of the total capacity of the blended anode is obtained from the Si—C nanocomposite in a blended anode composition of about 19 wt. % of Si—C nanocomposite. In some other implementations, about 70% of the total capacity of the blended anode is obtained from the Si—C nanocomposite in a blended anode composition of about 35 wt. % of Si—C nanocomposite. In some other implementations, about 80% of the total capacity of the blended anode is obtained from the Si—C nanocomposite in a blended anode composition of about 50 wt. % of Si—C nanocomposite. In such and some other implementations, Si—C nanocomposite or another Si-compromising material or their various mixtures may contribute from about 5% to about 98% of the total anode capacity (in some designs, from about 5 to about 20%; in other designs, from about 20 to about 50%; in other designs, from about 50 to about 80%; in yet other designs, from about 80 to about 98%).

While the description below may describe certain examples of suitable intercalation-type graphites to be used in combination with Si—C nanocomposite in a blend, it will be appreciated that various aspects of this disclosure may be applicable to soft-type synthesis graphite, hard-type synthesis graphite, and pitch coat natural graphite; including but not limited to those which exhibit discharge capacity from about 300 to about 380 (e.g., 300-340 or 340-350 or 350-362 or 362-372 or 372-380) mAh/g; including but not limited to those which exhibit low, moderate and high swelling; including but not limited to those which exhibit good and poor compression, including but not limited to those which exhibit Brunauer-Emmett-Teller (BET) surface area of about 1 to about 4 m²/g; including but not limited to those which exhibit lithiation efficiency of about 90% and more; including but not limited to those which exhibit particle sizes from about 8 μm to about 18 μm; including but not limited to those which exhibit true densities ranging from about 1.5 g/cm³ to about 2.3 g/cm³ (in other designs, from about 1.5 g/cm³ to about 1.8 g/cm³); including but not limited to those which exhibit poor, moderate, or good cycle life; including but not limited to those which are coated and comprise coatings with coating thickness to appreciably improve compression and springing during cycling.

While the description below may describe certain examples of suitable intercalation-type cathodes (including high voltage cathodes) in the context of lithium nickel cobalt aluminum oxides (NCA), lithium nickel cobalt manganese aluminum oxides (NCMA), lithium nickel oxides (LNO), lithium manganese oxides (LMO), lithium nickel manganese cobalt oxides (NCM), lithium cobalt oxide (LCO), lithium cobalt aluminum oxides (LCAO), lithium iron phosphate (LFP), lithium manganese iron phosphate (LMFP), LNP (lithium nickel phosphate), lithium cobalt phosphate (LCP) and other lithium transition metal (TM) oxide or phosphate or sulfate (or mixed) cathodes that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc.), it will be appreciated that various aspects may be applicable to various (including high-voltage) lithium transition metal oxide (or phosphate or sulfate or oxyfluorides or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, Sn, Si, or Ge).

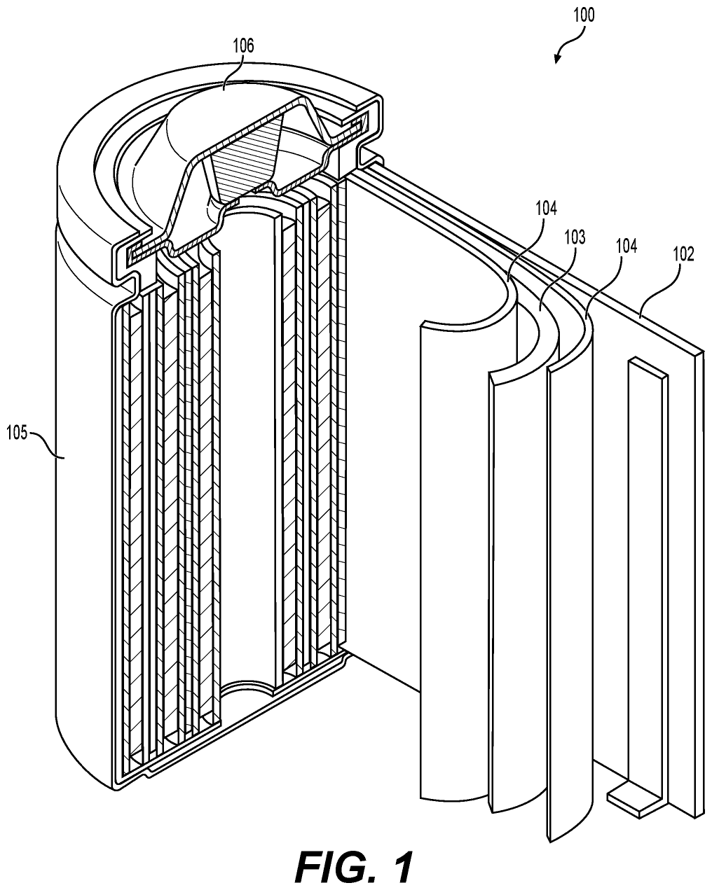

FIG. 1 illustrates an example metal-ion (e.g., Li-ion) battery in which the components, materials, methods, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). In some implementations, battery 100 also includes an anode current collector and a cathode current collector. The anode is disposed on and/or in the anode current collector and the cathode is disposed on and/or in the cathode current collector.

A conventional salt used in most conventional Li-ion battery electrolytes is LiPF₆. Examples of less common salts (e.g., explored primarily in research publications or, in some cases, never even described in Li-ion battery electrolyte applications, but may still be applicable and useful) include: lithium tetrafluoroborate (LiBF₄), lithium perchlorate (LiClO₄), lithium hexafluoroantimonate (LiSbF₆), lithium hexafluorosilicate (Li₂SiF₆), lithium hexafluoroaluminate (Li₃AlF₆), lithium bis(oxalato)borate (LiB(C₂O₄)₂) (LiBOB), lithium difluoro(oxalato)borate (LiBF₂(C₂O₄)) (LiDFOB), various lithium imides (such as SO₂FN⁻(Li⁺)SO₂F, CF₃SO₂N⁻(Li⁺)SO₂CF₃, CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li⁺)SO₂PhCF₃, and others), lithium difluorophosphate (LFO), and others.

Electrodes utilized in Li-ion batteries are typically produced by (i) formation of a slurry comprising active materials, conductive additives, binder solutions and, in some cases, surfactant or other functional additives; (ii) casting the slurry onto a metal current collector foil (e.g., Cu foil for most anodes and Al foil for most cathodes); and (iii) drying the casted electrodes to completely evaporate the solvent.

Conventional anode materials utilized in Li-ion batteries are of an intercalation-type, whereby metal ions are intercalated into and occupy interstitial positions of such materials during the charge or discharge of a battery. Such anodes experience small or very small volume changes when used in electrodes. Polyvinylidene fluoride, also known as polyvinylidene difluoride (PVDF), and carboxymethyl cellulose (CMC) are the two most common binders used in these electrodes. Other binders (e.g., acrylic binders, various polysaccharide binders, polytetrafluoroethylene (PTFE) and PTFE-based binders, etc.) may also be used in some designs. Carbon black is the most common conductive additive used in these electrodes. Other conductive additives (e.g., carbon fibers, single-walled carbon nanotubes, multi-walled carbon nanotubes, dendritic carbons, single-walled graphene or graphene oxide, multi-walled graphene or graphene oxide, metal nanowires, conductive carbides or carbo-nitriles, their various mixtures and combinations, etc.) may be used in some designs. However, such anodes exhibit relatively small gravimetric and volumetric capacities (typically less than about 370 mAh/g rechargeable specific capacity in the case of graphite- or hard carbon-based anodes and less than about 600 mAh/cm³ rechargeable volumetric capacity at the electrode level without considering the volume of the current collector foils).

Alloying-type (or, more broadly, conversion-type) anode materials for use in Li-ion batteries offer higher gravimetric and volumetric capacities compared to intercalation-type anodes. For example, Earth-abundant silicon (Si) offers approximately 10 times higher gravimetric capacity and approximately 3 times higher volumetric capacity compared to an intercalation-type graphite (or graphite-like) anode. However, Si suffers from significant volume expansion during Li insertion (up to approximately 300 vol. %) and thus may induce thickness changes and mechanical failure of Si-comprising anodes. In addition, Si (and some Li—Si alloy compounds that may form during lithiation of Si) suffer from relatively low electrical conductivity and relatively low ionic (Li-ion) conductivity. Electronic and ionic conductivity of Si is lower than that of graphite. Formation of (nano)composite Si-comprising particles (including, but not limited to Si-carbon composites, Si-metal composites, Si-polymer composites, Si-ceramic composites, composites comprising various combinations of nanostructured Si, carbon, polymer, ceramic and metal or other types of porous composites comprising nanostructured Si or nanostructured or nano-sized Si particles of various shapes and forms) may reduce volume changes during Li-ion insertion and extraction, which, in turn, may lead to better cycle stability in rechargeable Li-ion cells. In some designs, Si may be doped or heavily doped with nitrogen (N), phosphorous (P), aluminum (Al), magnesium (Mg), boron (B) or other elements or be allowed with metals (Al, Mg, Fe, Cu, Zn, Zr, etc.). In addition to Si-based composites, silicon oxides (SiOₓ) or oxynitrides (SiOₓN_{y}) or nitrides (SiN_{y}) or phosphides or other Si element-comprising particles (including those that are partially reduced by, for example, Li or Mg or Al, etc.) may reduce volume changes and improve cycle stability, although commonly at the expense of higher first cycle losses or faster degradation or both. In some designs, Si-comprising anode particles may exhibit high gravimetric capacities in the range from about 800 mAh/g to about 3000 mAh/g (per mass of Si-comprising anode particles in a Li-free state). Such high specific capacity is advantageous for attaining lighter batteries. However, Li-ion battery cells with anodes comprising high-capacity anode particles may exhibit undesirably fast degradation in conventional electrolytes, particularly at elevated temperatures (e.g., at or above battery operating temperature, e.g., above about 50-80° C.) or when charged to high voltages (e.g., above about 4-4.3 V). In some designs, a subset of anodes with Si-comprising anode particles may include anodes with an electrode layer exhibiting capacity in the range from about 400 mAh/g to about 2800 mAh/g (per mass of the electrode layer, not counting the mass of the current collector, in a Li-free state). Such a class of charge-storing anodes may offer great potential for increasing gravimetric and volumetric energy of rechargeable batteries. However, Li-ion battery cells with anodes comprising high-capacity anode particles may exhibit undesirably fast degradation in conventional electrolytes, particularly at elevated temperatures (e.g., at or above battery operating temperatures, e.g., above about 50-80° C.) or when charged to high voltages (e.g., above about 4-4.3 V). In addition to Si-comprising anodes, other examples of such high-capacity (e.g., nanocomposite) anodes comprising alloying-type (or, more broadly, conversion-type) active materials include, but are not limited to, those that comprise germanium, antimony, aluminum, magnesium, zinc, gallium, arsenic, phosphorous, silver, cadmium, indium, tin, lead, bismuth, their alloys, and others. In addition to anodes comprising active materials in a metallic form, other interesting types of high-capacity (including nanocomposite) anodes may comprise metal oxides (including silicon oxide, lithium oxide, etc.), metal nitrides (including silicon nitride, etc.), metal oxy-nitrides (including silicon oxy-nitride, etc.), metal phosphides (including lithium phosphide), metal hydrides, and others.

Li-ion cells with alloying-type (or, more broadly, conversion-type) active anode materials may exhibit undesirably fast degradation in conventional electrolytes, particularly at elevated temperatures (e.g., at or above battery operating temperatures, e.g., above about 50-80° C.) or when charged to high voltages (e.g., above about 4-4.3 V) and stored at such voltages at elevated temperatures (e.g., above about 50-80° C.). In some designs, degradation of Li-ion cells with alloying-type (or, more broadly, conversion-type) active anode materials may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). Note that small cells (e.g., cells with capacity in the range from about 0.001 Ah to about 1 Ah) and medium cells (e.g., cells with capacity in the range from about 1 Ah to about 10 Ah) may also suffer from the same issues, in some designs. However, large, or ultra-large or gigantic cells may be particularly attractive for use in some electric transportation or grid storage applications. In some designs, degradation of Li-ion cells with alloying-type (or, more broadly, conversion-type) active anode materials may become particularly undesirably fast for cells comprising medium (e.g., about 3-4 g/Ah) or small (e.g., about 2-3 g/Ah) amount of electrolyte when normalized by total cell capacity. However, in some designs, using a medium or a small amount of electrolyte may be particularly attractive for reducing cell fabrication costs or certain side reactions and for maximizing energy density of cells. One or more aspects of the present disclosure enables one to mitigate or overcome some or all of such limitations and substantially enhance performance of such Li-ion cells by using certain disclosed electrolyte compositions.

High-capacity (nano)composite anode powders (including, but not limited to those that comprise Si), which exhibit moderately high volume changes (e.g., about 8-about 180 vol. %) during the first charge-discharge cycle, moderate volume changes (e.g., about 4-about 50 vol. %) during the subsequent charge-discharge cycles and an average size in the range from about 0.2 to about 40 microns (for some applications, more preferably from about 0.4 to about 20 microns) may be particularly attractive for battery applications in terms of manufacturability and performance characteristics. In particular, a subclass of such anode powders with specific surface area in the range from about 0.5 m²/g to about 50 m²/g (in some designs, from about 0.5 m²/g to about 2 m²/g; in other designs, from about 2 m²/g to about 12 m²/g; in yet other designs, from about 12 m²/g to about 50 m²/g) performed particularly well in some embodiments. In some designs, electrodes with electrode areal capacity loading from moderate (e.g., from about 2 to about 4 mAh/cm²) to high (e.g., from about 4 to about 12 mAh/cm²) and ultra-high (e.g., above about 12 mAh/cm²) are also particularly attractive for use in cells. In some designs, a near-spherical or a spheroidal or an ellipsoid (inc. oblate spheroid) shape of these composite particles may additionally be very attractive for increasing rate performance and volumetric capacity (density) of the electrodes.

In spite of some improvements that may be achieved with the formation and utilization of such alloying-type (or conversion-type) active material(s)—comprising (e.g., nanocomposite) anode materials as well as electrode formulations, however, substantial additional improvements in cell performance characteristics may be achieved with improved composition and preparation of electrolytes (e.g., liquid electrolytes), beyond what is known or shown by the conventional state-of-the-art. Unfortunately, high-capacity (nano)composite anode and cathode powders, which exhibit moderately high volume changes (e.g., about 8-about 180 vol. %) during the first charge-discharge cycle, moderate volume changes (e.g., about 4-about 50 vol. %) during the subsequent charge-discharge cycles, an average size in the range from about 0.2 to about 40 microns and relatively low density (e.g., about 0.5-3.8 g/cc), are relatively new and their performance characteristics and limited cycle stability are typically relatively poor, particularly if electrode areal capacity loading is moderate (e.g., from about 2 to about 4 mAh/cm²) and even more so if electrode areal capacity loading is high (e.g., from about 4 to about 12 mAh/cm²) or ultra-high. Higher capacity loading, however, is advantageous in some designs for increasing cell energy density and reducing cell manufacturing costs. Similarly, the cell performance may suffer when such an electrode (e.g., anode) porosity (e.g., volume occupied by the spacing between the (nano)composite active anode particles in the electrode and filled with electrolyte, exclusive of closed pores, if any, within the particles themselves that are inaccessible to electrolyte) becomes moderately small (e.g., about 25-about 35 vol. %) and more so when the electrode (e.g., anode) porosity becomes small (e.g., about 5-about 25 vol. %) or when the amount of the binder and conductive additives in the electrode (e.g., anode) becomes moderately small (e.g., about 6-about 15 wt. %, total) and more so when the amount of the binder and conductive additives in the electrode (e.g., anode) becomes small (e.g., about 0.5-about 5 wt. %, total).

Higher electrode density and lower binder content, however, are advantageous for increasing cell energy density and reducing cost in certain applications. In some designs, lower binder content may also be advantageous for increasing cell rate performance. In some designs, larger volume changes may lead to inferior performance in some designs, which may be related to damages in the solid electrolyte interphase (SEI) layer formed on the anode, to the non-uniform lithiation and delithiation of the electrode particles within the electrodes, and/or other factors. Unfortunately, Li and Li-ion battery cells with such anodes and conventional electrolytes often require the use of such large amounts of conventional SEI-building additives to maintain acceptable cycle stability that prevents their use at elevated or low temperatures or undesirably limits their calendar life or does not allow such cells to be charged to high voltages (e.g., above about 4.1-4.3 V). In some designs, performance of such battery cells may become particularly poor when the cells are charged to above about 4.3-4.4 V and even more so when the cells are charged to above about 4.5 V.

Higher cell voltage, broader operational temperature window and longer cycle life, however, is advantageous for most applications. In some designs, such cells (e.g., cells with high amounts of conventional SEI-building additives) may suffer from excessive capacity degradation (e.g., above about 5%), large volume expansion (e.g., above about 10%) and significant gassing when exposed to high temperatures (e.g., above about 50-90° C.) in a fully charged state (e.g., state-of-charge, SOC, of about 90-100%) for a prolonged time (e.g., about 12-168 hours). Passing such elevated temperature charging tests is often required for most applications. In some designs, degradation of Li-ion cells comprising high-capacity (nano)composite anode powders, which exhibit moderately high volume changes during the first charge-discharge cycle, moderate volume changes during the subsequent charge-discharge cycles and an average size in the range from about 0.2 to about 40 microns may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). Note that small cells (e.g., cells with capacity in the range from about 0.001 Ah to about 1 Ah) and medium cells (e.g., cells with capacity in the range from about 1 Ah to about 10 Ah) may also suffer from the same issues, in some designs. In some designs, Li-ion cells with such volume changing anode particles may become particularly undesirably fast for cells comprising medium (e.g., about 3-4 g/Ah) or small (e.g., about 2-3 g/Ah) amount of electrolyte when normalized by total cell capacity. One or more embodiments of the present disclosure enables one to mitigate or overcome some or all of such limitations and substantially enhance performance of such Li-ion cells by using certain disclosed electrolyte compositions.

One or more embodiments of the present disclosure overcome some of the above-discussed challenges of various types of metal-ion (e.g., Li-ion) cells comprising high-capacity nanocomposite anode materials (for example, materials comprising conversion-type or alloying-type active materials) that may comprise Si in their composition, may experience certain volume changes during cycling (for example, moderately high volume changes (e.g., about 8-about 160 or about 180 vol. %) during the first charge-discharge cycle and moderate volume changes (e.g., about 4-about 50 vol. %) during the subsequent charge-discharge cycles), may exhibit an average particle size in the range from about 0.2 to about 40 microns and a specific surface area in the range from about 0.5 to about 50 m²/g (in some designs, from about 0.5 to about 2 m²/g; in other designs, from about 2 to about 12 m²/g; in yet other designs, from about 12 to about 50 m²/g), may be formulated with such electrodes in moderate (e.g., about 2-about 4 mAh/cm²) and high areal capacity loadings (e.g., about 4-about 12 mAh/cm²) with high packing density (electrode porosity filled with electrolyte in the range from about 5 to about 35 vol. % after the first charge-discharge cycle) and relatively low binder content (e.g., about 0.5-about 14 wt. %), may comprise moderate or small amount of electrolyte per cell capacity (e.g., less than about 4 g/mAh), may be charged to moderately high (e.g., above about 4.1-4.3 V) or high (e.g., above about 4.3-4.4 V) or very high (e.g., above about 4.5-4.8 V) voltages, may be exposed to temperatures above about 40° C. at high state of charge (e.g., SOC of about 70-100%) during testing or operation, may be produced as small cells (e.g., cells with capacity in the range from about 0.001 Ah to about 1 Ah); as medium cells (e.g., cells with capacity in the range from about 1 Ah to about 10 Ah); as large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more).

Conventional cathode materials utilized in Li-ion batteries are of an intercalation-type and commonly crystalline and polycrystalline. Such cathodes typically exhibit a highest charging potential of less than about 4.3 V vs. Li/Li⁺, gravimetric capacity of less than about 190 mAh/g (based on the mass of active material) and volumetric capacity of less than about 800 mAh/cm³ (based on the volume of the electrode and not counting the volume occupied by the current collector foil). For given anodes, higher energy density in Li-ion batteries may be achieved either by using high-voltage cathodes (cathodes with a highest charging potential from about 4.3 V vs. Li/Li⁺ to about 5.1 V vs. Li/Li⁺) or by using cathodes comprising so-called conversion-type cathode materials (including, but not limited to those that comprise F or S in their composition). Some high-voltage intercalation-type cathodes may comprise nickel (Ni). Some high-voltage intercalation-type cathodes may comprise manganese (Mn). Some high-voltage intercalation-type cathodes may comprise iron (Fe). Some high-voltage intercalation-type cathodes may comprise cobalt (Co). Some high-voltage intercalation-type cathodes may comprise aluminum (Al). Some high-voltage intercalation-type cathodes may comprise, as a dopant, silicon (Si), tin (Sn), antimony (Sb), or germanium (Ge) or their various combinations. In some designs, high-voltage intercalation-type cathode particles may comprise fluorine (F) as a dopant in their structure or the surface layer. Some high-voltage intercalation-type cathodes may comprise phosphorous (P) as a dopant. Some high-voltage intercalation-type cathodes may comprise sulfur (S) as a dopant. Some high-voltage intercalation-type cathodes may comprise selenium (Se) as a dopant. Some high-voltage intercalation-type cathodes may comprise tellurium (Te) as a dopant. Some high-voltage intercalation-type cathodes may comprise iron (Fe). Some high-voltage intercalation-type cathodes may comprise magnesium (Mg). Some high-voltage intercalation-type cathodes may comprise zirconium (Zr). Combination of such (or similar) types of higher energy density cathodes with high-capacity (e.g., Si based) anodes may result in high cell-level energy density. Unfortunately, the cycle stability and other performance characteristics of such cells may not be sufficient for some applications, at least when used in combination with conventional electrolytes.

One or more embodiments of the present disclosure are thereby directed to electrolyte compositions that work well for a combination of high voltage intercalation cathodes (cathodes with the highest charging potential in the range from about 4.0-4.2 V to about 4.5 V vs. Li/Li⁺ and, in some cases, from about 4.5 V vs. Li/Li⁺ to about 5.1 V vs. Li/Li⁺) with a subclass of high-capacity moderate volume changing anodes (e.g., anodes comprising (nano)composite anode powders, which exhibit moderately high volume changes (e.g., about 8-about 160 or about 180 vol. %) during the first charge-discharge cycle, moderate volume changes (e.g., about 4-about 50 vol. %) during the subsequent charge-discharge cycles), which exhibit an average particle size (e.g., average diameter) in the range from about 0.2 to about 40 microns and specific surface area in the range from about 0.5 to about 50 m²/g (when normalized by the mass of the composite electrode particles) and, in the case of Si-comprising anodes, specific capacities in the range from about 400 to about 2800 mAh/g (when normalized by the total mass of all the anode particles, conductive or other additives and binders, but does not include the weight of the current collectors) or in the range from about 650-800 to about 3000 mAh/g (when normalized by the mass of the Si-comprising anode particles only). In at least one embodiment, a particular electrolyte composition may be selected based on the value of the highest cathode charge potential or the highest operating temperature or the longest calendar life requirement.

One or more embodiments of the present disclosure are also directed to electrolyte compositions that work well for a combination of (i) a subclass of moderate capacity (e.g., about 160-260 mAh/g per mass of active materials, in some design), high-voltage intercalation-type cathodes (which may be layered cathodes in some designs; which may comprise Ni or Co or Mn or a combination of some of such metals in some designs, such as, for example, LCO (lithium cobalt oxides), NCA (lithium nickel cobalt aluminum oxides), NCMA (lithium nickel cobalt manganese aluminum oxides), LNO (lithium nickel oxides), LMO (lithium manganese oxides), NCM (lithium nickel cobalt manganese oxides, also known as NMC), LCAO (lithium cobalt aluminum oxides), LCP (lithium cobalt phosphates), LNP (lithium nickel phosphate), LMP (lithium manganese phosphates), LMFP (lithium manganese iron phosphates), LFP (lithium iron phosphate), or others), which are charged to above about 4.1 V vs. Li/Li⁺ during full cell battery cycling (in some designs, above about 4.2 V vs. Li/Li⁺; in other designs, above 4.3 V vs. Li/Li⁺; in yet other designs, above about 4.4 V vs. Li/Li⁺; in yet other designs, above about 4.5 V vs. Li/Li⁺; in yet other designs, above about 4.6 V vs. Li/Li⁺) with (ii) a subclass of high-capacity moderate volume changing anodes: anodes comprising about 5-about 100 wt. % of (nano)composite anode powders, which exhibit moderately high volume changes (e.g., about 8-about 160 or about 180 vol. %) during the first charge-discharge cycle, moderate volume changes (e.g., about 4-about 50 vol. %) during the subsequent charge-discharge cycles, an average size (e.g., average diameter) in the range from about 0.2 to about 40 microns and specific surface area in the range from about 0.5 to about 50 m²/g normalized by the mass of the (nano)composite anode particles and, in the case of Si-comprising anodes, specific reversible capacities in the range from about 400 to about 2800 mAh/g (when normalized by the total mass of all the active electrode particles, conductive additives and binders) or in the range from about 800 to about 3000 mAh/g (when normalized by the mass of the composite anode particles only).

The inventors have found that, in some designs, cells comprising anode electrodes based on high-capacity nanocomposite anode particles or powders (comprising conversion- or alloying-type active anode materials) that experience certain volume changes during cycling (moderately high volume changes (e.g., an increase by about 8-about 180 vol. % or a reduction by about 8-about 70 vol. %) during the first charge-discharge cycle and moderate volume changes (e.g., about 4-about 50 vol. %) during the subsequent charge-discharge cycles) and an average size in the range from about 0.2 to about 40 microns (such as Si-based nanocomposite anode powders, among many others) may benefit from specific compositions of electrolytes that provide significantly improved performance (particularly for high-capacity loadings or small electrolyte fractions or large cells).

For example, (i) continuous volume changes in high-capacity nanocomposite particles during cycling in combination with (ii) electrolyte decomposition on the electrically conductive electrode surface at electrode operating potentials (e.g., mostly electrochemical electrolyte reduction in the case of Si-based anodes) may lead to a continuous (even if relatively slow) growth of a solid electrolyte interphase (SEI) layer on the surface of the nanocomposite anode particles and the resulting irreversible losses in cell capacity. In some designs, the addition of some known SEI-forming additives may improve SEI stability during cycling but may induce undesirable electrolyte oxidation on the cathode (particularly at higher voltages or elevated temperature), resulting in gassing, cell swelling and reduced cycle and calendar life. In some designs, the addition of some known cathode solid electrolyte interphase (CEI)-forming additives may induce protective film formation on the cathode, reducing further electrolyte oxidation and gassing, but often at the expense of reduced SEI stability on the anode or other undesirable effects.

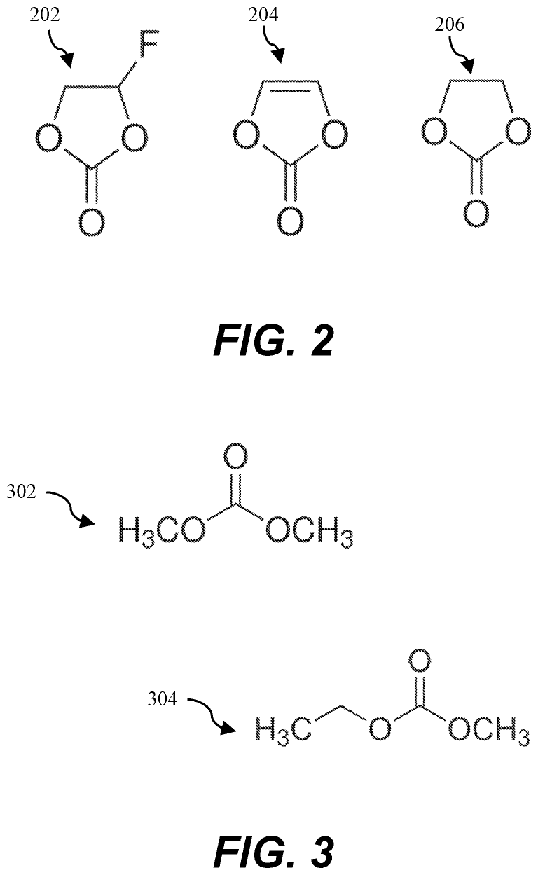

The inventors have found that, in some designs, the performance of cells comprising anode electrodes based on Si-nanocomposite and graphite particles or powders, may benefit from employing electrolytes which exhibit moderate-to-low fluoroethylene carbonate (FEC) mole fraction and low-to-minimum vinylene carbonate (VC) mole fraction, wherein “moderate-to-low” (for FEC) is from about 18 mol. % to about 6 mol. % and “low-to-minimum” (VC) is from about 5 mol. % to 0.1 mol. %. FEC and VC are examples of three-carbon cyclic carbonates and are shown as structures 202 and 204 in FIG. 2, respectively. Ethylene carbonate (EC) is another three-carbon cyclic carbonate, shown as structure 206 in FIG. 2. While electrolyte formulations for blends may be completely devoid of EC, the inventors have found that in some designs it may be advantageous to use a “low to minimum” mole fraction of EC in electrolytes (e.g., about 0.1 mol. % to about 5.0 mol. %).

For example, unlike the electrolytes with high mole fraction of FEC and VC, wherein “high” is above about 18 mol. % for FEC and above about 5 mol. % for VC, electrolytes with moderate-to-low FEC mole fraction and low-to-minimum VC mole fraction may improve the SEI stability during cycling, improve cycle life, reduce high-temperature (HT) outgassing on the cathode, improve the respective electrolyte's ionic conductivity, improve discharge voltage (V), reduce direct current (DC) resistance, decrease voltage hysteresis, and reduce anode charge-transfer resistance.

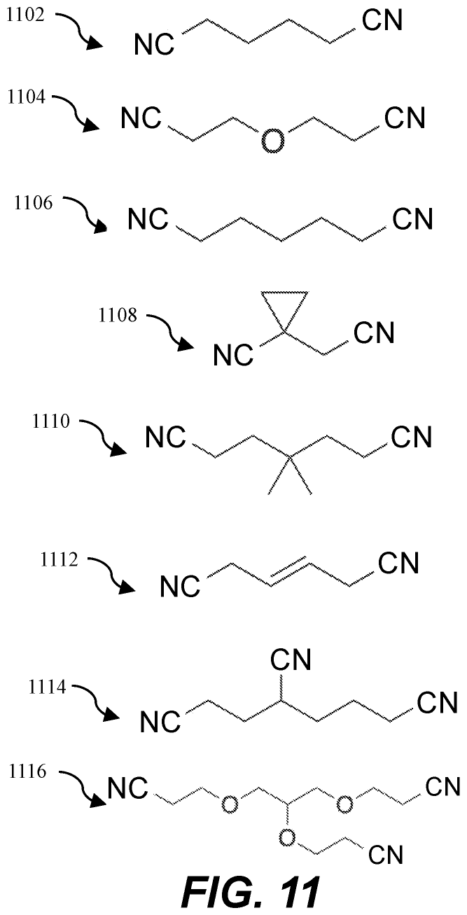

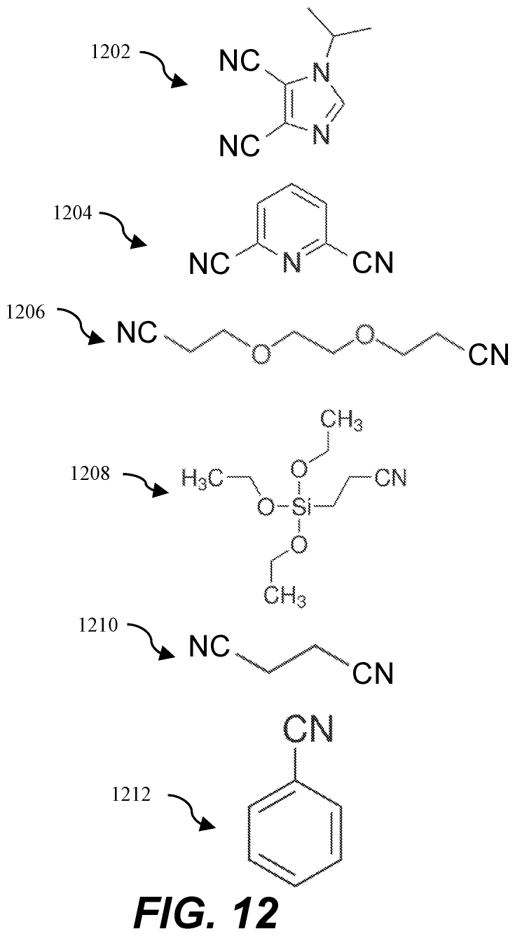

The inventors have found that in some designs it may be advantageous to maintain a necessary low mole fraction of VC in the electrolyte (with VC remaining in the electrolyte after formation) to ensure that there is no electrolyte outgassing under HT storage conditions due to excessive decomposition of residual VC in post-formation cells on the cathode. It may be advantageous in some designs to use a suitable amount of branched ester co-solvents in electrolyte (ELY) formulations to reduce HT outgassing that may be caused by VC. In some preferential designs it may be advantageous to use some small fraction of branched ester to form a protective film at the cathode. In some other designs, it may be advantageous to use additives, such as 1,3,2-dioxathiolane 2,2-dioxide (DTD), methylene methanedisulfonate (MMDS), dinitriles, trinitriles, difluorophosphate (LFO), sulfolane, or other compounds to suppress the HT outgassing caused by VC. Some nitrile additives including dinitriles and trinitriles are shown in FIGS. 11, 12, and 13 and are described in greater detail hereinbelow.

The inventors have also found that in some designs it is advantageous to maintain necessary low mole fractions of FEC and VC in the electrolyte (with FEC and VC remaining in the electrolyte after formation) to ensure that there is no electrolyte outgassing at state-of-health (SOH) of around 80%, also known as the end-of-life (EoL). In some designs, it may be advantageous to use a greater amount of branched ester co-solvents in the electrolyte formulations to suppress outgassing during cycling as the battery cell approaches its EoL. In some designs, it may be advantageous to use high-temperature storage additives (e.g., nitrile additives) or charge-transfer additives (e.g., Li salt additives) to suppress outgassing during cycling. In some designs, it is advantageous to keep the minimum necessary % of FEC to reduce outgassing at EoL. The optimal FEC and VC mole fractions may depend on the particular cell design and electrolyte composition.

In some designs, it may be advantageous to use linear esters as a main co-solvent. Herein, a compound that is employed in the solvent composition may be referred to as a “main co-solvent” (alternatively referred to as a “primary solvent”) when the mole fraction of that compound is greater than that of any of the other compounds in the solvent composition. The inventors found that linear esters may be more advantageous than linear carbonates in reducing outgassing as the cell approaches its EoL. The inferior stability of linear carbonates compared to esters may be due to the excessive formation of carbon monoxide (CO), which may be a primary cause of outgassing at the EoL.

In some designs, swelling of binder(s) in electrolyte(s) depends not just on the binder composition(s), but may also depend on the electrolyte composition(s). Furthermore, in some designs, such swelling (and the resulting performance reduction) often correlates with the reduction in elastic modulus upon exposure of binders to electrolytes. In this sense, the smaller the reduction in modulus in certain electrolytes, the more stable the binder-linked (nano)composite active particles/conductive additives interface becomes. In some designs, the reduction in binder modulus by over about 15-20% may result in a noticeable reduction in performance. In an example, the reduction in the binder modulus by about two times (2×) may result in a substantial performance reduction. In a further example, the reduction in modulus by about five or more times (e.g., about 5×-500×) may result in a very significant performance reduction. Therefore, selecting an electrolyte composition that does not induce significant binder swelling may be highly preferential for certain applications. In some examples, it may be preferable to select an electrolyte composition such that the binder modulus is reduced by less than about 30% (more preferably, less than about 10%) when exposed to electrolyte. In anodes which comprise more than one binder composition, in some designs, it may be preferable to select an electrolyte composition such that the elastic modulus of the at least one binder is not reduced by more than about 30% (more preferably, the elastic modulus is not reduced by more than about 10%) when exposed to electrolyte.

In some designs it is advantageous to use binders with functional groups which do not chemically or electrochemically interact with the electrolyte components, such as Li salts, FEC, VC, other co-solvents, and additives (e.g., Li salt additives, HT storage additives). The inventors have found that in some designs the presence of the carboxylic acid groups in the binders may cause undesirable excessive outgassing during the HT storage test. It may be advantageous in some designs to use a greater amount of branched esters, DTD, MMDS, dinitriles, trinitriles, LFO, sulfolane, or other compounds in ELY formulations to reduce HT outgassing.

In one or more embodiments of the present disclosure, it may be advantageous to have a total salt mole fraction in the electrolyte in the range from about 6 mol. % to about 20 mol. % (in other designs, from about 8 mol. % to about 20 mol. %), while utilizing one salt or a mixture of two, three or more salts. In one or more embodiments of the present disclosure, it may be advantageous to have a total salt concentration in the electrolyte in the range from approximately 0.8 M to approximately 1.8 M, while utilizing one salt or a mixture of two, three or more salts. Salt concentrations in the electrolyte that are too low (e.g., lower than about 0.8 M) may lead to excessive HT outgassing, reduced ELY conductivity, increased charge-transfer resistance in some designs (e.g., when high-capacity anode materials are used), particularly when high areal capacity electrodes are used (e.g., above about 4 mAh/cm²). Salt mole fractions (concentrations) in the electrolyte that are too high, on the other hand, may lead to reduced cycle life stability. Such excessive salt-induced degradation of cycle life stability characteristics may be related to reduced mobility of Li⁺ cations in the electrolyte in some designs, and in some designs, the formation of SEI exhibiting poor mechanical stability and/or chemical stability. Higher salt mole fractions (concentrations) may also lead to an increased electrolyte density and decreased electrolyte conductivity and cost in some designs, which may be undesirable for some applications such as low temperature applications. However, for some applications, in particular for high electrode capacity loadings (>about 4 mAh/cm²), an increased salt molarity, such as about 1.3-1.7 M (e.g., about 1.5 M), may be advantageously used to decrease charge-transfer resistance, which may be advantageous for low-temperature applications. Higher salt mole fractions (concentrations) may also lead to a faster charging and discharging rates in some designs (particularly in cells with low or medium electrode capacity loadings—e.g., about 1-4 mAh/cm²), which may be beneficial for some applications. Such improved rate performance may be related to the reduced anode and cathode charge-transfer resistance despite lower electrolyte conductivity. Such improved rate performance may be beneficial for fast-charge applications. Higher salt mole fractions (concentrations) may also lead to reduced HT outgassing during the HT storage test. Such improved outcome of the HT storage test may be related to the higher concentration of lithium hexafluorophosphate and formation of LiF protective layer on the surface of the cathode, which may impede other chemicals from the oxidative decomposition. The optimal salt concentration may depend on the particular cell design and electrolyte composition.

One aspect of the present disclosure is directed to an electrolyte for a lithium-ion battery. The electrolyte comprises a primary lithium salt and a solvent composition. In some implementations, the primary lithium salt may preferably be LiPF₆. In some implementations, a mole fraction of the primary lithium salt in the electrolyte may preferably be in a range of approximately 6 mol. % to approximately 20 mol. %. In some implementations, a concentration of the primary lithium salt in the electrolyte may preferably be in a range of approximately 0.65 M to approximately 2.1 M. In some implementations, the primary lithium salt is LiPF₆ and a mole fraction (concentration) of the primary lithium salt in the electrolyte is in a range of approximately 6 mol. % to approximately 16 mol. % or from approximately 0.65 M to approximately 1.7 M. In some designs, it may be advantageous to use an increased molarity of LiPF₆ to improve the operation of electrolyte under the fast charge conditions, such as from 3 C to 6 C. In some designs, it may be advantageous to use an increased molarity of LiPF₆ to improve the operation of electrolyte at low temperatures, such as from about −30° C. to about +10° C. In some designs, it may be advantageous to use an increased molarity of LiPF₆ to decrease HT outgassing. In some designs, an increased molarity of LiPF₆ may lead to the poor cycle life at room temperature. The optimal LiPF₆ molarity (concentration) may depend on the particular cell design and electrolyte composition.

High-temperature outgassing in a battery cell is an undesirable phenomenon that is observed to result from a heat treatment (also referred to as high-temperature storage treatment) of the battery cell after it has been charged to a high state-of-charge (SOC). The temperature of the heat treatment may vary depending on the specific heat treatment implementation, e.g., about 80° C., about 72° C., about 60° C., and other temperatures in a range of about 50° C. to about 90° C. The duration of the heat treatment may also vary depending on the specific heat treatment implementation, e.g., about 10 days, about 7 days, about 3 days, about 2.5 days, about 2 days, and other durations. In some Li-ion battery tests conducted by the inventors, the heat treatment was conducted at a temperature of 72° C. for a duration of 60 hours (2.5 days).

A measurement of the volume of the gases formed in the cell constitutes a metric for the high-temperature outgassing test. In a specific example, the volume of the gases in the cell at atmospheric pressure (“gas volume”), measured 1 h after the cell has been cooled to 25° C. after the high-temperature storage treatment under a high state-of-charge (SOC), is compared to the initial volume of the cell before the high-temperature storage treatment under a high state-of-charge (SOC). In some implementations, the gas volume preferably does not exceed 10 vol. % of the initial volume of the cell. In some implementations, the gas volume preferably does not exceed 3 vol. % of the initial volume of the cell. In some implementations, the gas volume preferably does not exceed about 1 vol. % of the initial volume of the cell.

In some implementations, the electrolyte may additionally include one or more charge-transfer additives. Certain Li salt additives as well as some other compounds may function as charge-transfer additives. In some implementations, one or more charge-transfer additives are selected from lithium difluorophosphate (LiPO₂F₂ or LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB). In some implementations, a mole fraction of the charge-transfer additives (e.g., lithium salt additives) may be in a range of approximately 0.1 mol. % to approximately 6 mol. %. In some implementations, a mole fraction of the charge-transfer additives may be in a range of approximately 0.5 mol. % to approximately 1.5 mol. %. In some implementations, a concentration of the additive lithium salt(s) in the electrolyte may preferably be in a range of approximately 0.05 M to approximately 0.15 M.

The inventors have found that in some designs it may be advantageous to use LFO additive to reduce HT outgassing, improve discharge voltage (V), and improve charge and discharge rates. In some designs, the presence of LFO may reduce HT outgassing by up to 100% compared to electrolyte formulations that do not contain LFO, which may be related to the formation of cathode surface film, which impedes other electrolyte components from oxidative decomposition. The inventors have found that the presence of LFO may lead to the reduced formation of carbon dioxide and carbon monoxide in the battery cells with LCO and/or NMC811 (NMC of approximate composition LiNi_{0.8}Co_{0.1}Mn_{0.1}O₂) as the cathode. In some designs, the presence of LFO may improve discharge V, which may be related to the formation of highly ionically conducting cathode CEI and anode SEI. In some designs, the presence of LFO may reduce cycle life which may be related to poor mechanical properties of the cathode CEI. In some other designs, LFO may reduce charge performance due to the chemical passivation on the surface of binders.

The inventors have found that in some designs it may be advantageous to use LiBF₄ additive to reduce HT outgassing, improve discharge voltage (V), and improve charge and discharge rates. In some designs, the electrolyte formulations which contain LiBF₄ may be advantageously used to reduce HT outgassing, which may be related to the formation of LiF on the cathode surface. The latter may originate from LiBF₄ due to the low oxidation potential of LiBF₄. However, it may also originate from LiPF₆ due to the changes in the Li-ion solvation shell and higher concentration of LiPF₆ contact ion pair in the presence of LiBF₄. In some designs, LiBF₄ may be advantageously used to increase recoverable capacity after the HT storage test due to an improved SEI stability. In some designs, it may be advantageous to use LiBF₄ to improve charge and discharge rates, which may be related to the formation of highly ionically conductive cathode CEI and anode SEI. In some designs, it may be advantageous to use LiBF₄ to decrease DC resistance, which may be related to the formation of highly conducting cathode CEI. In some designs, the use of LiBF₄, may lead to reduced cycle life due to the formation of resistive anode SEI. However, in some designs, more resistive anode SEI caused by LiBF₄ may be advantageous for stability at high temperature, including at HT storage and HT cycling. In some designs the use of LiBF₄ may lead to reduced ELY conductivity and increased ELY viscosity, which may be related to the stronger coordination of BF₄ to Li-ion. In some designs LiBF₄ may be advantageously used for cycling at elevated temperatures, such as about 45° C. or higher, due to an improved SEI stability.

The inventors have found that in some designs it may be advantageous to use LiDFOB additive to improve discharge voltage (V), and improve charge and discharge rates. In some designs, it may be advantageous to use LiDFOB to improve discharge voltage (V) and improve charge and discharge rates, which may be related to the formation of highly ionically conducting cathode CEI and anode SEI, respectively. In some other designs, the electrolyte formulations which contain LiDFOB may increase HT outgassing on the cathode, which may be related to the electrically conductive cathode CEI formed by LiDFOB. In some other designs, the electrolyte formulations which contain LiDFOB may increase DC resistance. In some designs, LiDFOB may be advantageously used to maintain stable SEI and slow down the resistance growth during cycling.

The inventors have found that in some designs it may be advantageous to use LiFSI additive to improve discharge voltage (V), and improve charge and discharge rates. In some designs, it may be advantageous to use LiFSI to improve discharge voltage (V) and improve charge and discharge rates, which may be related to the formation of highly ionically conducting cathode CEI and anode SEI, respectively. In some designs, LiFSI may be used as a main Li salt supplanting LiPF₆ in cells with NMC811 cathodes which operate at about 4.2V. In some designs, LiFSI may be advantageously used to enable high recoverable capacity after the HT storage test. In some designs, LiFSI may be advantageously used to improve HT cycling.

Accordingly, in some implementations, it may be advantageous to employ LFO, LiBF₄, LiFSI, and LiDFOB as charge-transfer additives in an electrolyte. In some cases, a total mole fraction of LFO, LiBF₄, LiFSI, and LiDFOB combined may be in a range of about 0.1 mol. % to about 6 mol. %, or in a range of 0.5 mol. % to about 1.5 mol. %. In some other designs, LiFSI may be used as a main Li salt in mole fractions from about 8 to about 20 mol. %, supplanting LiPF₆. In some other designs, LiFSI and LiPF₆ may be used as a mixture in an electrolyte.

In one or more embodiments of the present disclosure, an electrolyte for a lithium-ion battery includes a primary lithium salt and a solvent composition. The solvent composition may include (1) fluoroethylene carbonate (FEC), (2) at least one linear ester, and (3) at least one branched ester. A mole fraction of the FEC in the electrolyte may be in a range of about 2 mol. % or 4 mol. % to about 30 mol. % (e.g., about 2-4 mol. % or about 4-8 mol. % or about 8 to about 15 mol. % or about 15 to about 30 mol. %). A total mole fraction of the at least one linear ester and the at least one branched ester in the electrolyte may be at least about 45 mol. %, in some designs (e.g., about 45 to about 60 mol. % or about 60 to about 75 mol. % or about 75 to about 92 mol. % or about 60 to about 80 mol. % or about 80 to about 92 vol. %). A molar ratio of the at least one linear ester to the at least one branched esters may be in a range of about 1:10 to about 20:1 (in some designs, from about 1:10 to about 1:2; in other designs, from about 1:2 to about 1:1; in other designs, from about 1:1 to about 2:1; in other designs, from about 1.1:1 to about 1.4:1; in other designs, from about 2:1 to about 5:1; in other designs, from about 5:1 to about 10:1; in other designs, from about 10:1 to about 20:1). In other designs, molar ratio of the at least one linear ester to the at least one branched esters may be in a range of about 1:1 to about 10:1. The electrolyte may be substantially free of four-carbon cyclic carbonate. As used herein, an electrolyte that is “substantially free” of a component (in this case, four-carbon cyclic carbonate) may refer to an electrolyte that includes 0 wt. % of the component or about 0 wt. % of the component (e.g., trace amounts of the component may be present). Herein, an electrolyte may be considered to be “substantially free” of a component if the mole fraction of that component in the electrolyte is about 0.01 mol. % or less. Additionally, in some implementations, the electrolyte may also include at least one non-FEC cyclic carbonate. In some implementations, the at least one non-FEC cyclic carbonate may be ethylene carbonate, vinylene carbonate, or a combination thereof. In some implementations, a mole fraction of the at least one non-FEC cyclic carbonate in the electrolyte may be in a range of about 0.5 mol. % to about 30 mol. %, or in a range of about 1 mol. % to about 6 mol. %.

In one or more embodiments of the present disclosure, an electrolyte for a lithium-ion battery includes a primary lithium salt and a solvent composition. The solvent composition may include (1) fluoroethylene carbonate (FEC), (2) at least one ester (e.g., at least one ester, at least one branched ester, or at least one linear ester and at least one branched ester), and (3) at least one non-FEC cyclic carbonate. A mole fraction of the FEC in the electrolyte may be in a range of about 2 mol. % or 4 mol. % to about 30 mol. % (e.g., about 2-4 mol. % or about 4-8 mol. % or about 8-12 mol. % or about 12-20 mol. % or about 20-30 mol. %). A total mole fraction of the at least one ester may be at least about 40 mol. %, in some designs. A total mole fraction of the at least one non-FEC cyclic carbonate in the electrolyte may be in a range of about 0.5 mol. % to about 30 mol. %, in some designs. The electrolyte may be substantially free of four-carbon cyclic carbonate, in some designs. Additionally, in some implementations, a total mole fraction of all cyclic carbonates (FEC and non-FEC cyclic carbonates) does not exceed about 40 mol. %. In some implementations, a total mole fraction of the at least one ester in the electrolyte may be in a range of about 45 mol. % to about 70 mol. %. In some implementations, a molar ratio of the at least one ester to the at least one non-FEC cyclic carbonate may be in a range of about 1.5:1 to about 20:1.

In one or more embodiments of the present disclosure, an electrolyte for a lithium-ion battery includes a primary lithium salt and a solvent composition. The solvent composition may include (1) fluoroethylene carbonate (FEC), (2) at least one ester (e.g., at least one ester, at least one branched ester, or at least one linear ester and at least one branched ester), and (3) at least one linear carbonate. A mole fraction of the FEC in the electrolyte may be in a range of about 2 mol. % to about 30 mol. % (e.g., about 2-4 mol. % or about 4-8 mol. % or about 8 to about 15 mol. % or about 15 to about 30 mol. %). In some designs, a mole fraction of the at least one ester and one linear carbonate in the electrolyte may be at least about 45 mol. %. In some designs, a molar ratio of the at least one ester to the at least one linear carbonate may be in a range of about 1:1 to about 10:1. The electrolyte may be substantially free of four-carbon cyclic carbonate, in some designs. Additionally, in some implementations, the electrolyte may also include at least one non-FEC cyclic carbonate. In some implementations, the at least one non-FEC cyclic carbonate may be ethylene carbonate, vinylene carbonate, or a combination thereof. In some implementations, a mole fraction of the at least one non-FEC cyclic carbonate in the electrolyte may be in a range of about 0.5 mol. % to about 30 mol. %, or in a range of about 1 mol. % to about 6 mol. %.

In one or more embodiments of the present disclosure, a lithium-ion battery may include an anode current collector, a cathode current collector, an anode disposed on and/or in the anode current collector, a cathode disposed on and/or in the cathode current collector, and any one of the foregoing electrolytes ionically coupling the anode and the cathode. For example, there may be a separator interposed in a space between the anode and the cathode, with the electrolyte impregnating the separator. In some implementations, the anode may comprise a mixture of (A) Si-comprising particles (e.g., Si—C composite or nanocomposite particles comprising both Si and C atoms where the total weight of Si and C is the range of about 75-100% of the total composite weight (e.g., with the silicon part being arranged as active material particles and the carbon forming an inactive or substantially inactive or substantially less active part of scaffolding matrix with pores in which the silicon active material (e.g., nanoparticles) disposed and/or part of a carbon coating or shell arranged around the composite particles)), and (B) graphitic carbon particles comprising carbon (e.g., with carbon-comprising graphite as an active material) and being substantially free of silicon. Such an anode comprising a mixture is sometimes referred to as a blended anode herein. In some implementations, a mass of the silicon is in a range of about 1.5 wt. % to about 60 wt. % of the total mass of the anode (in other designs, in a range of about 3 wt. % to about 30 wt. % of the total mass of the anode).

In some implementations, the anode may comprise graphitic carbon particles comprising carbon, wherein the graphitic carbon particles are substantially free of silicon. The inventors have found that certain electrolytes may be particularly suitable for use with graphite anodes in lithium-ion batteries. Such a suitable electrolyte for a lithium-ion battery may include a primary lithium salt and a solvent composition. The solvent composition may include (1) fluoroethylene carbonate (FEC), (2) at least one ester (e.g., at least one ester, at least one branched ester, or at least one linear ester and at least one branched ester), and (3) at least one non-FEC cyclic carbonate. A mole fraction of the FEC in the electrolyte may be in a range of about 1 mol. % or 4 mol. % to about 30 mol. % (e.g., about 1-2 mol. % or about 2-4 mol. % or about 4-8 mol. % or about 8-15 mol. % or about 15-30 mol. %). A total mole fraction of the at least one ester may be at least about 40 mol. %, in some designs. A total mole fraction of the at least one non-FEC cyclic carbonate in the electrolyte may be in a range of about 0.5 mol. % to about 30 mol. %, or in a range of about 1 mol. % to about 6 mol. %, in some designs. The electrolyte may be substantially free of four-carbon cyclic carbonate, in some designs.

In one or more embodiments of the present disclosure, a preferred electrolyte for a lithium-ion battery may include cyclic carbonates (CCs) that promote the formation of the anode solid electrolyte interphase (SEI). FIG. 2 shows three illustrative examples of such preferred SEI “builders”: fluoroethylene carbonate (FEC) (202), vinylene carbonate (VC) (204), and ethylene carbonate (EC) (206). In some embodiments, FEC, VC and EC may be preferably present in the electrolyte. FEC, VC, and EC are examples of three-carbon cyclic carbonates.

In some implementations, the solvent composition of the electrolyte includes FEC. In some implementations, a mole fraction of FEC in the electrolyte may preferably be in a range of approximately 1 mol. % or 4 mol. % to approximately 30 mol. % (in some implementations, from about 1 mol. % to about 4 mol. %; in other implementations, from about 4 mol. % to about 10 mol. %; in other implementations, from about 10 mol. % to about 18 mol. %; in yet other implementations, from about 18 mol. % to about 30 mol. %). In some implementations, a mole fraction of FEC in the electrolyte may be in a range of approximately 1 mol. % to approximately 30 mol. %. In some preferred embodiments a mole fraction of FEC is in the range from about 4 mol. % to about 26 mol. %. In some implementations in which the mole fraction of the at least one ester in the electrolyte is in a range of approximately 45 mol. % to approximately 70 mol. % or approximately 80 mol. %, while the mole fraction of FEC in the electrolyte may preferably range from approximately 4 mol. % to approximately 26 mol. %. In some designs, when the mole fraction of FEC in the electrolyte is too low (e.g., in some implementations, less than approximately 1 to 8 mol. % or 1 to 4 mol. %, especially with high fraction of Si in the anode), the cycle life may degrade undesirably fast because of insufficient amount of suitable SEI builders. In some designs, there is more SEI formation when the FEC mole fraction is greater than approximately 8 mol. %. More robust SEI formation may occur when certain branched esters are present in the electrolyte. However, in some designs, increasing FEC mole fractions may undesirably be accompanied by increased high-temperature outgassing, and/or lower discharge voltages (due to the overly resistive SEI formation) and/or increased viscosity of the electrolyte (due to the high viscosity of FEC). Lower discharge voltages typically result in lower volumetric energy densities (VEDs), and higher viscosities result in lower ionic conductivities. For these reasons, the FEC mole fraction should preferably be set to below a certain threshold (e.g., mol. % threshold) in some designs. In some implementations, the FEC mole fraction should preferably not exceed approximately 30 mol. %. In some implementations, the FEC mole fraction preferably does not exceed approximately 20 mol. %. For FEC mole fractions in a preferred mole fraction range (such as a range of approximately 1 mol. % to approximately 30 mol. %, or a range of approximately 4 mol. % to approximately 26 mol. %, or a range of approximately 8 mol. % to 18 mol. %), high-temperature outgassing may be effectively mitigated by the addition of certain high-temperature storage additive(s) (e.g., nitrile additive(s)) or high-temperature storage additive(s) in combination with branched ester(s) as discussed hereinbelow. In some designs, within a preferred mole fraction range, the presence of FEC in the electrolyte may contribute to a preferable balance of sufficiently good cycle life, good ionic conductivity, high discharge voltage, mitigation of high-temperature outgassing, and/or good low-temperature performance.

In some implementations, a mole fraction of VC in the electrolyte may preferably be in a range of approximately 0.1 mol. % or 0.5 mol. % to approximately 5 mol. % (e.g., about 0.1-2.5 mol. % or about 0.5-2.5 mol. % or about 2.5-5 mol. %). In some implementations, the mole fraction of VC in the electrolyte may preferably be in a range of approximately 1 mol. % to approximately 3 mol. %. In some designs, within a preferred mole fraction range (e.g., in a range of approximately 1 mol. % to approximately 2 mol. %), the presence of VC in the electrolyte may contribute to a preferable balance of good cycle life, good ionic conductivity, and high discharge voltage.

In some implementations, when the mole fraction of VC in the electrolyte is too low (e.g., less than approximately 0.5 mol. %; especially for anodes with high Si fraction), the cycle life may degrade too fast because of insufficient amount of SEI formation or insufficiently robust property of the SEI. In some implementations, the cycle life may be better in electrolytes with VC mole fractions greater than about 0.5 mol. % or greater than about 2.5 mol. %. In some implementations, a higher mole fraction of VC in the electrolyte may result in a higher mole fraction of VC in the Li-ion solvation shell and a higher mole fraction of VC (or its decomposition products) in the SEI. Accordingly, a more robust SEI may be formed during initial 1-100 charge-discharge cycles when the VC mole fraction is greater than about 1.0 mol. %, greater than about 1.5 mol. %, greater than about 2.0 mol. %, greater than about 2.5 mol. %, greater than about 3.0 mol. %, greater than about 3.5 mol. %, or greater than about 4.0 mol. %. In some designs, because of its high dielectric constant (ε=126 at 25° C.), the presence of VC in the electrolyte may also enable formation of electrolytes with a higher Li-ion conductivity. Therefore, in some implementations, the ionic conductivity may be higher in electrolytes wherein the VC mole fraction is greater than about 0.5 mol. %, greater than about 1.0 mol. %, greater than about 1.5 mol. %, greater than about 2.0 mol. %, greater than about 2.5 mol. %, or greater than about 3.0 mol. %. Nevertheless, in some implementations, there is a greater tendency for high-temperature outgassing in electrolytes with higher VC mole fractions. In some implementations, a good balance among cycle life, ionic conductivity, high discharge voltage, and mitigation of high-temperature outgassing may be achieved when the VC mole fraction in the electrolyte is in a range of about 0.1 mol. % or 0.5 mol. % to about 5 mol. % (e.g., in some designs, in a range of about 0.1 mol. % or 0.5 mol. % to about 1 mol. %; in some other designs, in a range of about 1 mol. % to about 2 mol. %; in yet other designs, in a range of about 2 mol. % to about 3 mol. %; and in yet other designs, in a range of about 3 mol. % to about 5 mol. %).

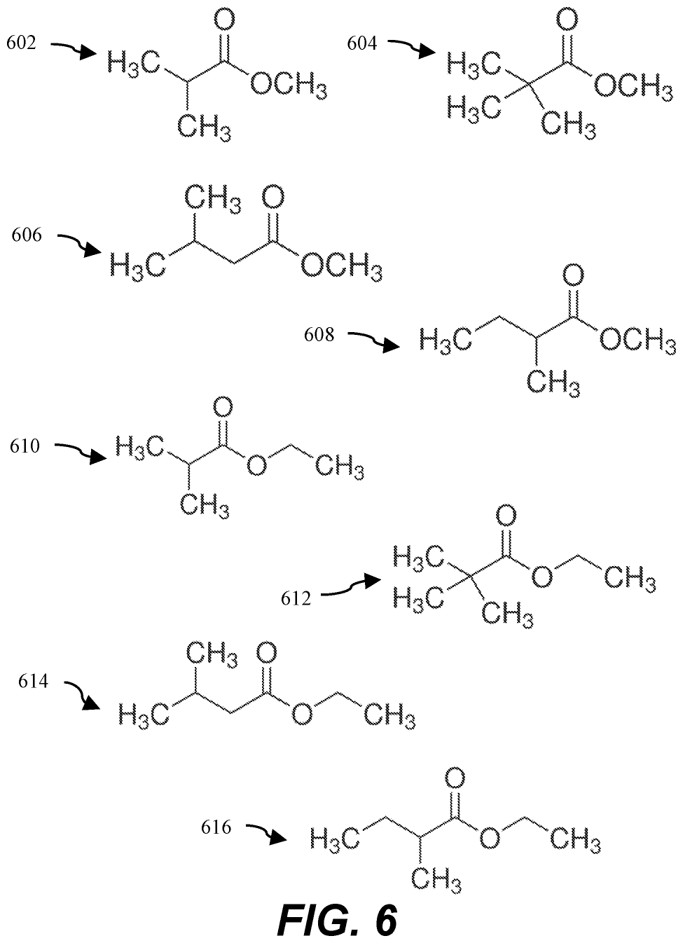

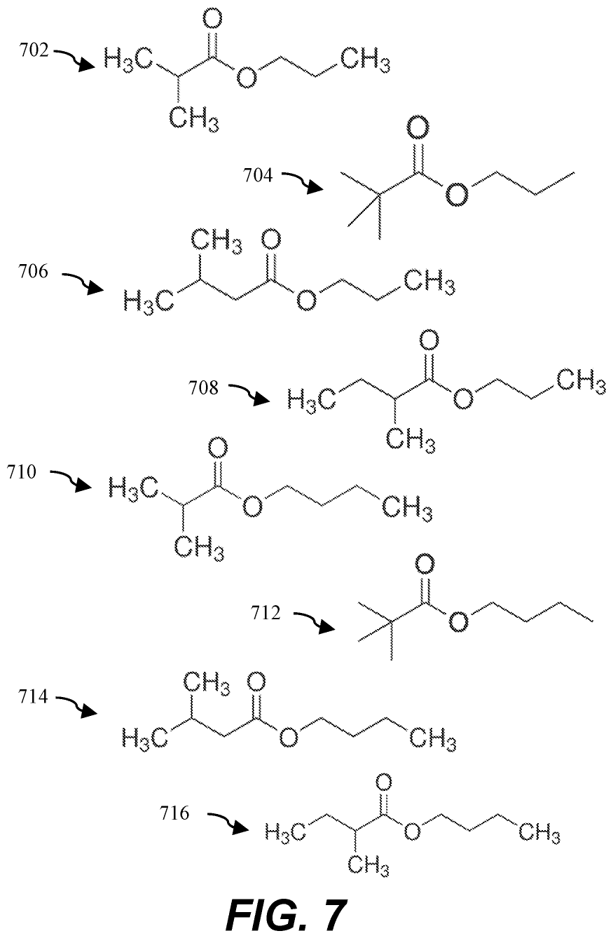

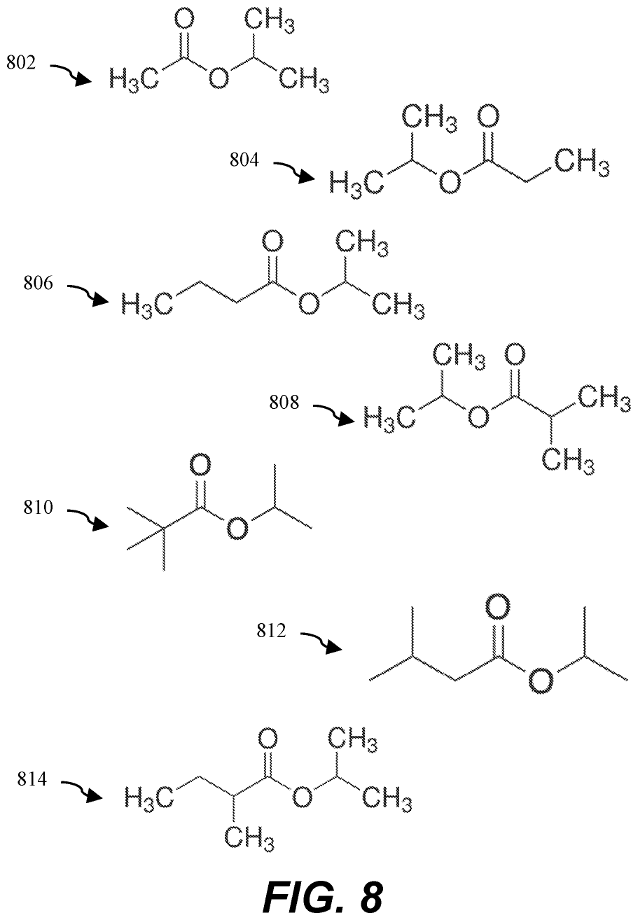

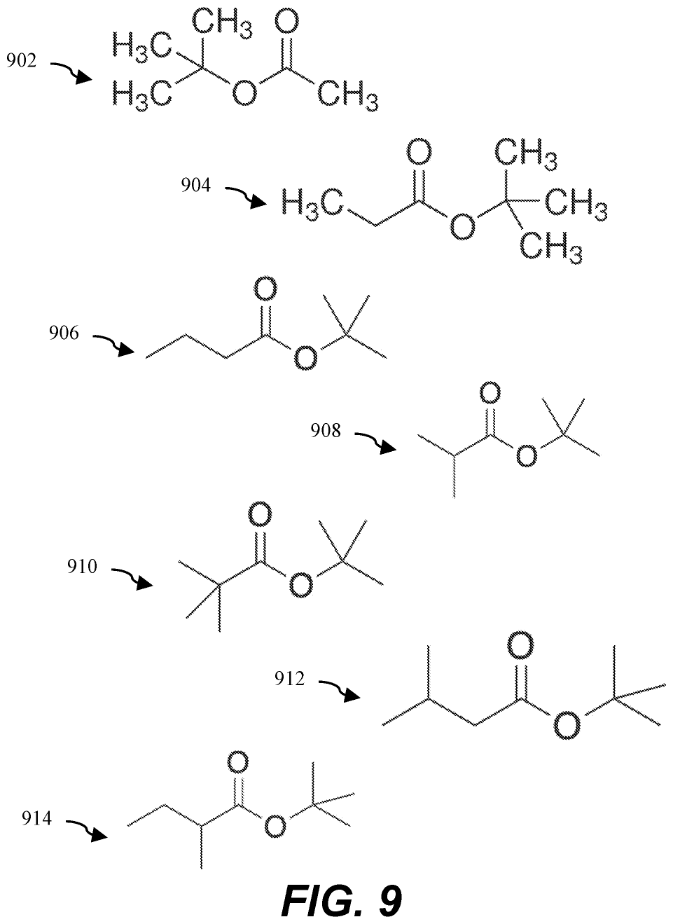

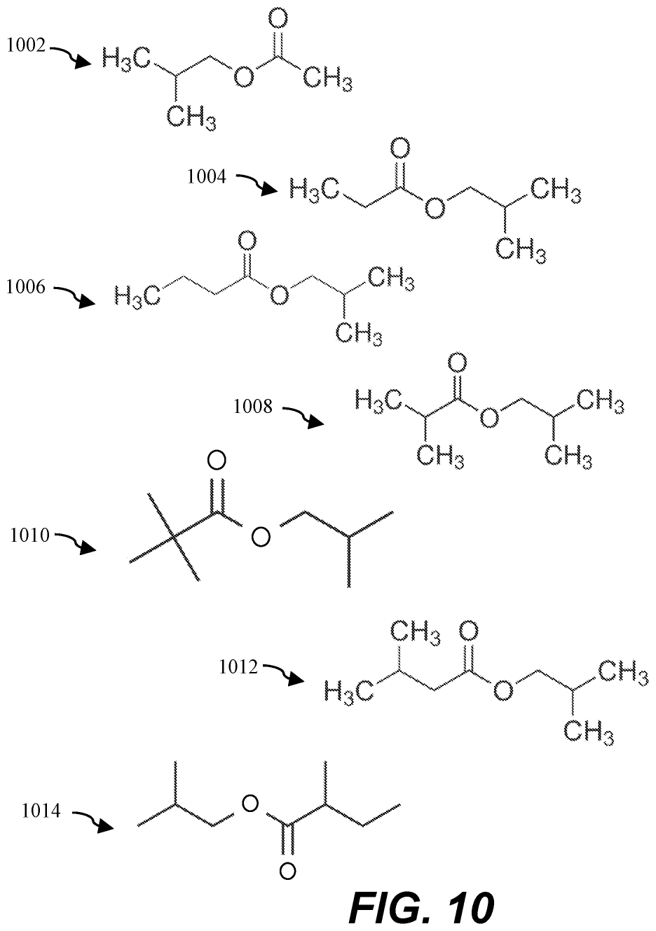

In one or more embodiments of the present disclosure, an electrolyte for a lithium-ion battery includes a primary lithium salt and a solvent composition. In some designs, the solvent composition may include at least one three-carbon cyclic carbonate and ethyl trimethylacetate (ET) (a branched ester, shown as structure 612 in FIG. 6). In some designs, the at least one three-carbon cyclic carbonate may include ethylene carbonate (EC). In some designs, a mole fraction of the ET in the electrolyte may range from about 30 mol. % to about 80 mol. % (e.g., about 30-40 mol. %; about 40-50 mol. %; about 50-60 mol. %; about 60-70 mol. %; about 70-80 mol. %). In some designs, a mole fraction of the ET in the electrolyte may be at least about 50 mol. %. In some designs, the electrolyte may be substantially free of four-carbon cyclic carbonate. In some implementations, a total mole fraction of the ET in the electrolyte may be in a range of about 50 mol. % to about 80 mol. %. In some implementations, a mole fraction of the at least one three-carbon cyclic carbonate in the electrolyte may be in a range of about 5 mol. % to about 40 mol. % (e.g., about 5-10 mol. %; about 10-20 mol. %; about 20-30 mol. %; about 30-40 mol. %). In some implementations, a mole fraction of the at least one three-carbon cyclic carbonate in the electrolyte may be in a range of about 20 mol. % to about 40 mol. % In some implementations, the at least one three-carbon cyclic carbonate may comprise FEC and/or VC. In some implementations, the electrolyte may be substantially free of linear carbonates. In some designs, the branched ester that is employed in this example electrolyte is ET. Alternatively, in other designs, any one or more of the branched esters illustrated in FIGS. 6, 7, 8, 9, and 10 may be suitable for use in similar example electrolytes. These branched esters are discussed hereinbelow.

In one or more embodiments of the present disclosure, a lithium-ion battery may include an anode current collector, a cathode current collector, an anode disposed on and/or in the anode current collector, a cathode disposed on and/or in the cathode current collector, and any one of the foregoing electrolytes ionically coupling the anode and the cathode. For example, there may be a separator interposed in a space between the anode and the cathode, with the electrolyte impregnating the separator.

In some implementations, the anode may comprise graphitic carbon particles comprising carbon, wherein the graphitic carbon particles are substantially free of silicon. The inventors have found that certain electrolytes may be particularly suitable for use with graphite (or hard or soft carbon) anodes in lithium-ion batteries. Such a suitable electrolyte for a lithium-ion battery may include a primary lithium salt and a solvent composition. In some designs, the solvent composition may include at least one three-carbon cyclic carbonate and ethyl trimethylacetate (ET) (a branched ester, shown as structure 612 in FIG. 6). In some designs, the at least one three-carbon cyclic carbonate may include ethylene carbonate (EC). In some designs, a mole fraction of the ET in the electrolyte may be at least about 50 mol. %. The electrolyte may be substantially free of four-carbon cyclic carbonate, in some designs.

In some implementations, it may be advantageous to use ethylene carbonate (EC) as an SEI “builder” for the blended anode. In some implementations, EC may be used as an SEI “builder” to build SEI on graphite material, which helps to improve cycle life. Accordingly, the use of EC in an electrolyte may be beneficial in Li-ion battery cells in which the anode includes graphite, such as blended anodes (e.g., mixture of silicon-carbon composite particles and graphitic carbon particles) and “pure” graphite anodes (e.g., the anode active material includes graphitic carbon particles but does not include silicon-carbon composite particles). The use of EC in an electrolyte may be particularly beneficial in anodes in which the anode active material includes a large fraction of graphitic carbon particles (e.g., about 90 wt. % to about 100 wt. %). In some implementations, it may be advantageous to use from about 1 mol. % to about 32 mol. %, or 20 mol. % to about 40 mol. %, or about 20 mol. % to about 32 mol. % of EC in the electrolyte. In some implementations, a good balance among cycle life, ionic conductivity, cell resistance, discharge voltage, high-temperature cycling, and low-temperature performance may be achieved when the mole fraction of EC in the electrolyte is about 1 mol. % to about 32 mol. %, or about 20 mol. % to about 40 mol. %, or about 20 mol. % to about 32 mol. %.

Propylene carbonate (PC) is known as a co-solvent in electrolyte formulations for Li-ion battery cells. In some implementations of Li-ion batteries as considered herein, such as Li-ion batteries employing blended anodes such as blended anodes (e.g., mixture of silicon-carbon composite particles and graphitic carbon particles) and “pure” graphite anodes (e.g., the anode active material includes graphitic carbon particles but does not include silicon-carbon composite particles), the inventors have found that PC may decrease the electrolyte's ionic conductivity and may be inferior SEI “builders.” Accordingly, in some implementations, electrolytes that include PC may exhibit one or more of the following characteristics, compared to some other electrolytes that do not include PC: increased high-temperature outgassing, lower discharge voltage, and inferior cycle life. In some implementations, it may be preferable to avoid the use of PC in electrolytes (e.g., either partially or altogether). PC is an example of a four-carbon cyclic carbonate. In some implementations, it may be preferable to avoid the use of four-carbon cyclic carbonates in electrolytes. In some implementations, an electrolyte for a lithium-ion battery may be substantially free of four-carbon cyclic carbonates. In some implementations, an electrolyte for a lithium-ion battery may be substantially free of propylene carbonate.

The mechanism of the decomposition of cyclic carbonates (CCs) at high temperatures may be different on the cathode and on the anode. For example, the oxidation of CC with the formation of CO and CO₂ on the cathode may be a result of various electrolyte-cathode chemical or electrochemical interactions and result in outgassing. Several mechanisms of the decomposition of CC on the cathode may take place. For example, oxygen which may be generated on the cathode at a high state of charge (SOC) may oxidize CCs, leading to the generation of CO/CO₂ mixtures. Also, the hydrogen (H) abstraction from the CC, as a result of an oxidation, may result in the disproportionation of the five-membered ring of the CC with the formation of CO and CO₂. Also, the electron abstraction from VC might accelerate the formation of gaseous products. Also, the changes in the magnitude of ion pairing of Li salt, which may be tuned by changing the CC concentration, may result in increased outgassing at elevated temperatures. For example, increased ion pairing of Li⁺ and PF₆⁻ may result in reduced high-temperature (HT) outgassing due to the decomposition of LiPF₆ and formation of LiF protective layer.

The mechanism of gassing on the anode may be very different from that on the cathode. At high SOC, the anode-sourced electrons may work as nucleophiles to attack positively charged carbonyls of a CC. The resulting decomposition product may be CO₂. In addition to CO₂, the formation of H₂, CO, CH₄, C₂H₄, C₂H₆, C₃H₆ and/or C₃H₈ may also take place as a result of chemical or electrochemical interactions of the electrolyte and the anode surface and may induce substantial high-temperature (HT) outgassing.

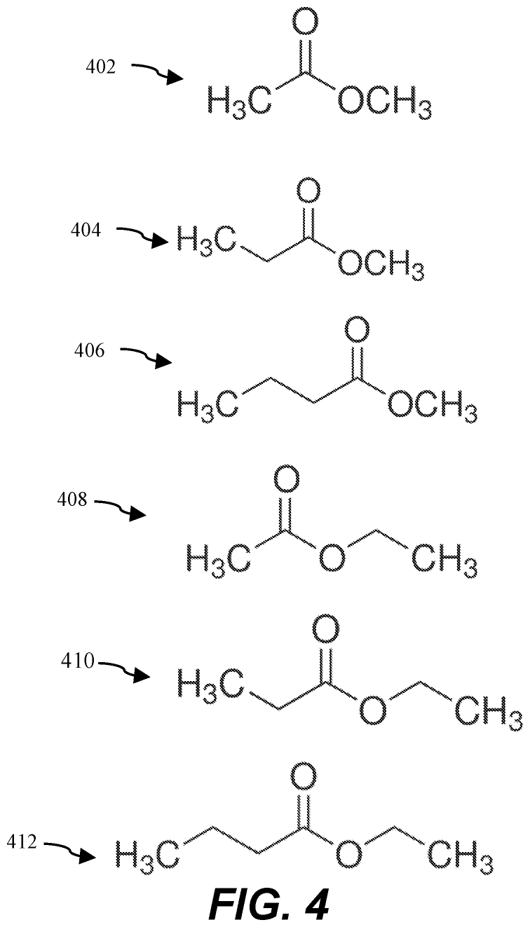

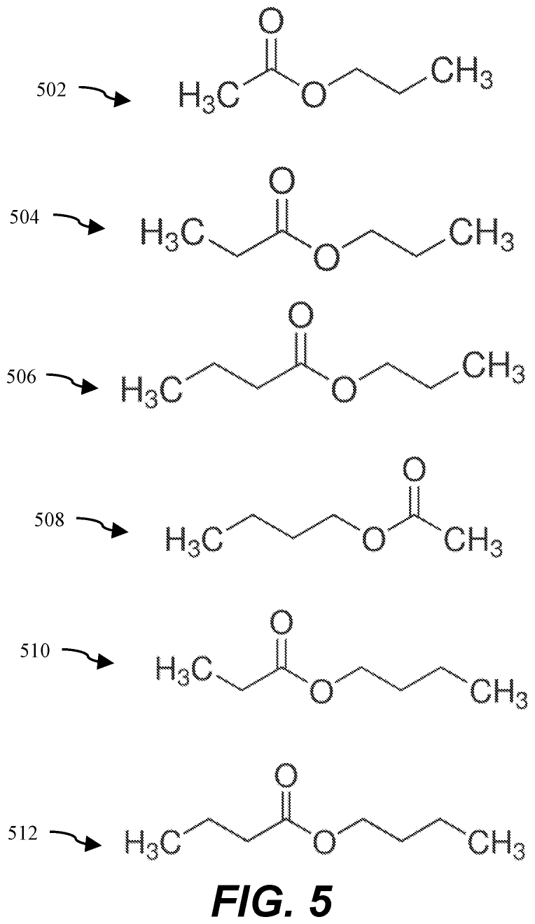

In one or more embodiments of the present disclosure, a preferred electrolyte for a lithium-ion battery may include at least one linear ester (ES) as a main (e.g., about 20 to about 70 mol. % of the electrolyte) co-solvent. FIGS. 4 and 5 show illustrative examples of some of the suitable linear esters: methyl acetate (sometimes abbreviated as MA herein, structure 402), methyl propionate (MP, 404), methyl butyrate (MB, 406), ethyl acetate (EA, 408), ethyl propionate (EP, 410), ethyl butyrate (EB, 412), propyl acetate (PA, 502), propyl propionate (PP, 504), propyl butyrate (PB, 506), butyl acetate (BA, 508), butyl propionate (BP, 510), and butyl butyrate (BB, 512).

In one or more embodiments of the present disclosure, a preferred electrolyte for a lithium-ion battery may include at least one branched ester (ES) as a main (e.g., about 20 to about 70 mol. %) co-solvent or one of the major co-solvents. In some designs, two, three or more branched esters may advantageously be used. FIGS. 6, 7, 8, 9, and 10 show illustrative examples of some of the suitable branched esters: methyl isobutyrate (MI, 602), methyl trimethylacetate (MT, 604), methyl isovalerate (MIV, 606), methyl 2-methylbutyrate (MMB, 608), ethyl isobutyrate (EI, 610), ethyl trimethylacetate (ET, 612), ethyl isovalerate (EIV, 614), ethyl 2-methylbutyrate (EMB, 616), propyl isobutyrate (PI, 702), propyl trimethylacetate (PT, 704), propyl isovalerate (PIV, 706), propyl 2-methylbutyrate (PMB, 708), butyl isobutyrate (BI, 710), butyl trimethylacetate (BT, 712), butyl isovalerate (BIV, 714), butyl 2-methylbutyrate (BMB, 716), isopropyl acetate (IPA, 802), isopropyl propionate (IPP, 804), isopropyl butyrate (IPB, 806), isopropyl isobutyrate (IPI, 808), isopropyl trimethylacetate (IPT, 810), isopropyl isovalerate (IPIV, 812), isopropyl 2-methylbutyrate (IPMB, 814), tert-butyl acetate (TBA, 902), tert-butyl propionate (TBP, 904), tert-butyl butyrate (TBB, 906), tert-butyl isobutyrate (TBI, 908), tert-butyl trimethylacetate (TBT, 910), tert-butyl isovalerate (TBIV, 912), tert-butyl 2-methylbutyrate (TBMB, 914), isobutyl acetate (IBA, 1002), isobutyl propionate (IBP, 1004), isobutyl butyrate (IBB, 1006), isobutyl isobutyrate (IBI, 1008), isobutyl trimethylacetate (IBT, 1010), isobutyl isovalerate (IBIV, 1012), and isobutyl 2-methylbutyrate (IBMB, 1014).

In some designs, suitable mixture of ester compounds may contribute to better ionic conductivity in the electrolyte, better discharge performance (also referred to as “C-rate performance”), better fast charge performance, reduced HT outgassing, reduced end-of-life outgassing, better calendar life, and/or better low-temperature performance. In one or more embodiments of the present disclosure, a preferred electrolyte for a lithium-ion battery may include a mixture of at least one linear ester and at least one branched ester. In some implementations, a total mole fraction of the mixture (of the at least one linear ester and the at least one branched ester) may be at least about 45 mol. %. In some implementations, the total mole fraction of the mixture (of the at least one linear ester and the at least one branched ester) may be in a range of about 60 mol. % to about 75 mol. %. In some implementations, a molar ratio of the at least one linear ester to the at least one branched ester may be in a range of about 1:10 to about 20:1 (in some designs, from about 1:10 to about 1:5; in other designs, from about 1:5 to about 1:2; in other designs, from about 1:2 to about 1:1; in other designs, from about 1:1 to about 2:1; in other designs, from about 2:1 to about 5:1; in other designs, from about 5:1 to about 10:1; in yet other designs, from about 10:1 to about 20:1; in yet other designs, from about 1:1 to about 10:1). In some implementations, a molar ratio of the at least one linear ester to the at least one branched esters may be in a range of about 1:1 to about 2:1. In some implementations, a molar ratio of the at least one linear ester to the at least one branched esters may be in a range of about 1.1:1 to about 1.4:1.

In some designs, suitable ester(s) may contribute to better ionic conductivity in the electrolyte, better discharge performance (also referred to as “C-rate performance”), and/or better low-temperature performance. In some designs, the presence of branched esters in electrolytes that contain FEC, VC, and/or EC may lead to formation of a more robust SEI. Accordingly, in some designs, electrolytes containing branched esters may exhibit good (in some designs, improved) cycle life. In one or more embodiments of the present disclosure, a mole fraction of ester(s) (linear esters, branched esters, or a mixture of linear esters and branched esters) in the electrolyte may preferably be in a range of approximately 20 mol. % to approximately 70 mol. % or approximately 80 mol. %. In other embodiments, the mole fraction of esters in the electrolyte may preferably be in a range of approximately 45 mol. % to approximately 70 mol. % or approximately 80 mol. %. In other embodiments, the mole fraction of esters in the electrolyte may preferably be in a range of approximately 30 mol. % to approximately 50 mol. %. In other embodiments, the mole fraction of esters in the electrolyte may preferably be in a range of approximately 50 mol. % to approximately 70 mol. % or approximately 80 mol. %. In other embodiments, the mole fraction of esters in the electrolyte may preferably be at least approximately 30 mol. %. In other embodiments, the mole fraction of esters in the electrolyte may preferably be at least approximately 40 mol. %. In other embodiments, the mole fraction of esters in the electrolyte may preferably be at least approximately 50 mol. %. In other embodiments, the mole fraction of esters in the electrolyte may preferably be at least approximately 60 mol. %.

In some implementations, EP (410), a linear ester, may contribute to lower viscosity, higher discharge voltages, low cell resistance, better C-rate performance, and/or better low-temperature performance. However, in some designs, the presence of EP in an electrolyte may also undesirably lead to high-temperature outgassing, end-of-life outgassing, shorter cycle life, and/or evolution of gaseous by-products, such as hydrogen, on the anode. Accordingly, in some designs, a mole fraction of EP in the electrolyte may preferably be in a range of approximately 20 mol. % to approximately 70 mol. % or approximately 80 mol. % (in some designs, from about 30 mol. % to about 60 vol. %). Within this preferred mole fraction range, in some designs, the presence of EP in the electrolyte may contribute to a favorable balance of good cycle life, high discharge voltage, and/or mitigation of high-temperature outgassing and/or end-of-life-outgassing in a suitable electrolyte (which, in some designs, may also comprise SEI “builders” or a combination of SEI “builders” and branched esters).

In some implementations, EA (408), a linear ester, may contribute to lower viscosity, higher discharge voltages, low cell resistance, better C-rate performance, and/or better low-temperature performance. However, in some designs, the presence of EA in an electrolyte may also undesirably lead to high-temperature outgassing, end-of-life outgassing, shorter cycle life, and/or evolution of gaseous by-products, such as methane, on the anode. Accordingly, in some designs, a mole fraction of EP in the electrolyte may preferably be in a range of approximately 20 mol. % to approximately 80 mol. % (in some designs, from about 30 mol. % to about 60 vol. %). Within this preferred mole fraction range, in some designs, the presence of EA in the electrolyte may contribute to a favorable balance of good cycle life, high discharge voltage, and/or mitigation of high-temperature outgassing and/or end-of-life-outgassing in a suitable electrolyte (which, in some designs, may also comprise SEI “builders” or a combination of SEI “builders” and branched esters). In some designs, the mixture of EA and EP may contribute to a favorable balance of good cycle life, high discharge voltage, low cell resistance, and high electrolyte conductivity. In some implementations, a mixture of EA (linear ester) and EP (linear ester) may be employed in a suitable electrolyte (e.g., an electrolyte employing a three-carbon cyclic carbonate such as FEC), wherein a molar ratio of the EA (linear ester) to the EP (linear ester) may be in a range of about 1:10 to about 20:1 (in some designs, from about 1:10 to about 1:5; in other designs, from about 1:5 to about 1:2; in other designs, from about 1:2 to about 1:1; in other designs, from about 1:1 to about 2:1; in other designs, from about 2:1 to about 5:1; in other designs, from about 5:1 to about 10:1; in yet other designs, from about 10:1 to about 20:1). In some implementations, a molar ratio of the EA (linear ester) to the EP (linear ester) may be in a range of about 1:1.1 to about 1:1.4.

In some implementations, ethyl isobutyrate (EI) (610), a branched ester, may contribute to better cycle life, decreased high-temperature outgassing, and/or decreased end-of-life outgassing compared to the linear (non-branched) ethyl propionate (EP) (410). Furthermore, the flash point of EI which is approximately 20° C., is higher than that of EP which is approximately 12° C. However, in some designs, the presence of EI (or other branched esters) in an electrolyte may lead to a slight reduction of the discharge voltage and a reduction of the C-rate performance (e.g., due to increased charge-transfer resistance). In some designs, this reduction of C-rate performance may be mitigated by adding certain charge-transfer additive salt(s) (e.g., lithium difluorophosphate (LiPO₂F₂), abbreviated LFO, or lithium tetrafluoroborate (LiBF₄), among others and their various combinations). Accordingly, in some designs, a mole fraction of EI in the electrolyte may preferably be in a range of approximately 25 mol. % to approximately 80 mol. %. Within this preferred mole fraction range, in some designs, the presence of EI in the electrolyte may contribute to a suitable balance of good cycle life, high discharge voltage, and/or mitigation of high-temperature outgassing and/or end-of-life-outgassing in a suitable electrolyte (which, in some designs that may preferably comprise cyclic carbonates). In some implementations, a mixture of EP (linear ester) and EI (branched ester) may be employed in a suitable electrolyte (e.g., an electrolyte employing a three-carbon cyclic carbonate such as FEC), wherein a molar ratio of the EP (linear ester) to the EI (branched ester) may be in a range of about 10:1 to about 20:1 (in some designs, from about 1:10 to about 1:5; in other designs, from about 1:5 to about 1:2; in other designs, from about 1:2 to about 1:1; in other designs, from about 1:1 to about 2:1; in other designs, from about 2:1 to about 5:1; in other designs, from about 5:1 to about 10:1; in yet other designs, from about 10:1 to about 20:1; in yet other designs, from about 1:1 to about 10:1). In some implementations, a molar ratio of the EP (linear ester) to the EI (or another branched ester) may be in a range of about 1.1:1 to about 1.4:1.

Ethyl isovalerate (EIV) (614) is another example of a branched ester that may be used to improve some of the performance characteristics of a Li-ion battery. Accordingly, in some implementations, a mixture of EP (linear ester) and EIV (branched ester) may be employed in a suitable electrolyte (e.g., an electrolyte employing a three-carbon cyclic carbonate such as FEC), wherein a molar ratio of the EP (linear ester) to the EIV (branched ester) may be in a range of about 1:1 to about 10:1. In some implementations, a molar ratio of the EP (linear ester) to the EIV (branched ester) may be in a range of about 1.1:1 to about 1.4:1. Additionally, in some implementations, a mixture of EP (linear ester), EI (branched ester), and EIV (branched ester) may be employed in a suitable electrolyte (e.g., an electrolyte employing a three-carbon cyclic carbonate such as FEC), wherein a molar ratio of the EP (linear ester) to the sum of the EI and EIV (branched esters) may be in a range of about 1:10 to about 20:1 (in some designs, from about 1:10 to about 1:5; in other designs, from about 1:5 to about 1:2; in other designs, from about 1:2 to about 1:1; in other designs, from about 1:1 to about 2:1; in other designs, from about 2:1 to about 5:1; in other designs, from about 5:1 to about 10:1; in yet other designs, from about 10:1 to about 20:1; in yet other designs, from about 1:1 to about 10:1). In some implementations, a molar ratio of the EP (linear ester) to the sum of the EI and EIV (branched esters) may be in a range of about 1.1:1 to about 1.4:1.

In some implementations, it may be beneficial to use a branched ester, ethyl trimethyl acetate (ET) (612), as an SEI builder for anodes which employ blended anodes including graphitic carbon particles and Si—C composite particles. In some designs, the presence of ET in an electrolyte may increase the cycle life of blended anodes containing graphite particles. In some designs, an ET-comprising electrolyte may be applied to either graphite anodes or blended anodes in which graphite is mixed with Si—C composite particles. In some designs, the presence of ET in the electrolyte could contribute to decreased HT outgassing at the anodes, which may be graphite anodes or blended anodes of graphite (e.g., graphitic carbon particles) and Si—C composite particles. In some designs, the presence of ET in the electrolyte could contribute to decreased HT outgassing at the cathodes. The inventors have found that ET may contribute to the formation of robust anode SEI on both graphitic carbon particles and Si—C composite particles. The inventors have also found that ET may contribute to the formation of robust CEI on the cathode particles. In some designs, the use of ET in the electrolyte could be beneficial for high voltage cathode materials (e.g., LCO, NMC811). In some designs, the use of ET in the electrolyte could be beneficial for cathodes featuring polycrystalline microstructures, thereby enabling the formation of robust CEI. In some implementations, ET could be used in an electrolyte containing ethylene carbonate (EC). In some other designs, it may be more advantageous to use ET in an electrolyte with FEC to improve low temperature performance. In some designs, it may be advantageous to use ET as a main co-solvent with the molar fraction of ET in the electrolyte being at least about 50 mol. %. In some other designs it may be advantageous to use ET as a secondary co-solvent with a molar fraction of ET in the electrolyte ranging from about 5 mol. % to about 50 mol. %.

In one or more embodiments of the present disclosure, a preferred electrolyte for a Li-ion battery may include at least one linear carbonate (LC). FIG. 3 shows two examples of linear carbonates: dimethyl carbonate (DMC) (302) and ethyl methyl carbonate (EMC) (304). The molecular weights of these compounds are about 90.08 g/mol (DMC) and about 104.10 g/mol (EMC), respectively. Another example of a linear carbonate is diethyl carbonate (DEC), which has a molecular weight of about 118.13 g/mol. These linear carbonates are notable for their relatively low viscosities (approximately 0.59 cP for DMC and approximately 0.65 cP for EMC, at 25° C.). Accordingly, in some designs, the viscosity of an electrolyte may be decreased by adding one or more of these linear carbonates. For example, in some electrolyte formulations, EMC may increase discharge voltage and improve low-temperature performance. In some designs, linear carbonates may be used in an electrolyte at relatively low mole fractions, such as in a range greater than about 0 mol. % and up to approximately 6 mol. % (e.g., in a range greater than 0 mol. % and up to about 1 mol. %, in a range of about 1 mol. % to about 3 mol. %, or in a range of about 3 mol. % to about 6 mol. %). In other designs, the LC may be omitted entirely or the electrolyte may be substantially free of linear carbonates. In some implementations, the electrolyte may be substantially free of diethyl carbonate, dimethyl carbonate, and ethyl methyl carbonate. In other designs, linear carbonates may be used in an electrolyte in a range of about 1 mol. % to about 17 mol. % (e.g., from about 6 mol. % to about 17 mol. %; in other designs, from about 1 mol. % to about 20 molo. %), or in a range of about 17 mol. % to about 30 mol. %.

In some designs, it may be beneficial to avoid using linear carbonates in electrolytes that contain FEC. For example, this may apply to electrolytes comprising (1) a solvent composition comprising fluoroethylene carbonate (FEC), at least one linear ester, and at least one branched ester, or (2) a solvent composition comprising fluoroethylene carbonate (FEC), at least one ester, and at least one non-FEC cyclic carbonate. Accordingly, in some implementations, the electrolyte may be substantially free of diethyl carbonate, dimethyl carbonate, and ethyl methyl carbonate. In some implementations, the electrolyte may be substantially free of linear carbonates. In some designs, the combination of FEC with linear carbonates may decrease the cycle life due to the structure of Li-ion solvation shell (e.g., FEC is displaced from the solvation shell in the presence of linear carbonates) and due to the chemical degradation of FEC by linear carbonates or the products of electrochemical decomposition of linear carbonates (such as ethoxides). In some implementations, the FEC mole fraction preferably does not exceed approximately 20 mol. %. In some implementations, the FEC mole fraction may preferably be in a range of about 4 mol. % to about 20 mol. %. In some implementations (e.g., in anodes with low Si wt. %), the FEC mole fraction may be lower than about 4 mol. % (e.g., from about 1 mol. % to about 4 mol. %).

The inventors have investigated the use of ethylene carbonate (EC) (206), a three-carbon cyclic carbonate, in certain electrolytes with the aim of improving lithium-ion batteries including graphite anodes and blended anodes of graphite particles and Si—C composite particles. The inventors have found that EC may be effective as a main SEI “builder”. The inventors have found that in some designs it is more advantageous to use EC as a main SEI builder for electrolytes in lithium-ion batteries (with graphite anodes or blended anodes comprising graphite particles and Si—C composite particles), when the electrolytes contain certain linear carbonates as main co-solvents. However, it may be advantageous to avoid using (or reduce the mole fraction of) FEC in the electrolytes containing EC. In some designs, the presence of FEC and EC in electrolyte could be disadvantageous to the cycle life of the anodes with “pure” graphite anodes or blended anodes of graphite and Si—C composite particles. These phenomena could be related to the structure of the Li-ion solvation shell in which FEC is displaced from the Li-ion solvation shell in the presence of EC.

In one or more embodiments of the present disclosure, an electrolyte for a lithium-ion battery includes a primary lithium salt and a solvent composition. The solvent composition may include fluoroethylene carbonate (FEC) and at least one linear carbonate. A mole fraction of the FEC in the electrolyte may be in a range of about 2-4 mol. % to about 20 mol. %. In some designs, a total mole fraction of the at least one linear carbonate in the electrolyte is at least about 40 mol. %. In some designs, the electrolyte may be substantially free of four-carbon cyclic carbonate. In some implementations, it may be preferable to select ethyl methyl carbonate and/or dimethyl carbonate as the at least one linear carbonate, and to avoid using diethyl carbonate (molecular weight of about 118). In some implementations, it may be preferable to select dimethyl carbonate as the at least one linear carbonate. The electrolyte may be substantially free of any linear carbonate of molecular weight greater than 117. In some implementations, a total mole fraction of the linear carbonate(s) in the electrolyte may be in a range of about 60 mol. % to about 75 mol. %. In some implementations, the electrolyte may additionally include at least one non-FEC cyclic carbonate, which may be selected from ethylene carbonate and vinylene carbonate. In some implementations, the electrolyte additionally includes a non-FEC cyclic carbonate, and a mole fraction of the at least one non-FEC cyclic carbonate in the electrolyte is in a range of about 1 mol. % to about 30 mol. %, or in a range of about 15 mol. % to about 30 mol. %.

In one or more embodiments of the present disclosure, a lithium-ion battery may include an anode current collector, a cathode current collector, an anode disposed on and/or in the anode current collector, a cathode disposed on and/or in the cathode current collector, and any one of the foregoing electrolytes ionically coupling the anode and the cathode. For example, there may be a separator interposed in a space between the anode and the cathode, with the electrolyte impregnating the separator. In some implementations, the anode may comprise a mixture of (A) Si-comprising particles (e.g., silicon-carbon nanocomposite particles comprising silicon and carbon in the total of about 75-100 wt. %), and (B) graphitic carbon particles comprising carbon and being substantially free of silicon. Such an anode comprising a mixture is sometimes referred to as a blended anode herein. In some implementations, a mass of the silicon is in a range of about 1 wt. % to about 60 wt. % of a total mass of the anode (in other designs, from about 3 wt. % to about 30 wt. %).

The inventors have found that in some implementations in which the anode comprises a graphite anode or blended anode of graphite and Si—C composite particles, it may be advantageous to use electrolytes that contain FEC but do not contain EC. In some designs, it may be beneficial to use an ester as a main co-solvent in combination with FEC. In some designs, electrolytes that contain esters and FEC are beneficial for improved cycle life of graphite anodes and blended anodes of graphite and Si—C composite particles. In some designs, the presence of EC in such electrolytes may lead to the decreased cycle life. This phenomenon could be due to the poorer SEI building properties of EC compared to FEC. In some designs, the fraction of one or more esters in such electrolytes may exceed about 50 mol. %. In some other designs, the combination of linear and branched esters may be beneficial to increase discharge voltage, improve cycle life, and decrease charge-transfer resistance.

In some designs, the surface of a cathode and an anode may preferably be protected by one or more high-temperature storage additives (e.g., nitrile additives as well as other compounds) to decrease high-temperature (HT) outgassing and mitigate transition metal dissolution. As used herein, the term “nitriles” refers to organic molecules which feature one or more CN (nitrile) groups. In some preferable examples, the nitriles may be dinitriles. In other preferable examples, the nitriles may be trinitriles. In other preferable examples, the nitriles may be tetrakis-nitriles. In other preferable examples, the nitriles may be mononitriles.

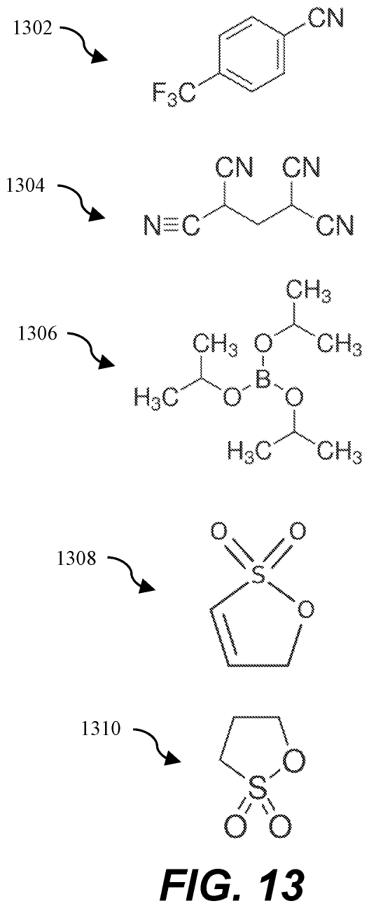

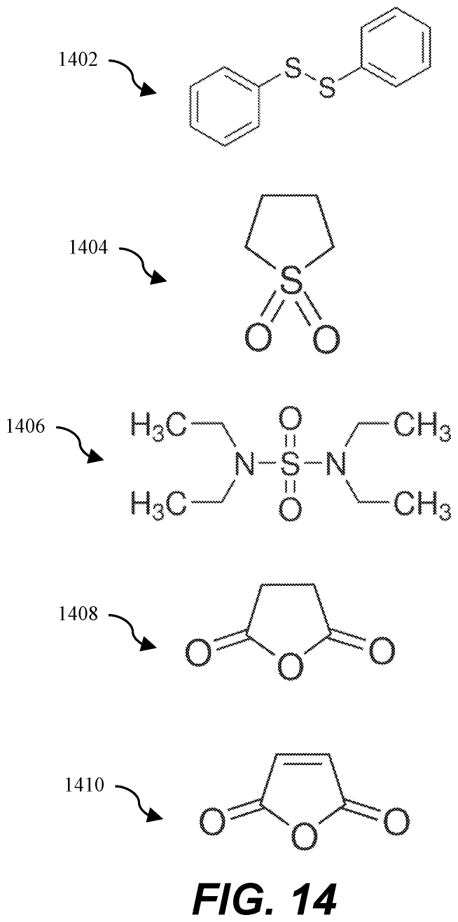

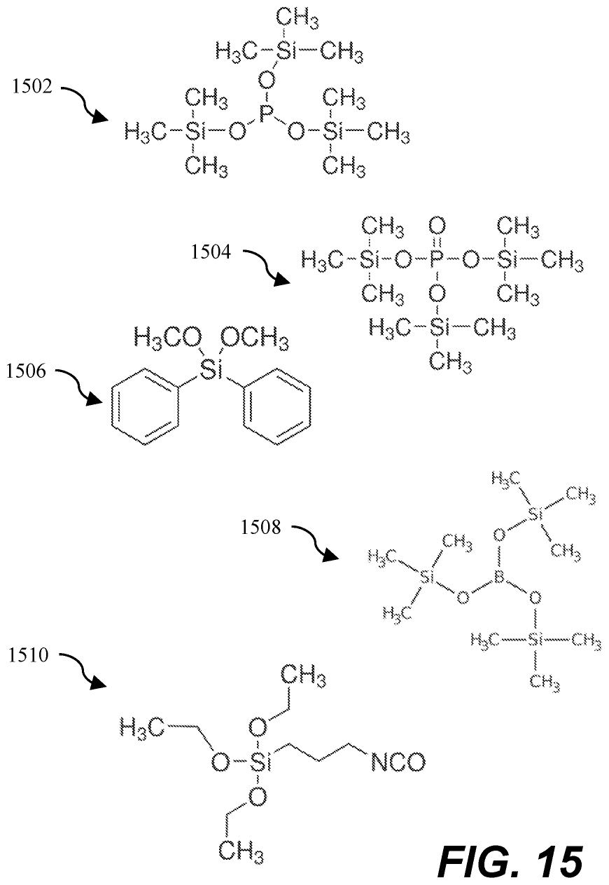

The chemical structures of some compounds that may be used as high-temperature storage additives are shown in FIGS. 11, 12, 13, 14, and 15. Some examples of nitrile compounds that may be used as high-temperature storage additives are shown in FIGS. 11, 12, and 13. Some examples of nitrile compounds that may be used as high-temperature storage additives are: adiponitrile (sometimes abbreviated as ADN) (dinitrile, structure 1102), 3-(2-cyanoethoxy) propanenitrile (dinitrile, 1104), 1,5-dicyanopentane (dinitrile, 1106), 1-(cyanomethyl)cyclopropane-1-carbonitrile (dinitrile, 1108), 4,4-dimethylheptanedinitrile (dinitrile, 1110), trans-1,4-dicyano-2-butene (dinitrile, 1112), 1,3,6-hexanetricarbonitrile (HTCN) (trinitrile, 1114), 3-{[1,3-bis(2-cyanoethoxy)propan-2-yl]oxy} propanenitrile (trinitrile, 1116), 1-(propan-2-yl)-1H-imidazole-4,5-dicarbonitrile (dinitrile, 1202), pyridine-2,6-dicarbonitrile (dinitrile, 1204), ethylene glycol bis(propionitrile) ether (dinitrile, 1206), 3-(triethoxysilyl) propionitrile (mononitrile, 1208), succinonitrile (dinitrile, 1210), benzonitrile (mononitrile, 1212), 4-(trifluoromethyl) benzonitrile (mononitrile, 1302), 1,2,2,3-propanetetracarbonitrile (tetrakis-nitrile, 1304). Some examples of other (non-nitrile) compounds that may be used as high-temperature storage additives are shown in FIGS. 13, 14, and 15. Some examples of non-nitrile compounds that may be used as high-temperature (HT) storage additives are: triisopropyl borate (TIB) (1306), 1-propene 1,3-sultone (PES) (1308), 1,3-propane sultone (1310), phenyl disulfide (1402), sulfolane (1404), N,N,N,N-tetraethyl sulfamide (1406), succinic anhydride (1408), maleic anhydride (1410), tris(trimethylsilyl)phosphite (TMSPI) (1502), tris(trimethylsilyl)phosphate (1504), dimethoxydiphenylsilane (1506), tris(trimethylsilyl) borate (TMSB) (1508), 3-(triethoxysilyl)propyl isocyanate (1510), methylene methanedisulfonate (MMDS), and 1,3,2-dioxathiolane 2,2-dioxide (DTD).

In some designs, the nitriles may act differently when interacting with cathode or anode surfaces at high SOC and at elevated temperatures. For example, nitriles may coordinate to the surface of the cathode via transition metal oxide centers. The coordination mechanism may be related to the high dipole moment of a nitrile group. While effective coordination may be a prerequisite to strong bonding of nitrile to the transition metal oxide, the length of the nitrile chain may play an important role in blocking the access of CC to the surface of cathode in some designs. On one hand, the length of the nitrile chain may determine the effectiveness of blocking CC molecules from reaching the surface of the cathode. The chain length may have an optimal design to form an arch on the surface of the cathode to screen off the molecules from reaching the surface. On the other hand, the steric bulk of nitriles may be used for blocking CC molecules from reaching the surface of the cathode. In some embodiments of the present disclosure, the steric bulk of the nitriles may be improved by using nitriles with (1) fused aliphatic rings, such as cyclopropane ring, (2) nitriles with a double carbon-carbon bond, or (3) branched nitriles, such as methyl or dimethyl substituted nitriles. In other embodiments of this disclosure, star-like shaped nitriles with three or four aliphatic carbon chains deviating from the center, in which aliphatic carbons may also be replaced by oxygen groups, such as O, may be used to enable steric bulk of nitriles. In some other embodiments, the nitriles with four and more nitrile groups may anchor to the surface of the cathode and block other molecules from oxidation. Additionally, in some designs, the oxidative stability of nitriles may determine the onset of high-temperature (HT) outgassing. For example, a nitrile with low oxidation stability may decompose at lower oxidation potentials with the formation of electronically insulative film that is Li-ion conducting. Such surface protection may also block CC and other molecules from undesirable or excessive decomposition on the cathode in some designs. To enable the formation of an electronically insulative film that is Li-ion conducting, nitriles with ethylene glycol structural units may be used effectively in some designs.

In some designs, nitriles may be prone to decomposition on the surface of the anode when exposed to a source of electrons due to their electron acceptor properties. Therefore, in some designs, using nitriles with low reduction potentials may be beneficial to achieve a high cycle life, decrease voltage hysteresis and decrease internal resistance, while ensuring surface protection for the cathodes. In some designs, the cathodic stability of a nitrile may be regulated by electron donicity of a nitrile. For example, in some designs, the electron donicity of a nitrile may be improved by replacing hydrogen atoms by short chain aliphatic groups, such as methyl or ethyl groups. In another example, the electron donicity may be improved by incorporating oxygen (O) groups in the structure of nitriles.

The inventors have found that in some embodiments, it may be advantageous to use a mixture of nitriles in order to achieve a good balance of cycle life, cycle life at elevated temperature, calendar life, HT storage outgassing, discharge V, C-rate and suppress transition metal dissolution. In some implementations, it may be advantageous to use a singular dinitrile to achieve a good balance of cycle life and HT outgassing, wherein the mole fraction of dinitrile is from about 0.5 mol. % to about 3 mol. %. In some other implementations, it may be advantageous to use a mixture of a dinitrile and a trinitrile to achieve a good balance of cycle life and HT outgassing, wherein the mole fraction of dinitrile is from about 0.5 mol. % to about 2 mol. %, and the mole fraction of trinitriles is from about 0.5 to about 1 mol. %. In some implementations, it may be beneficial to use a mixture of a dinitrile (e.g., ADN), a trinitrile (e.g., HTCN), and a non-nitrile high-temperature storage additive (e.g., PES). A total mole fraction of such a mixture, containing a dinitrile (e.g., ADN), a trinitrile (e.g., HTCN), and a non-nitrile high-temperature storage additive (e.g., PES), may be in a range of about 0.1 mol. % to about 3 mol. %, or in a range of about 1.0 mol. % to about 3 mol. %. In some implementations, a mole fraction of the one or more high-temperature storage additives in the electrolyte may be in a range of about 0.1 mol. % to about 3 mol. %.

The inventors have also found that it may be advantageous to use high-temperature storage additives such as triisopropyl borate (TIB) (1306), succinic anhydride (1408), maleic anhydride (1410), tris(trimethylsilyl)phosphite) (TMSPI) (1502), and tris(trimethylsilyl) borate (TMSB) (1508), to reduce thickness change, scavenge HF, and reduce transition metal dissolution. In some embodiments, it may be advantageous to use these additives in addition to nitrile additives. In some other embodiments, it may be advantageous to use from about 0.1 mol. % to about 3 mol. % of these additives in the electrolyte formulation.

In some embodiments of the present disclosure, the combination of nitrile additive(s), charge-transfer additives (e.g., Li salt additives), or other HT storage additives with branched esters may be advantageously used to decrease high-temperature (HT) outgassing by, for example, preventing or reducing transition metal dissolution elevated temperatures (e.g., battery operating temperatures, e.g., above about 50-80° C.) and by forming a protective cathode film. In a specific example, the branched ester may be chosen from one of the branched esters, such as ethyl isobutyrate, methyl isobutyrate, ethyl trimethyl acetate, ethyl isovalerate, methyl trimethyl acetate, methyl isovalerate, methyl 2-methyl butyrate, ethyl 2-methyl butyrate, to name a few. In a specific example, Li salt additive may be chosen from lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB). In some implementations, non-Li metal (e.g., Mg, Ca, Sr, Ba, La, lanthanoids, Y, etc.) analogies of such salts may be used in addition or instead of Li salts (e.g., from about 0.03 mol. % to about 6 mol. % in total non-Li salt amounts). In some implementations, a mole fraction of Li salt additives in the electrolyte may preferably be in a range of approximately 0.1 mol. % to approximately 3.0 mol. %, or in a range of approximately 0.1 mol. % to approximately 6.0 mol. %, in a range of approximately 0.5 mol. % to approximately 1.5 mol. %. The optimal additive mole fraction (concentration) in the combination with branched ester may depend on the particular cell design and electrolyte composition.

In one or more embodiments of the present disclosure, the combination of suitable anode and cathode surface protection to decrease high-temperature (HT) outgassing may be designed by using a single nitrile or a mixture of nitriles with additive Li salt(s). In a specific example, the additive Li salt(s) may be chosen from lithium difluorophosphate (LiPO₂F₂ or LFO), lithium tetrafluoroborate (LiBF₄), lithium fluorosulfate (LiSO₃F), lithium bis(fluorosulfonyl)imide (LiFSI), and lithium difluoro(oxalato)borate (LiDFOB), to name a few. In some implementations, non-Li metal (e.g., Mg, Ca, Sr, Ba, La, lanthanoids, Y, etc.) analogs of such salts may be used in addition or instead of Li additive salts (e.g., from about 0.01 mol. % to about 3 mol. % in total non-Li salt amounts). In some implementations, a mole fraction of Li additive salts in the electrolyte may preferably be in a range of approximately 0.1 mol. % to approximately 3.0 mol %. In some implementations, there may be a tendency for an undesired reduction of cycle life when the mole fraction of additive salts in the electrolyte is greater than approximately 2.5-3 mol. %, so their fraction may need to be carefully optimized for a particular cell design.

In one or more embodiments of the present disclosure, a preferred electrolyte for a lithium-ion battery may include lithium difluorophosphate (LFO). In some designs, this additive salt tends to reduce charge-transfer resistance (Rct) at room, low and/or elevated temperatures. Reduction of Rct contributes to increasing the discharge voltage and improving low-temperature performance. In some cell designs, LFO may be particularly effective in simultaneously reducing Rct at the anode and cathode and improving the discharge voltage of a battery cell both at room temperature and at a high (e.g., elevated) temperature. In some implementations, LFO contributes to mitigation of high-temperature outgassing.

In one or more embodiments of the present disclosure, Li metal or Li-ion battery cells may employ electrolytes that include: (1) branched ester, (2) a nitrile additive composition that includes a suitable amount of a selected nitrile compound or a suitable amount of a mixture of selected nitrile compounds or (3)) Li salt additive, (4) other HT storage additive, which may provide multiple benefits to Li or Li-ion batteries, particularly those that comprise a subclass of high-capacity, moderate volume changing anodes comprising from about 5 to about 100 wt. % of (nano)composite anode powders (as a fraction of all particles that include active materials), wherein such (nano)composite anode powders exhibit moderately high volume changes during the first charge-discharge cycle, moderate volume changes during the subsequent charge-discharge cycles, an average size (e.g., average diameter) in the range from about 0.2 to about 40 microns and specific surface area in the range from about 0.5 to about 50 m²/g and, in the case of Si-comprising (nano)composite anode powders, specific reversible capacities in the range from about 800 to about 3000 mAh/g (when normalized by the mass of the composite anode particles only) or with the corresponding anode specific reversible capacities being in the range from about 400 to about 2800 mAh/g (when normalized by the total mass of all the active electrode particles, conductive additives and binders). In some designs (e.g., depending on cell chemistry, loading, operating conditions and/or other factors), suitable branched esters or related compounds (or their mixtures) may be added at the additive level (from about 0.1 mol. % to about 5-10 mol. %) or as a main co-solvent/major co-solvent level (from about 30 mol. % to about 80 mol. %) for attaining substantial benefits. In other embodiments, such anode powders may comprise a mixture of Si—C nanocomposite and graphite, a so-called blended anode.

Examples of such benefits may include one or more of the following: (i) improving high-temperature storage stability (e.g., retaining higher reversible capacity after about 1 h to about 10 years of storage at elevated temperatures (e.g., about 40-80° C.) at high state of charge (SOC) (e.g., SOC of about 70-100%) or reducing gas generation after storage or cycling at elevated temperatures); (ii) reducing gas generation during storage or cycling at room or low temperatures; (iii) reducing or minimizing cell swelling (or built-in stresses in cells) at the end of life (e.g., after about 20-80% of the initial capacity retention); (iv) improving cycling stability when used at various (e.g., different) temperature conditions; (v) reducing or minimizing impedance growth during cycling; (vi) reducing or minimizing formation of undesirable (harmful) by-products during battery cell operation, among others; (vii) reducing carbon monoxide generation on the cathode and anode; (viii) reducing carbon dioxide generation on the cathode and anode; (ix) reducing hydrogen generation on the anode, (x) reducing methane generation on the anode; (xi) reducing C2-hydrocarbon generation on the anode, and/or (xii) reducing C3-hydrocarbon generation on the anode.

Some of such benefits may stem from the formation of more favorable or more robust cathode/electrolyte interphase (CEI) film that may, for example, help to reduce or minimize electrolyte oxidation on the cathode with the formation of gaseous species or help to reduce or minimize cathode dissolution or other unfavorable/undesirable interactions between the cathode and liquid electrolyte in a Li or Li-ion battery. In some implementations, for example, in case of employing an in electrolyte that contains: (1) a nitrile additive composition that includes a suitable amount of a selected nitrile compound or a suitable amount of a mixture of selected nitrile compounds, (2) a mixture of the nitrile additive composition with selected branched esters (such as ethyl isobutyrate, ethyl trimethylacetate, and/or other suitable esters with two or three aliphatic carbons attached at the alpha or beta position to the carboxyl group)), or (3) a mixture of the nitrile additive, Li salt additive, and branched esters, a more robust CEI film formation may be related to having a stronger adhesion to the cathode surface. Some of such benefits may also stem from the formation of more favorable or more robust solid electrolyte interphase (SEI) film on the anode (or, for example, from helping to maintain a more stable anode SEI). In some designs, improved SEI stability may be related to the dramatically reduced diffusion of suitable branched esters and related compounds through the SEI, which may prevent or greatly reduce or minimize their reduction as well as other electrolyte components on the anode surface, particularly at elevated temperatures. In some designs, improved SEI stability may be related to the reduced ability to form gaseous species upon electrolyte reduction. In some designs, improved SEI stability may be related to the reduced ability to form more elastically or plastically deformable (in the electrolyte) SEI or, for example, less resistive SET. Such improved SEI stability or properties may, for example, help reduce or minimize electrolyte reduction on the anode (with the associated undesirable irreversible losses of cyclable Li or with the undesirable formation of gaseous species or undesirable anode swelling, etc.) or may help to reduce or minimize anode dissolution or other unfavorable/undesirable interactions between the anode and liquid electrolyte in a Li or Li-ion battery, which may lead to impedance growth or gas generation or other undesirable processes or performance degradations in cells. Some of such benefits may stem from the reduction in elastic modulus of the electrode binders upon exposure of electrodes to electrolytes during cell formation or cell operation (cycling). In some designs, it may be preferable to select an electrolyte composition comprising some suitable nitriles; or suitable nitrile mixtures; or suitable mixtures comprising nitriles and branched esters (such as ethyl isobutyrate or other suitable esters with two or three aliphatic carbons in alpha or beta position to carboxyl group and others); or suitable mixtures comprising nitriles, charge-transfer additives (e.g., Li salt additives such as LiFSI, LFO, LiBF₄, and LiDFOB), and other additives; or suitable mixtures comprising nitriles, charge-transfer additives, other HT storage additives (e.g., DTD, MMDS), and branched esters. Preferably, the elastic modulus of binder in at least one of the electrodes is not reduced by more than about 30 vol. % (e.g., more preferably, is not reduced by more than about 10 vol. %) when the cell including the electrodes is exposed to the electrolyte.

In some designs, employing an electrolyte that contains: (1) a nitrile additive composition that includes a suitable amount of a selected nitrile compound or a suitable amount of a mixture of selected nitrile compounds, (2) a mixture of the nitrile additive composition with selected branched esters (such as ethyl isobutyrate, ethyl trimethylacetate, and/or other suitable esters with two or three aliphatic carbons attached at the alpha or beta position to the carboxyl group), (3) a mixture of nitrile additive, Li salt additive, and branched ester in a Li or Li-ion battery cell may offer greatly increased FEC or VC presence in the Li-ion solvation shell to facilitate the formation of robust SEI.

In some designs, employing an electrolyte that contains: (1) a nitrile additive composition that includes a suitable amount of a selected nitrile compound or a suitable amount of a mixture of selected nitrile compounds, (2) a mixture of the nitrile additive composition with selected branched esters (such as ethyl isobutyrate, ethyl trimethylacetate, and/or other suitable esters with two or three aliphatic carbons attached at the alpha or beta position to the carboxyl group), or (3) a mixture of the nitrile additive, branched ester, other HT storage additives, and Li salt additive in a Li-ion battery cell may offer greatly reduced gassing on the anode surface (including, but not limited to the case of Li plating on the anode surface). In some designs, branched esters with two or three alkyl groups in the alpha position to the carboxyl group of the branched ester may offer particularly improved performance. In some designs, branched esters with two or three alkyl groups in the alpha position to carboxyl group of the branched ester may offer reduced rates of hydrogen, methane, ethane, ethylene, propene, propane, butane and/or butene formation on the anode.

In some designs, employing an electrolyte that contains: (1) branched ester (such as ethyl isobutyrate, ethyl trimethylacetate, and/or other suitable esters with two or three aliphatic carbons attached at the alpha or beta position to the carboxyl group), or (2) branched esters with Li salt additive (such as LFO, LiBF₄, LiDFOB, LiFSI) in a Li-ion battery cell may mitigate parasitic (highly undesirable) degradation of common SEI “builders” (such as fluoroethylene carbonate (FEC), vinylene carbonate (VC), ethylene carbonate (EC), among others) present in the electrolyte due to the reduced rate of the alkoxide formation. In some designs, esters with two or three alkyl groups in the alpha position to carboxyl group of the ester may offer particularly improved performance due to the steric bulk of esters and reduced rate of the alkoxide formation.

In some designs, employing an electrolyte that contains branched esters (such as ethyl isobutyrate, ethyl trimethylacetate, and/or other suitable esters with two or three aliphatic carbons attached at the alpha or beta position to the carboxyl group) in a Li-ion battery cell may reduce or completely eliminate the undesirable formation of enol form of the corresponding ester (or reduce the formation of tautomeric enol form) (e.g., by shifting the equilibrium towards the ester). In some designs, by reducing or avoiding the enol presence in the electrolyte, the parasitic degradation of Li salt(s) (e.g., lithium hexafluorophosphate (LiPF₆)) or other electrolyte components by, for example, alcoholysis could be greatly reduced or minimized. Similarly, in some designs, formation of hydrofluoric acid (HF) or other undesirable by-products of, e.g., LiPF₆ alcoholysis, could be greatly reduced or minimized.

In some other embodiments of this invention disclosure, it may be beneficial to use low viscosity co-solvent, selected from but not limited to open chain carbonates, such as dimethyl carbonate and ethyl methyl carbonate. In some designs, such co-solvents, may be beneficial for improving HT outgassing and extending cycle life. In some other designs the use of such solvents may lead to the extensive out gassing at low SOC and during the prolonged gassing. In some other designs, in order to avoid outgassing at low SOC and during prolonged cycles, it may be advantageous to use high mole fractions (concentrations) of FEC and VC to build robust SEI.

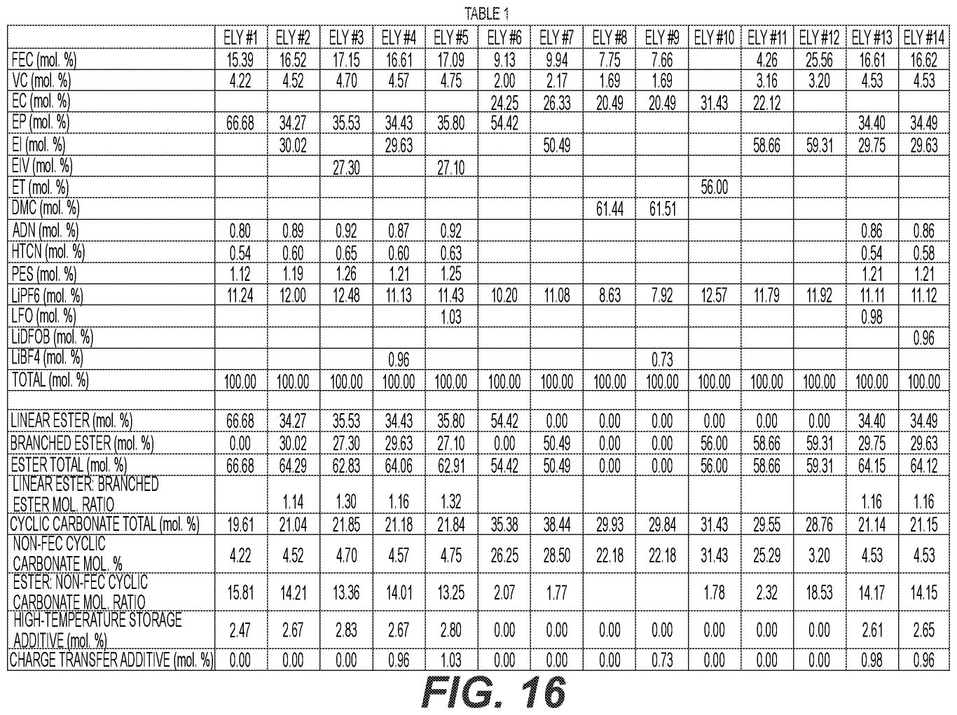

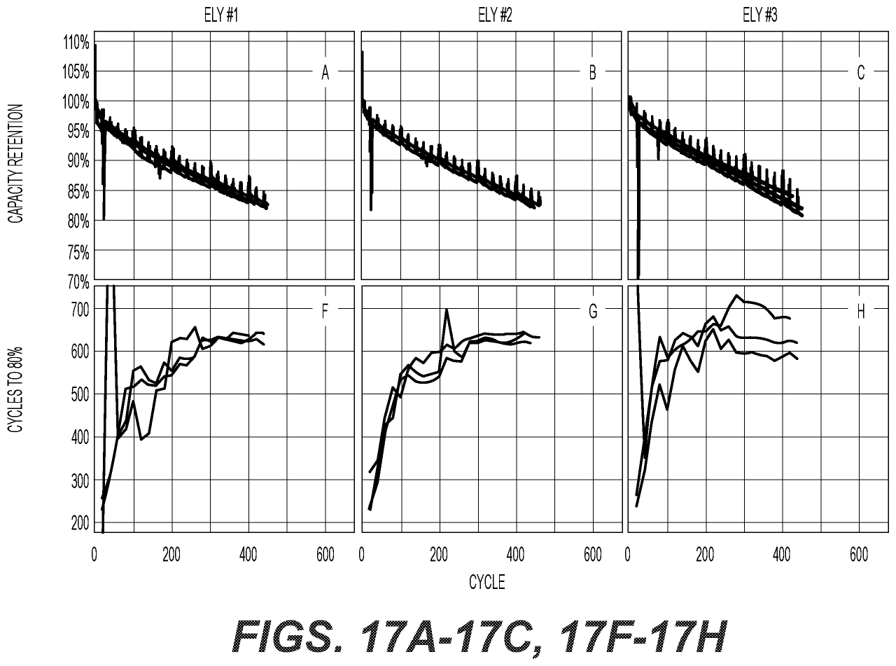

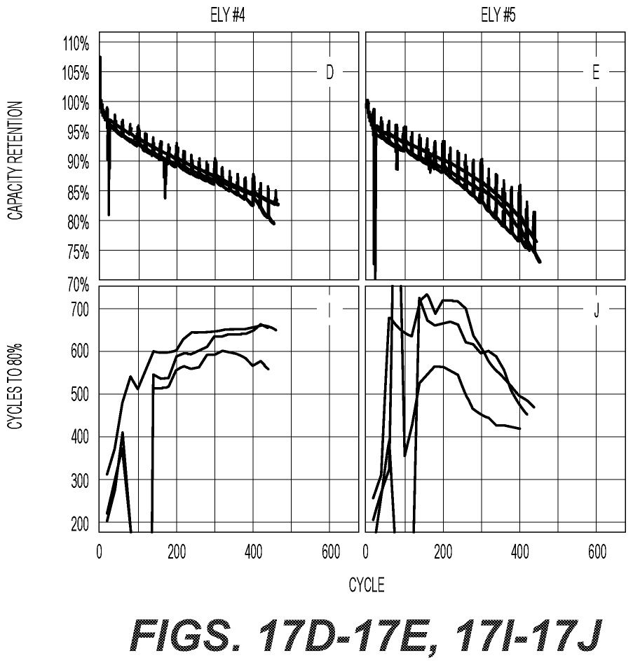

Table 1 (FIG. 16) shows composition data for electrolyte formulations (ELYs) #1, #2, #3, #4, #5, #6, #7, #8, #9, #10, #11, #12, #13, and #14. For each electrolyte, the relative amounts, expressed in mol. %, of fluoroethylene carbonate (FEC), vinylene carbonate (VC), ethylene carbonate (EC), ethyl propionate (EP), ethyl isobutyrate (EI), ethyl isovalerate (EIV), ethyl trimethylacetate (ET), dimethyl carbonate (DMC), adiponitrile (ADN), 1,3,6-hexanetricarbonitrile (HTCN), 1-propene 1,3-sultone (PES), lithium hexafluorophosphate (LiPF₆), lithium difluorophosphate (LFO), lithium difluoro(oxalato)borate (LiDFOB), and lithium tetrafluoroborate (LiBF₄) are shown. A blank entry indicates that the respective amount is zero. The linear ester entries correspond to the respective amounts of EP. The branched ester entries are sums of the respective EI, EIV, and ET entries. The ester total entries are sums of the respective linear ester and branched ester entries. The linear ester: branched ester molar ratio entries are the ratios of the respective linear ester entries to the respective branched ester entries. The cyclic carbonate total entries are sums of the respective FEC, VC, and EC entries. The non-FEC cyclic carbonate entries are sums of the respective VC and EC entries. The high-temperature storage additive entries are sums of the respective ADN, HTCN, and PES entries. The charge-transfer additive entries are sums of the respective LFO, LiDFOB, and LiBF₄ entries.

In one illustrative example, a small consumer Li-ion battery cell (Li-ion battery cell for use in consumer electronics products) with capacity of about 0.020 Ah may comprise: (i) an anode with 19% by weight of Si—C nanocomposite active material (with specific reversible capacity of about 1520 mAh/g when normalized by the weight of active materials in the anode) and 76.5% by weight of graphite casted on Cu current collector foil from a water-based suspension comprising a carboxymethyl cellulose and butadiene-styrene copolymer and a carbon black conductive additive, (ii) a cathode with high-voltage LCO (approximate composition of LiCoO₂) active material (with specific reversible capacity of about 190 mAh/g when normalized by the weight of active materials in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 3.27 mAh/cm², charge voltage of about 4.4V, (iii) a polymer-ceramic separator, and (iv) an ELY #1 comprising: about 15.39 mol. % of FEC, about 66.68 mol. % of ethyl propionate (EP) (linear ester), about 4.22 mol. % of VC, about 0.80 mol. % of adiponitrile (ADN), about 0.54 mol. % of 1,3,6-hexanetricarbonitrile (HTCN), about 1.12 mol. % 1-propene 1,3-sultone (PES), and about 11.24 mol. % of LiPF₆. Hereinbelow, particular electrolyte formulations may be denoted as ELY followed by a number (e.g., ELY #1, ELY #2, etc.).

In one illustrative example, a small consumer Li-ion battery cell (Li-ion battery cell for use in consumer electronics products) with capacity of about 0.020 Ah may comprise: (i) an anode with 19% by weight of Si—C nanocomposite active material (with specific reversible capacity of about 1520 mAh/g when normalized by the weight of active materials in the anode) and 76.5% by weight of graphite powder casted on Cu current collector foil from a water-based suspension comprising a carboxymethyl cellulose and butadiene-styrene copolymer and a carbon black conductive additive, (ii) a cathode with high-voltage LCO active material (with specific reversible capacity of about 190 mAh/g when normalized by the weight of active materials in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 3.27 mAh/cm², charge voltage of about 4.4V, (iii) a polymer-ceramic separator, and (iv) an ELY #2 comprising: about 16.52 mol. % of FEC, about 34.27 mol. % of ethyl propionate (EP) (linear ester), about 30.02 mol. % of ethyl isobutyrate (EI) (branched ester), about 4.52 mol. % of VC, about 0.89 mol. % of adiponitrile (ADN), about 0.60 mol. % of 1,3,6-hexanetricarbonitrile (HTCN), about 1.19 mol. % 1-propene 1,3-sultone (PES), and about 12.00 mol. % of LiPF₆.

In one illustrative example, a small consumer Li-ion battery cell (Li-ion battery cell for use in consumer electronics products) with capacity of about 0.020 Ah may comprise: (i) an anode with 19% by weight of Si—C nanocomposite active material (with specific reversible capacity of about 1520 mAh/g when normalized by the weight of active materials in the anode) and 76.5% by weight of graphite casted on Cu current collector foil from a water-based suspension comprising a carboxymethyl cellulose and butadiene-styrene copolymer and a carbon black conductive additive, (ii) a cathode with high-voltage LCO active material (with specific reversible capacity of about 190 mAh/g when normalized by the weight of active materials in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 3.27 mAh/cm², charge voltage of about 4.4V, (iii) a polymer-ceramic separator, and (iv) an ELY #3 comprising: about 17.15 mol. % of FEC, about 35.53 mol. % of ethyl propionate (EP) (linear ester), about 27.30 mol. % of ethyl isovalerate (EIV) (branched ester), about 4.70 mol. % of VC, about 0.92 mol. % of adiponitrile (ADN), about 0.65 mol. % of 1,3,6-hexanetricarbonitrile (HTCN), about 1.26 mol. % 1-propene 1,3-sultone (PES), and about 12.48 mol. % of LiPF₆.

In one illustrative example, a small consumer Li-ion battery cell (Li-ion battery cell for use in consumer electronics products) with capacity of about 0.020 Ah may comprise: (i) an anode with 19% by weight of Si—C nanocomposite active material (with specific reversible capacity of about 1520 mAh/g when normalized by the weight of active materials in the anode) and 76.5% by weight of graphite casted on Cu current collector foil from a water-based suspension comprising a carboxymethyl cellulose and butadiene-styrene copolymer and a carbon black conductive additive, (ii) a cathode with high-voltage LCO active material (with specific reversible capacity of about 190 mAh/g when normalized by the weight of active materials in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 3.27 mAh/cm², charge voltage of about 4.4V, (iii) a polymer-ceramic separator, and (iv) an ELY #4 comprising: about 16.61 mol. % of FEC, about 34.43 mol. % of ethyl propionate (EP) (linear ester), about 29.63 mol. % of ethyl isobutyrate (EI) (branched ester), about 4.57 mol. % of VC, about 0.87 mol. % of adiponitrile (ADN), about 0.60 mol. % of 1,3,6-hexanetricarbonitrile (HTCN), about 1.21 mol. % 1-propene 1,3-sultone (PES), about 0.96 mol. % LiBF₄, and about 11.13 mol. % of LiPF₆.

In one illustrative example, a small consumer Li-ion battery cell (Li-ion battery cell for use in consumer electronics products) with capacity of about 0.020 Ah may comprise: (i) an anode with 19% by weight of Si—C nanocomposite active material (with specific reversible capacity of about 1520 mAh/g when normalized by the weight of active materials in the anode) and 76.5% by weight of graphite casted on Cu current collector foil from a water-based suspension comprising a carboxymethyl cellulose and butadiene-styrene copolymer and a carbon black conductive additive, (ii) a cathode with high-voltage LCO active material (with specific reversible capacity of about 190 mAh/g when normalized by the weight of active materials in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 3.27 mAh/cm², charge voltage of about 4.4V, (iii) a polymer-ceramic separator, and (iv) an ELY #5 comprising: about 17.09 mol. % of FEC, about 35.80 mol. % of ethyl propionate (EP) (linear ester), about 27.10 mol. % of ethyl isovalerate (EIV) (branched ester), about 4.75 mol. % of VC, about 0.92 mol. % of adiponitrile (ADN), about 0.63 mol. % of 1,3,6-hexanetricarbonitrile (HTCN), about 1.25 mol. % 1-propene 1,3-sultone (PES), about 1.03 mol. % lithium difluorophosphate (LFO), and about 11.43 mol. % of LiPF₆.

Li-ion battery test cells respectively comprising ELY #1, ELY #2, ELY #3, ELY #4, and ELY #5 were tested in a cycle life test. The test cells were fabricated, and an initial formation procedure was carried out on the test cells. Charge/discharge test conditions comprise constant current, constant potential (CCCP) at 1 C charge to 4V and taper to 0.5 C, then CCCP at 0.5 C charge to 4.4V and taper to 0.05 C followed by the 0.5 C discharge. The electrolytes in this series (#1, #2, #3, #4, and #5) contain FEC, VC, ADN, HTCN, and PES. The test cells contain blended anodes of graphite and Si—C composite particles. ELY #1 contains a linear ester but no branched ester. ELY #2 and ELY #3 contain linear ester-branched ester mixtures and do not contain any charge-transfer additives. ELY #4 and ELY #5 contain linear ester-branched ester mixtures and contain charge-transfer additives. ELY #2 (linear ester EP, branched ester EI) and ELY #3 (linear ester EP, branched ester EIV) exhibited better cycle life than ELY #1 which comprises one linear ester EP. ELY #4 which employs LiBF₄ charge-transfer additive (Li salt additive) demonstrated cycle life similar to ELY #2 which employs no Li salt additives. ELY #5 which employs LFO Li salt additive demonstrated worse cycle life compared to ELY #3 which feature no Li salt additives.

In one illustrative example, a small Li-ion battery cell with capacity of about 0.055 Ah may comprise: (i) an anode with 50% by capacity Si—C nanocomposite active material (with specific reversible capacity of about 1520 mAh/g when normalized by the weight of active materials in the anode) and graphite casted on Cu current collector foil from a water-based suspension comprising a carboxymethyl cellulose and butadiene-styrene copolymer and a carbon black conductive additive, (ii) a cathode with high-voltage NMC811 active material (with specific reversible capacity of about 200 mAh/g when normalized by the weight of active materials in the cathode) casted on Al current collector foil from an organic solvent suspension comprising a polyvinylidene fluoride (PVDF)-based binder and a carbon black conductive additive, anode:cathode areal capacity ratio of about 1.15:1 and areal reversible capacity loading of about 4.8 mAh/cm², charge voltage of about 4.2V, (iii) a polymer-ceramic separator, and (iv) an ELY #6 comprising: about 9.13 mol. % of FEC, about 54.42 mol. % of ethyl propionate (EP) (linear ester), about 2.00 mol. % of VC, about 24.25 mol. % of ethylene carbonate (EC), and about 10.20 mol. % of LiPF₆.

In one illustrative example, a small Li-ion battery cell with capacity of about 0.055 Ah may comprise: (i) an anode with 50% by capacity Si—C nanocomposite active material (with specific reversible capacity of about 1520 mAh/g when normalized by the weight of active materials in the anode) and graphite casted on Cu current collector foil from a water-based suspension comprising a carboxymethyl cellulose and butadiene-styrene copolymer and a carbon black conductive additive, (ii) a cathode with high-voltage NMC811 active material (with specific reversible capacity of about 200 mAh/g when normalized by the weight of active materials in the cathode) casted on Al current collector foil from an organic solvent suspension comprising a polyvinylidene fluoride (PVDF)-based binder and a carbon black conductive additive, anode:cathode areal capacity ratio of about 1.15:1 and areal reversible capacity loading of about 4.8 mAh/cm², charge voltage of about 4.2V, (iii) a polymer-ceramic separator, and (iv) an ELY #7 comprising: about 9.94 mol. % of FEC, about 50.49 mol. % of ethyl isobutyrate (EI) (branched ester), about 2.17 mol. % of VC, about 26.33 mol. % of ethylene carbonate (EC), and about 11.08 mol. % of LiPF₆.

Li-ion battery test cells respectively comprising ELY #6 and ELY #7 were tested in a cycle life test. The test cells were fabricated, and an initial formation procedure was carried out on the test cells. Charge/discharge test conditions comprise CCCP at 1 C charge to 4.2V and taper to 0.05 C followed by 1 C discharge. The electrolytes in this series (#6 and #7) contain FEC, VC, and EC. The test cells contain blended anodes of graphite and Si—C composite particles. The ELY #7 cells which contain a branched ester EI exhibited improved cycle life over the ELY #6 cells which comprise a linear ester EP.

Li-ion battery test cells respectively comprising ELY #6 and ELY #7 were tested for generated gas volume as follows. The test cells were fabricated, and an initial formation procedure was carried out on the test cells. The test cells were charged to a high state-of-charge and the initial cell thicknesses were measured. The cells were heated to a temperature of 60° C. and were maintained at a temperature of 60° C. for a period of 72 hours (high-temperature storage treatment). The test cells were then cooled to 25° C. and the final cell thicknesses were measured within 1 hour after reaching 25° C. The volume of the gas generated in the cell was analyzed using gas chromatography. The gas volume from the cell with ELY #7 was 0.217 mL, which is 12% smaller by volume than gas volume collected from the cell with ELY #6.

In one illustrative example, a small Li-ion battery cell with capacity of about 0.055 Ah may comprise: (i) an anode with 50% by capacity Si—C nanocomposite active material (with specific reversible capacity of about 1520 mAh/g when normalized by the weight of active materials in the anode) and graphite casted on Cu current collector foil from a water-based suspension comprising a carboxymethyl cellulose and butadiene-styrene copolymer and a carbon black conductive additive, (ii) a cathode with high-voltage NMC811 active material (with specific reversible capacity of about 200 mAh/g when normalized by the weight of active materials in the cathode) casted on Al current collector foil from an organic solvent suspension comprising a polyvinylidene fluoride (PVDF)-based binder and a carbon black conductive additive, anode:cathode areal capacity ratio of about 1.15:1 and areal reversible capacity loading of about 4.8 mAh/cm², charge voltage of about 4.2V, (iii) a polymer-ceramic separator, and (iv) an ELY #8 comprising: about 7.75 mol. % of FEC, about 61.44 mol. % of dimethyl carbonate (DMC), about 1.69 mol. % of VC, about 20.49 mol. % of ethylene carbonate (EC), and about 8.63 mol. % of LiPF₆.

In one illustrative example, a small Li-ion battery cell with capacity of about 0.055 Ah may comprise: (i) an anode with 50% by capacity Si—C nanocomposite active material (with specific reversible capacity of about 1520 mAh/g when normalized by the weight of active materials in the anode) and graphite casted on Cu current collector foil from a water-based suspension comprising a carboxymethyl cellulose and butadiene-styrene copolymer and a carbon black conductive additive, (ii) a cathode with high-voltage NMC811 active material (with specific reversible capacity of about 200 mAh/g when normalized by the weight of active materials in the cathode) casted on Al current collector foil from an organic solvent suspension comprising a polyvinylidene fluoride (PVDF)-based binder and a carbon black conductive additive, anode:cathode areal capacity ratio of about 1.15:1 and areal reversible capacity loading of about 4.8 mAh/cm², charge voltage of about 4.2V, (iii) a polymer-ceramic separator, and (iv) an ELY #9 comprising: about 7.66 mol. % of FEC, about 61.51 mol. % of dimethyl carbonate (DMC), about 1.69 mol. % of VC, about 20.49 mol. % of ethylene carbonate (EC), about 0.73 mol. % of LiBF₄, and about 7.92 mol. % of LiPF₆.

Li-ion battery test cells respectively comprising ELY #8 and ELY #9 were tested in a cycle life test. The test cells were fabricated, and an initial formation procedure was carried out on the test cells. Charge/discharge test conditions comprise CCCP at 1 C charge to 4.2V and taper to 0.05 C followed by 1 C discharge. The electrolytes in this series (#8, #9) contain FEC, VC, EC, and DMC. The test cells contain blended anodes of graphite and Si—C composite particles. Test cells for both electrolytes (#8, #9) exhibits satisfactory cycle life. However, the ELY #8 cells which do not contain LiBF₄ exhibits improved cycle life over the ELY #9 cells which contain LiBF₄.

In one illustrative example, a small consumer Li-ion battery cell (Li-ion battery cell for use in consumer electronics products) with capacity of about 0.140 Ah may comprise: (i) an anode with 100% by weight graphite (i.e., 100% of active material is graphite) casted on Cu current collector foil from a water-based suspension comprising a carboxymethyl cellulose and butadiene-styrene copolymer and a carbon black conductive additive, (ii) a cathode with high-voltage LCO active material (with specific reversible capacity of about 190 mAh/g when normalized by the weight of active materials in the cathode) casted on Al current collector foil from an organic solvent suspension comprising a polyvinylidene fluoride (PVDF)-based binder and a carbon black conductive additive, charge voltage of about 4.25V, (iii) a polymer-ceramic separator, and (iv) an ELY #10 comprising: about 56.00 mol. % of ethyl trimethylacetate (ET) (branched ester), about 31.43 mol. % of ethylene carbonate (EC), and about 12.57 mol. % of LiPF₆.

In one illustrative example, a small consumer Li-ion battery cell (Li-ion battery cell for use in consumer electronics products) with capacity of about 0.140 Ah may comprise: (i) an anode with 100% by weight graphite (i.e., 100% of active material is graphite) casted on Cu current collector foil from a water-based suspension comprising a carboxymethyl cellulose and butadiene-styrene copolymer and a carbon black conductive additive, (ii) a cathode with high-voltage LCO active material (with specific reversible capacity of about 190 mAh/g when normalized by the weight of active materials in the cathode) casted on Al current collector foil from an organic solvent suspension comprising a polyvinylidene fluoride (PVDF)-based binder and a carbon black conductive additive, charge voltage of about 4.25V, (iii) a polymer-ceramic separator, and (iv) an ELY #11 comprising: about 4.26 mol. % of fluoroethylene carbonate (FEC), about 58.55 mol. % ethyl isobutyrate (EI) (branched ester), about 3.16 mol. % vinylene carbonate (VC), about 22.12 mol. % of ethylene carbonate (EC), and about 11.79 mol. % of LiPF₆.

In one illustrative example, a small consumer Li-ion battery cell (Li-ion battery cell for use in consumer electronics products) with capacity of about 0.140 Ah may comprise: (i) an anode with 100% by weight graphite (i.e., 100% of active material is graphite) casted on Cu current collector foil from a water-based suspension comprising a carboxymethyl cellulose and butadiene-styrene copolymer and a carbon black conductive additive, (ii) a cathode with high-voltage LCO active material (with specific reversible capacity of about 190 mAh/g when normalized by the weight of active materials in the cathode) casted on Al current collector foil from an organic solvent suspension comprising a polyvinylidene fluoride (PVDF)-based binder and a carbon black conductive additive, charge voltage of about 4.25V, (iii) a polymer-ceramic separator, and (iv) an ELY #12 comprising: about 25.56 mol. % of fluoroethylene carbonate (FEC), about 59.31 mol. % ethyl isobutyrate (EI) (branched ester), about 3.20 mol. % vinylene carbonate (VC), and about 11.92 mol. % of LiPF₆.

Li-ion battery test cells respectively comprising ELY #10, ELY #11, and ELY #12 were tested in a cycle life test. The test cells were fabricated, and an initial formation procedure was carried out on the test cells. Charge/discharge test conditions comprise CCCP at 1 C charge to 4.35V and taper to 0.05 C followed by 1 C discharge. The test cells contain graphite anodes. ELY #10 contains ethylene carbonate (EC) and ET (branched ester). ELY #11 contains FEC, VC, EC, and EI (branched ester). ELY #12 contains FEC, VC, and EI (branched ester). ELY #12 cells (FEC, EI) exhibited better cycle life than ELY #11 cells (FEC, EC, EI) and ELY #10 cells (EC, ET, no FEC). ELY #11 cells (FEC, EC, EI) exhibited better cycle life than ELY #10 cells (EC, ET, no FEC).

In one illustrative example, a consumer Li-ion battery cell (Li-ion battery cell for use in consumer electronics products) with capacity of about 0.020 Ah may comprise: (i) an anode with 19% by weight of Si—C nanocomposite active material (with specific reversible capacity of about 1520 mAh/g when normalized by the weight of active materials in the anode) and 76.5% by weight of graphite casted on Cu current collector foil from a water-based suspension comprising a carboxymethyl cellulose and butadiene-styrene copolymer and a carbon black conductive additive, (ii) a cathode with high-voltage LCO active material (with specific reversible capacity of about 190 mAh/g when normalized by the weight of active materials in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 3.27 mAh/cm², charge voltage of about 4.4V, (iii) a polymer-ceramic separator, and (iv) an ELY #13 comprising: about 16.61 mol. % of FEC, about 34.40 mol. % of ethyl propionate (EP) (linear ester), about 29.75 mol. % of ethyl isobutyrate (EI) (branched ester), about 4.53 mol. % of VC, about 0.86 mol. % of adiponitrile (ADN), about 0.54 mol. % of 1,3,6-hexanetricarbonitrile (HTCN), about 1.21 mol. % 1-propene 1,3-sultone (PES), about 0.98 mol. % lithium difluorophosphate (LFO), and about 11.11 mol. % of LiPF₆.

In one illustrative example, a small consumer Li-ion battery cell (Li-ion battery cell for use in consumer electronics products) with capacity of about 0.020 Ah may comprise: (i) an anode with 19% by weight of Si—C nanocomposite active material (with specific reversible capacity of about 1520 mAh/g when normalized by the weight of active materials in the anode) and 76.5% by weight of graphite casted on Cu current collector foil from a water-based suspension comprising a carboxymethyl cellulose and butadiene-styrene copolymer and a carbon black conductive additive, (ii) a cathode with high-voltage LCO active material (with specific reversible capacity of about 190 mAh/g when normalized by the weight of active materials in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 3.27 mAh/cm², charge voltage of about 4.4V, (iii) a polymer-ceramic separator, and (iv) an ELY #14 comprising: about 16.62 mol. % of FEC, about 34.49 mol. % of ethyl propionate (EP) (linear ester), about 29.63 mol. % of ethyl isobutyrate (EI) (branched ester), about 4.53 mol. % of VC, about 0.86 mol. % of adiponitrile (ADN), about 0.58 mol. % of 1,3,6-hexanetricarbonitrile (HTCN), about 1.21 mol. % 1-propene 1,3-sultone (PES), about 0.96 mol. % Li difluoro(oxalato)borate (LiDFOB), and about 11.12 mol. % of LiPF₆.

Li-ion battery test cells respectively comprising ELY #13 and ELY #14 were tested in a discharge rate test. The test cells were fabricated, and an initial formation procedure was carried out on the test cells. The electrolytes in this series (#13, #14) contain FEC, VC, EP (linear ester), EI (branched ester), ADN, HTCN, and PES. The test cells contain blended anodes of graphite and Si—C composite particles. Charge test conditions comprise CCCP at 1 C charge to 4.35V and taper to 0.05 C. Discharge cell capacity measured at 2 C is expressed as a fraction (%) of the discharge cell capacity measured at 0.5 C. The ELY #13 cells (containing LFO) exhibited a discharge capacity fraction of 87%. The ELY #14 cells (containing LiDFOB) exhibited a discharge capacity fraction of 89%. Accordingly, ELY #14 exhibited a better discharge capacity fraction than ELY #13.

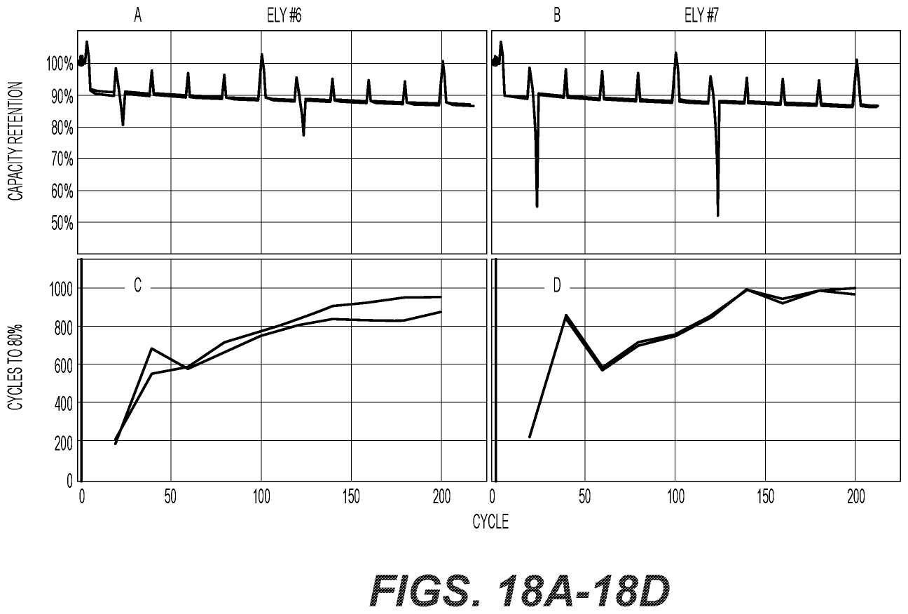

FIGS. 18A and 18B are graphical plots of the capacity retention (in % of initial capacity) as a function of cycle number, for Li-ion battery cells comprising ELY #6 and #7, respectively. FIGS. 18C and 18D are graphical plots of the estimated number of cycles to 80% of initial capacity as a function of cycle number, for Li-ion battery cells comprising ELY #6 and #7, respectively. ELY #6 and #7 are examples of ester-comprising electrolytes.

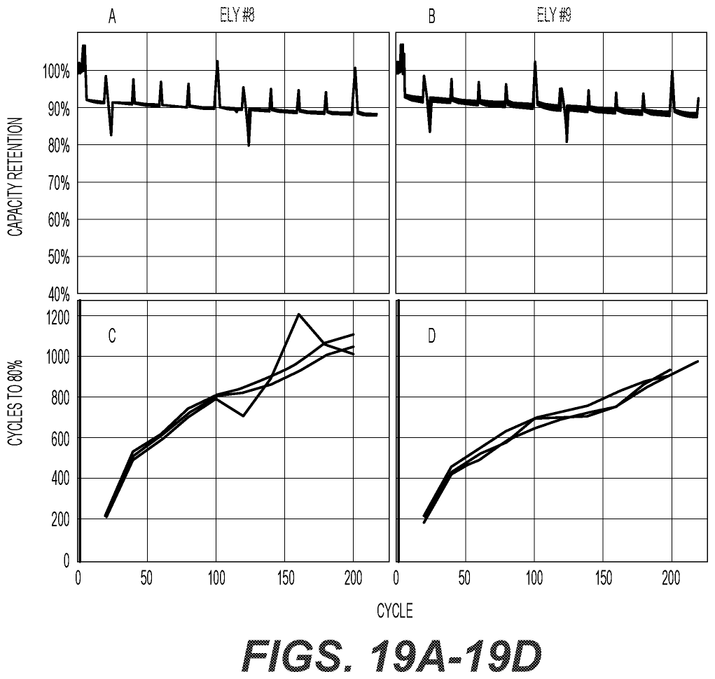

FIGS. 19A and 19B are graphical plots of the capacity retention (in % of initial capacity) as a function of cycle number, for Li-ion battery cells comprising ELY #8 and #9, respectively. FIGS. 19C and 19D are graphical plots of the estimated number of cycles to 80% of initial capacity as a function of cycle number, for Li-ion battery cells comprising ELY #8 and #9, respectively. ELY #8 and #9 are examples of linear carbonate-comprising electrolytes.

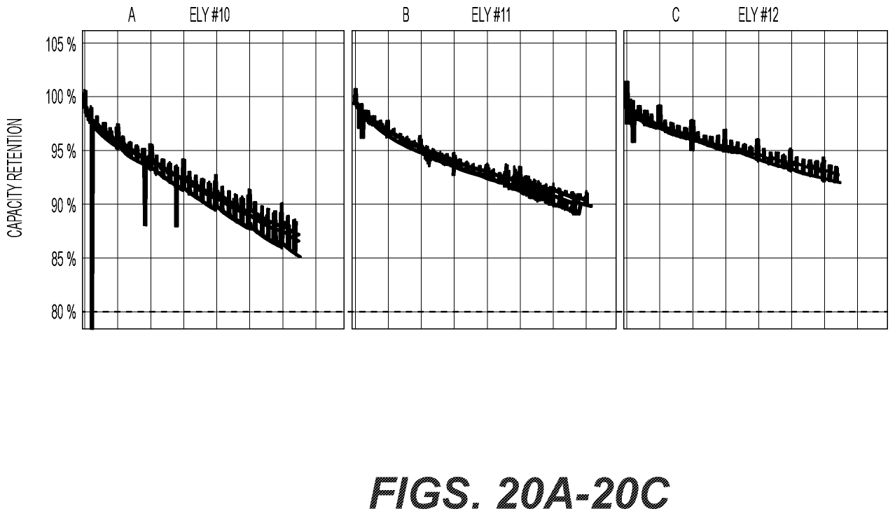

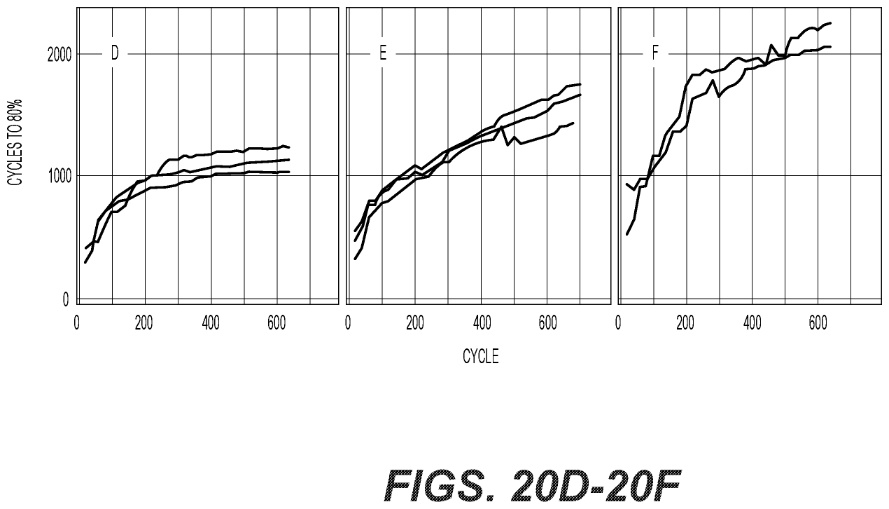

FIGS. 20A, 20B, 20C, 20D, 20E, and 20F show cycle life test results of Li-ion battery test cells comprising electrolytes ELY #10, 11, and 12. FIGS. 20A, 20B, and 20C are graphical plots of the capacity retention (in % of initial capacity) as a function of cycle number, for Li-ion battery cells comprising ELY #10, #11, and #12, respectively. FIGS. 20D, 20E, and 20F are graphical plots of the estimated number of cycles to 80% of initial capacity as a function of cycle number, for Li-ion battery cells comprising ELY #10, #11, and #12, respectively. ELY #10, #11, and #12 are examples of electrolytes comprising at least one cyclic carbonate and a branched ester.

The above-described exemplary nanocomposite particles (e.g., anode or cathode particles) may generally be of any shape (e.g., near-spherical or a spheroidal or an ellipsoid (e.g., including oblate spheroid), cylindrical, plate-like, have a random shape, etc.) and of any size. The maximum size of the particle may depend on the rate performance requirements, on the rate of the ion diffusion into the partially filled particles, and/or on other parameters. For most applications, the average diffusion distance from the solid-electrolyte interphase (e.g., from the surface of the composite particles) to the inner core of the composite particles may be smaller than about 10 microns for the optimal performance.

Some aspects of this disclosure may also be applicable to conventional intercalation-type electrodes (e.g., lower voltage cathodes) and provide benefits of improved rate performance or improved stability, particularly for electrodes with medium and high-capacity loadings (e.g., greater than about 3-4 mAh/cm²).

In the detailed description above it may be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. An electrolyte for a lithium-ion battery, comprising: a primary lithium salt; and a solvent composition comprising fluoroethylene carbonate (FEC), at least one linear ester, and at least one branched ester; wherein: a mole fraction of the FEC in the electrolyte is in a range of about 2 mol. % to about 30 mol. %; a total mole fraction of the at least one linear ester and the at least one branched ester in the electrolyte is at least about 45 mol. %; a molar ratio of the at least one linear ester to the at least one branched ester is in a range of about 1:10 to about 20:1; and the electrolyte is substantially free of four-carbon cyclic carbonates.

Clause 2. The electrolyte of clause 1, wherein the total mole fraction of the at least one linear ester and the at least one branched ester in the electrolyte is in a range of about 60 mol. % to about 75 mol. %.

Clause 3. The electrolyte of any of clauses 1 to 2, wherein the molar ratio of the at least one linear ester to the at least one branched ester is in a range of about 1:1 to about 2:1.

Clause 4. The electrolyte of any of clauses 1 to 3, wherein the at least one linear ester is selected from methyl acetate (MA), methyl propionate (MP), methyl butyrate (MB), ethyl acetate (EA), ethyl propionate (EP), ethyl butyrate (EB), propyl acetate (PA), propyl propionate (PP), propyl butyrate (PB), butyl acetate (BA), butyl propionate (BP), and butyl butyrate (BB).

Clause 5. The electrolyte of any of clauses 1 to 4, wherein the at least one branched ester is selected from methyl isobutyrate (MI), methyl trimethyl acetate (MT), methyl isovalerate (MIV), methyl 2-methylbutyrate (MMB), ethyl isobutyrate (EI), ethyl trimethylacetate (ET), ethyl isovalerate (EIV), ethyl 2-methylbutyrate (EMB), propyl isobutyrate (PI), propyl trimethylacetate (PT), propyl isovalerate (PIV), propyl 2-methylbutyrate (PMB), butyl isobutyrate (BI), butyl trimethylacetate (BT), butyl isovalerate (BIV), butyl 2-methylbutyrate (BMB), isopropyl acetate (IPA), isopropyl propionate (IPP), isopropyl butyrate (IPB), isopropyl isobutyrate (IPI), isopropyl trimethylacetate (IPT), isopropyl isovalerate (IPIV), isopropyl 2-methylbutyrate (IPMB), tert-butyl acetate (TBA), tert-butyl propionate (TBP), tert-butyl butyrate (TBB), tert-butyl isobutyrate (TBI), tert-butyl trimethylacetate (TBT), tert-butyl isovalerate (TBIV), tert-butyl 2-methylbutyrate (TBMB), isobutyl acetate (IBA), isobutyl propionate (IBP), isobutyl butyrate (IBB), isobutyl isobutyrate (IBI), isobutyl trimethylacetate (IBT), isobutyl isovalerate (IBIV), and isobutyl 2-methylbutyrate (IBMB).

Clause 6. The electrolyte of any of clauses 1 to 5, wherein the at least one linear ester is ethyl propionate (EP) and the at least one branched ester is ethyl isobutyrate (EI) and/or ethyl isovalerate (EIV).

Clause 7. The electrolyte of any of clauses 1 to 6, wherein the electrolyte is substantially free of diethyl carbonate, dimethyl carbonate, and ethyl methyl carbonate.

Clause 8. The electrolyte of any of clauses 1 to 7, wherein the primary lithium salt is LiPF₆.

Clause 9. The electrolyte of clause 8, wherein a mole fraction of the primary lithium salt in the electrolyte is in a range from about 6 mol. % to about 20 mol. %.

Clause 10. The electrolyte of any of clauses 1 to 9, further comprising: one or more charge-transfer additives selected from the following: lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB).

Clause 11. The electrolyte of clause 10, wherein the one or more charge-transfer additives comprise the lithium difluorophosphate (LFO), the lithium tetrafluoroborate (LiBF₄), the lithium bis(fluorosulfonyl)imide (LiFSI), and the lithium difluoro(oxalato)borate (LiDFOB).

Clause 12. The electrolyte of any of clauses 10 to 11, wherein a mole fraction of the one or more charge-transfer additives in the electrolyte is in a range of about 0.1 mol. % to about 6 mol. %.

Clause 13. The electrolyte of clause 12, wherein the mole fraction of the one or more charge-transfer additives is in a range of about 0.5 mol. % to about 1.5 mol. %.

Clause 14. The electrolyte of any of clauses 1 to 13, further comprising: one or more high-temperature storage additives selected from adiponitrile, 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile, 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether, 3-(triethoxysilyl) propionitrile, succinonitrile, benzonitrile, 4-(trifluoromethyl) benzonitrile, 1,2,2,3-propanetetracarbonitrile, triisopropyl borate, 1-propene 1,3-sultone, 1,3-propanesultone, phenyl disulfide, sulfolane, N,N,N,N-tetraethyl sulfamide, succinic anhydride, maleic anhydride, tris(trimethylsilyl)phosphite, tris(trimethylsilyl)phosphate, dimethoxydiphenylsilane, tris(trimethylsilyl) borate, 3-(triethoxysilyl)propyl isocyanate, 1,3,2-dioxathiolane 2,2-dioxide (DTD), and methylene methanedisulfonate (MMDS).

Clause 15. The electrolyte of clause 14, wherein a mole fraction of the one or more high-temperature storage additives in the electrolyte is in a range of about 0.1 mol. % to about 3 mol. %.

Clause 16. The electrolyte of any of clauses 1 to 15, further comprising: at least one non-FEC cyclic carbonate selected from ethylene carbonate and vinylene carbonate.

Clause 17. The electrolyte of clause 16, wherein a mole fraction of the at least one non-FEC cyclic carbonate in the electrolyte is in a range of about 0.5 mol. % to about 30 mol. %.

Clause 18. The electrolyte of clause 17, wherein the mole fraction of the at least one non-FEC cyclic carbonate in the electrolyte is in a range of about 1 mol. % to about 6 mol. %.

Clause 19. A lithium-ion battery, comprising: an anode current collector; a cathode current collector; an anode disposed on and/or in the anode current collector; a cathode disposed on and/or in the cathode current collector; and the electrolyte of any of clauses 1 to 18 ionically coupling the anode and the cathode.

Clause 20. The lithium-ion battery of clause 19, wherein: the anode comprises a mixture of (A) silicon-comprising particles comprising silicon and carbon, and (B) graphitic carbon particles comprising carbon and being substantially free of silicon; and a mass of the silicon is in a range of about 1.5 wt. % to about 60 wt. % of a total mass of the anode.

Clause 21. An electrolyte for a lithium-ion battery, comprising: a primary lithium salt; and a solvent composition comprising fluoroethylene carbonate (FEC), at least one ester, and at least one non-FEC cyclic carbonate; wherein: a mole fraction of the FEC in the electrolyte is in a range of about 2 mol. % to about 30 mol. %; a total mole fraction of the at least one ester in the electrolyte is at least about 40 mol. %; a total mole fraction of the at least one non-FEC cyclic carbonate in the electrolyte is in a range of about 0.5 mol. % to about 30 mol. %; and the electrolyte is substantially free of four-carbon cyclic carbonates.

Clause 22. The electrolyte of clause 21, wherein the total mole fraction of the at least one ester in the electrolyte is in a range of about 45 mol. % to about 70 mol. %.

Clause 23. The electrolyte of any of clauses 21 to 22, wherein a molar ratio of the at least one ester to the at least one non-FEC cyclic carbonate is in a range of about 1.5:1 to about 20:1.

Clause 24. The electrolyte of any of clauses 21 to 23, wherein the at least one ester is selected from methyl acetate (MA), methyl propionate (MP), methyl butyrate (MB), ethyl acetate (EA), ethyl propionate (EP), ethyl butyrate (EB), propyl acetate (PA), propyl propionate (PP), propyl butyrate (PB), butyl acetate (BA), butyl propionate (BP), butyl butyrate (BB), methyl isobutyrate (MI), methyl trimethyl acetate (MT), methyl isovalerate (MIV), methyl 2-methylbutyrate (MMB), ethyl isobutyrate (EI), ethyl trimethylacetate (ET), ethyl isovalerate (EIV), ethyl 2-methylbutyrate (EMB), propyl isobutyrate (PI), propyl trimethylacetate (PT), propyl isovalerate (PIV), propyl 2-methylbutyrate (PMB), butyl isobutyrate (BI), butyl trimethylacetate (BT), butyl isovalerate (BIV), butyl 2-methylbutyrate (BMB), isopropyl acetate (IPA), isopropyl propionate (IPP), isopropyl butyrate (IPB), isopropyl isobutyrate (IPI), isopropyl trimethylacetate (IPT), isopropyl isovalerate (IPIV), isopropyl 2-methylbutyrate (IPMB), tert-butyl acetate (TBA), tert-butyl propionate (TBP), tert-butyl butyrate (TBB), tert-butyl isobutyrate (TBI), tert-butyl trimethylacetate (TBT), tert-butyl isovalerate (TBIV), tert-butyl 2-methylbutyrate (TBMB), isobutyl acetate (IBA), isobutyl propionate (IBP), isobutyl butyrate (IBB), isobutyl isobutyrate (IBI), isobutyl trimethylacetate (IBT), isobutyl isovalerate (IBIV), and isobutyl 2-methylbutyrate (IBMB).

Clause 25. The electrolyte of clause 24, wherein the at least one ester comprises the ethyl acetate (EA), the ethyl propionate (EP), the ethyl isobutyrate (EI), and/or the ethyl isovalerate (EIV).

Clause 26. The electrolyte of any of clauses 24 to 25, wherein the at least one ester comprises a mixture of the ethyl acetate (EA) and the ethyl propionate (EP).

Clause 27. The electrolyte of any of clauses 21 to 26, wherein the at least one non-FEC cyclic carbonate is selected from ethylene carbonate and vinylene carbonate.

Clause 28. The electrolyte of any of clauses 21 to 27, wherein the electrolyte is substantially free of diethyl carbonate, dimethyl carbonate, and ethyl methyl carbonate.

Clause 29. The electrolyte of any of clauses 21 to 28, wherein the primary lithium salt is LiPF₆.

Clause 30. The electrolyte of clause 29, wherein a mole fraction of the primary lithium salt in the electrolyte is in a range from about 6 mol. % to about 20 mol. %.

Clause 31. The electrolyte of any of clauses 21 to 30, further comprising: one or more charge-transfer additives selected from lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB).

Clause 32. The electrolyte of clause 31, wherein the one or more charge-transfer additives comprise the lithium difluorophosphate (LFO), the lithium tetrafluoroborate (LiBF₄), the lithium bis(fluorosulfonyl)imide (LiFSI), and the lithium difluoro(oxalato)borate (LiDFOB).

Clause 33. The electrolyte of any of clauses 31 to 32, wherein a mole fraction of the one or more charge-transfer additives in the electrolyte is in a range of about 0.1 mol. % to about 6 mol. %.

Clause 34. The electrolyte of clause 33, wherein the mole fraction of the one or more charge-transfer additives is in a range of about 0.5 mol. % to about 1.5 mol. %.

Clause 35. The electrolyte of any of clauses 21 to 34, further comprising: one or more high-temperature storage additives selected from adiponitrile, 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile, 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether, 3-(triethoxysilyl) propionitrile, succinonitrile, benzonitrile, 4-(trifluoromethyl) benzonitrile, 1,2,2,3-propanetetracarbonitrile, triisopropyl borate, 1-propene 1,3-sultone, 1,3-propanesultone, phenyl disulfide, sulfolane, N,N,N,N-tetraethyl sulfamide, succinic anhydride, maleic anhydride, tris(trimethylsilyl)phosphite, tris(trimethylsilyl)phosphate, dimethoxydiphenylsilane, tris(trimethylsilyl) borate, 3-(triethoxysilyl)propyl isocyanate, 1,3,2-dioxathiolane 2,2-dioxide (DTD), and methylene methanedisulfonate (MMDS).

Clause 36. The electrolyte of clause 35, wherein a mole fraction of the one or more high-temperature storage additives in the electrolyte is in a range of about 0.1 mol. % to about 3 mol. %.

Clause 37. A lithium-ion battery, comprising: an anode current collector; a cathode current collector; an anode disposed on and/or in the anode current collector; a cathode disposed on and/or in the cathode current collector; and the electrolyte of clause 21 ionically coupling the anode and the cathode.

Clause 38. The lithium-ion battery of clause 37, wherein: the anode comprises a mixture of (A) silicon-comprising particles comprising silicon and carbon, and (B) graphitic carbon particles comprising carbon and being substantially free of silicon; and a mass of the silicon is in a range of about 1.5 wt. % to about 60 wt. % of a total mass of the anode.

Clause 39. The lithium-ion battery of any of clauses 37 to 38, wherein: the anode comprises graphitic carbon particles comprising carbon and being substantially free of silicon.

Clause 40. An electrolyte for a lithium-ion battery, comprising: a primary lithium salt; and a solvent composition comprising fluoroethylene carbonate (FEC) and at least one linear carbonate; wherein: a mole fraction of the FEC in the electrolyte is in a range of about 2 mol. % to about 20 mol. %; a total mole fraction of the at least one linear carbonate in the electrolyte is at least 40 mol. %; the electrolyte is substantially free of four-carbon cyclic carbonates; and the electrolyte is substantially free of any linear carbonate of molecular weight greater than 117.

Clause 41. The electrolyte of clause 40, wherein: the at least one linear carbonate is selected from ethyl methyl carbonate and dimethyl carbonate; and the total mole fraction of the at least one linear carbonate in the electrolyte is in a range of about 60 mol. % to about 75 mol. %.

Clause 42. The electrolyte of any of clauses 39 to 41, wherein the primary lithium salt is LiPF₆.

Clause 43. The electrolyte of any of clauses 41 to 42, wherein a mole fraction of the primary lithium salt in the electrolyte is in a range from about 6 mol. % to about 20 mol. %.

Clause 44. The electrolyte of any of clauses 40 to 43, further comprising: one or more charge-transfer additives selected from lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB).

Clause 45. The electrolyte of clause 44, wherein the one or more charge-transfer additives comprise the lithium difluorophosphate (LFO), the lithium tetrafluoroborate (LiBF₄), the lithium bis(fluorosulfonyl)imide (LiFSI), and/or the lithium difluoro(oxalato)borate (LiDFOB)

Clause 46. The electrolyte of any of clauses 44 to 45, wherein a mole fraction of the one or more charge-transfer additives in the electrolyte is in a range of about 0.1 mol. % to about 6 mol. %.

Clause 47. The electrolyte of clause 46, wherein the mole fraction of the one or more charge-transfer additives is in a range of about 0.5 mol. % to about 1.5 mol. %.

Clause 48. The electrolyte of any of clauses 40 to 47, further comprising: one or more high-temperature storage additives selected from adiponitrile, 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile, 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether, 3-(triethoxysilyl) propionitrile, succinonitrile, benzonitrile, 4-(trifluoromethyl) benzonitrile, 1,2,2,3-propanetetracarbonitrile, triisopropyl borate, 1-propene 1,3-sultone, 1,3-propanesultone, phenyl disulfide, sulfolane, N,N,N,N-tetraethyl sulfamide, succinic anhydride, maleic anhydride, tris(trimethylsilyl)phosphite, tris(trimethylsilyl)phosphate, dimethoxydiphenylsilane, tris(trimethylsilyl) borate, 3-(triethoxysilyl)propyl isocyanate, 1,3,2-dioxathiolane 2,2-dioxide (DTD), and methylene methanedisulfonate (MMDS).

Clause 49. The electrolyte of clause 48, wherein a mole fraction of the one or more high-temperature storage additives in the electrolyte is in a range of about 0.1 mol. % to about 3 mol. %.

Clause 50. The electrolyte of any of clauses 40 to 49, further comprising: at least one non-FEC cyclic carbonate selected from ethylene carbonate and vinylene carbonate.

Clause 51. The electrolyte of clause 50, wherein a mole fraction of the at least one non-FEC cyclic carbonate in the electrolyte is in a range of about 1 mol. % to about 30 mol. %.

Clause 52. The electrolyte of clause 51, wherein the mole fraction of the at least one non-FEC cyclic carbonate in the electrolyte is in a range of about 15 mol. % to about 30 mol. %.

Clause 53. A lithium-ion battery, comprising: an anode current collector; a cathode current collector; an anode disposed on and/or in the anode current collector; a cathode disposed on and/or in the cathode current collector; and the electrolyte of clause 40 ionically coupling the anode and the cathode.

Clause 54. The lithium-ion battery of clause 53, wherein: the anode comprises a mixture of (A) silicon-comprising particles comprising silicon and carbon, and (B) graphitic carbon particles comprising carbon and being substantially free of silicon; and a mass of the silicon is in a range of about 1.5 wt. % to about 60 wt. % of a total mass of the anode.

Clause 55. An electrolyte for a lithium-ion battery, comprising: a primary lithium salt; and a solvent composition comprising at least one three-carbon cyclic carbonate and ethyl trimethylacetate (ET); wherein: the at least one three-carbon cyclic carbonate comprises ethylene carbonate (EC); a mole fraction of the ET in the electrolyte is at least about 50 mol. %; and the electrolyte is substantially free of four-carbon cyclic carbonates.

Clause 56. The electrolyte of clause 55, wherein the mole fraction of the ET in the electrolyte is in a range of about 50 mol. % to about 80 mol. %.

Clause 57. The electrolyte of any of clauses 55 to 56, wherein the primary lithium salt is LiPF₆.

Clause 58. The electrolyte of clause 57, wherein a mole fraction of the primary lithium salt in the electrolyte is in a range from about 6 mol. % to about 20 mol. %.

Clause 59. The electrolyte of any of clauses 55 to 58, wherein a mole fraction of the at least one three-carbon cyclic carbonate in the electrolyte is in a range of about 20 mol. % to about 40 mol. %.

Clause 60. The electrolyte of any of clauses 55 to 59, wherein the at least one three-carbon cyclic carbonate comprises fluoroethylene carbonate (FEC) and/or vinylene carbonate.

Clause 61. The electrolyte of any of clauses 55 to 60, wherein the electrolyte is substantially free of linear carbonates.

Clause 62. A lithium-ion battery, comprising: an anode current collector; a cathode current collector; an anode disposed on and/or in the anode current collector; a cathode disposed on and/or in the cathode current collector; and the electrolyte of clause 55 ionically coupling the anode and the cathode.

Clause 63. The lithium-ion battery of clause 62, wherein: the anode comprises graphitic carbon particles comprising carbon and being substantially free of silicon.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. An electrolyte for a lithium-ion battery, comprising:
a primary lithium salt; and
a solvent composition comprising fluoroethylene carbonate (FEC), at least one linear ester, and at least one branched ester;
wherein:
a mole fraction of the FEC in the electrolyte is in a range of about 2 mol. % to about 30 mol. %;
a total mole fraction of the at least one linear ester and the at least one branched ester in the electrolyte is at least about 45 mol. %;
a molar ratio of the at least one linear ester to the at least one branched ester is in a range of about 1:10 to about 20:1; and
the electrolyte is substantially free of four-carbon cyclic carbonates.

2. The electrolyte of claim 1, wherein the total mole fraction of the at least one linear ester and the at least one branched ester in the electrolyte is in a range of about 60 mol. % to about 75 mol. %.

3. The electrolyte of claim 1, wherein the molar ratio of the at least one linear ester to the at least one branched ester is in a range of about 1:1 to about 2:1.

4. The electrolyte of claim 1, wherein the at least one linear ester is selected from methyl acetate (MA), methyl propionate (MP), methyl butyrate (MB), ethyl acetate (EA), ethyl propionate (EP), ethyl butyrate (EB), propyl acetate (PA), propyl propionate (PP), propyl butyrate (PB), butyl acetate (BA), butyl propionate (BP), and butyl butyrate (BB).

5. The electrolyte of claim 1, wherein the at least one branched ester is selected from methyl isobutyrate (MI), methyl trimethyl acetate (MT), methyl isovalerate (MIV), methyl 2-methylbutyrate (MMB), ethyl isobutyrate (EI), ethyl trimethylacetate (ET), ethyl isovalerate (EIV), ethyl 2-methylbutyrate (EMB), propyl isobutyrate (PI), propyl trimethylacetate (PT), propyl isovalerate (PIV), propyl 2-methylbutyrate (PMB), butyl isobutyrate (BI), butyl trimethylacetate (BT), butyl isovalerate (BIV), butyl 2-methylbutyrate (BMB), isopropyl acetate (IPA), isopropyl propionate (IPP), isopropyl butyrate (IPB), isopropyl isobutyrate (IPI), isopropyl trimethylacetate (IPT), isopropyl isovalerate (IPIV), isopropyl 2-methylbutyrate (IPMB), tert-butyl acetate (TBA), tert-butyl propionate (TBP), tert-butyl butyrate (TBB), tert-butyl isobutyrate (TBI), tert-butyl trimethylacetate (TBT), tert-butyl isovalerate (TBIV), tert-butyl 2-methylbutyrate (TBMB), isobutyl acetate (IBA), isobutyl propionate (IBP), isobutyl butyrate (IBB), isobutyl isobutyrate (IBI), isobutyl trimethylacetate (IBT), isobutyl isovalerate (IBIV), and isobutyl 2-methylbutyrate (IBMB).

6. The electrolyte of claim 1, wherein the at least one linear ester is ethyl propionate (EP) and the at least one branched ester is ethyl isobutyrate (EI) and/or ethyl isovalerate (EIV).

7. The electrolyte of claim 1, wherein the electrolyte is substantially free of diethyl carbonate, dimethyl carbonate, and ethyl methyl carbonate.

8. The electrolyte of claim 1, wherein the primary lithium salt is LiPF₆.

9. The electrolyte of claim 8, wherein a mole fraction of the primary lithium salt in the electrolyte is in a range from about 6 mol. % to about 20 mol. %.

10. The electrolyte of claim 1, further comprising:
one or more charge-transfer additives selected from the following: lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB).

11. The electrolyte of claim 10, wherein the one or more charge-transfer additives comprise the lithium difluorophosphate (LFO), the lithium tetrafluoroborate (LiBF₄), the lithium bis(fluorosulfonyl)imide (LiFSI), and the lithium difluoro(oxalato)borate (LiDFOB).

12. The electrolyte of claim 10, wherein a mole fraction of the one or more charge-transfer additives in the electrolyte is in a range of about 0.1 mol. % to about 6 mol. %.

13. The electrolyte of claim 12, wherein the mole fraction of the one or more charge-transfer additives is in a range of about 0.5 mol. % to about 1.5 mol. %.

14. The electrolyte of claim 1, further comprising:
one or more high-temperature storage additives selected from adiponitrile, 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile, 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether, 3-(triethoxysilyl) propionitrile, succinonitrile, benzonitrile, 4-(trifluoromethyl) benzonitrile, 1,2,2,3-propanetetracarbonitrile, triisopropyl borate, 1-propene 1,3-sultone, 1,3-propanesultone, phenyl disulfide, sulfolane, N,N,N,N-tetraethyl sulfamide, succinic anhydride, maleic anhydride, tris(trimethylsilyl)phosphite, tris(trimethylsilyl)phosphate, dimethoxydiphenylsilane, tris(trimethylsilyl) borate, 3-(triethoxysilyl)propyl isocyanate, 1,3,2-dioxathiolane 2,2-dioxide (DTD), and methylene methanedisulfonate (MMDS).

15. The electrolyte of claim 14, wherein a mole fraction of the one or more high-temperature storage additives in the electrolyte is in a range of about 0.1 mol. % to about 3 mol. %.

16. The electrolyte of claim 1, further comprising:
at least one non-FEC cyclic carbonate selected from ethylene carbonate and vinylene carbonate.

17. The electrolyte of claim 16, wherein a mole fraction of the at least one non-FEC cyclic carbonate in the electrolyte is in a range of about 0.5 mol. % to about 30 mol. %.

18. The electrolyte of claim 17, wherein the mole fraction of the at least one non-FEC cyclic carbonate in the electrolyte is in a range of about 1 mol. % to about 6 mol. %.

19. A lithium-ion battery, comprising:
an anode current collector;
a cathode current collector;
an anode disposed on and/or in the anode current collector;
a cathode disposed on and/or in the cathode current collector; and
the electrolyte of claim 1 ionically coupling the anode and the cathode.

20. The lithium-ion battery of claim 19, wherein:
the anode comprises a mixture of (A) silicon-comprising particles comprising silicon and carbon, and (B) graphitic carbon particles comprising carbon and being substantially free of silicon; and
a mass of the silicon is in a range of about 1.5 wt. % to about 60 wt. % of a total mass of the anode.

21. An electrolyte for a lithium-ion battery, comprising:
a primary lithium salt; and
a solvent composition comprising fluoroethylene carbonate (FEC), at least one ester, and at least one non-FEC cyclic carbonate;
wherein:
a mole fraction of the FEC in the electrolyte is in a range of about 2 mol. % to about 30 mol. %;
a total mole fraction of the at least one ester in the electrolyte is at least about 40 mol. %;
a total mole fraction of the at least one non-FEC cyclic carbonate in the electrolyte is in a range of about 0.5 mol. % to about 30 mol. %; and
the electrolyte is substantially free of four-carbon cyclic carbonates.

22. The electrolyte of claim 21, wherein the total mole fraction of the at least one ester in the electrolyte is in a range of about 45 mol. % to about 70 mol. %.

23. The electrolyte of claim 21, wherein a molar ratio of the at least one ester to the at least one non-FEC cyclic carbonate is in a range of about 1.5:1 to about 20:1.

24. The electrolyte of claim 21, wherein the at least one ester is selected from methyl acetate (MA), methyl propionate (MP), methyl butyrate (MB), ethyl acetate (EA), ethyl propionate (EP), ethyl butyrate (EB), propyl acetate (PA), propyl propionate (PP), propyl butyrate (PB), butyl acetate (BA), butyl propionate (BP), butyl butyrate (BB), methyl isobutyrate (MI), methyl trimethyl acetate (MT), methyl isovalerate (MIV), methyl 2-methylbutyrate (MMB), ethyl isobutyrate (EI), ethyl trimethylacetate (ET), ethyl isovalerate (EIV), ethyl 2-methylbutyrate (EMB), propyl isobutyrate (PI), propyl trimethylacetate (PT), propyl isovalerate (PIV), propyl 2-methylbutyrate (PMB), butyl isobutyrate (BI), butyl trimethylacetate (BT), butyl isovalerate (BIV), butyl 2-methylbutyrate (BMB), isopropyl acetate (IPA), isopropyl propionate (IPP), isopropyl butyrate (IPB), isopropyl isobutyrate (IPI), isopropyl trimethylacetate (IPT), isopropyl isovalerate (IPIV), isopropyl 2-methylbutyrate (IPMB), tert-butyl acetate (TBA), tert-butyl propionate (TBP), tert-butyl butyrate (TBB), tert-butyl isobutyrate (TBI), tert-butyl trimethylacetate (TBT), tert-butyl isovalerate (TBIV), tert-butyl 2-methylbutyrate (TBMB), isobutyl acetate (IBA), isobutyl propionate (IBP), isobutyl butyrate (IBB), isobutyl isobutyrate (IBI), isobutyl trimethylacetate (IBT), isobutyl isovalerate (IBIV), and isobutyl 2-methylbutyrate (IBMB).

25. The electrolyte of claim 24, wherein the at least one ester comprises the ethyl acetate (EA), the ethyl propionate (EP), the ethyl isobutyrate (EI), and/or the ethyl isovalerate (EIV).

26. The electrolyte of claim 24, wherein the at least one ester comprises a mixture of the ethyl acetate (EA) and the ethyl propionate (EP).

27. The electrolyte of claim 21, wherein the at least one non-FEC cyclic carbonate is selected from ethylene carbonate and vinylene carbonate.

28. The electrolyte of claim 21, wherein the electrolyte is substantially free of diethyl carbonate, dimethyl carbonate, and ethyl methyl carbonate.

29. The electrolyte of claim 21, wherein the primary lithium salt is LiPF₆.

30. The electrolyte of claim 29, wherein a mole fraction of the primary lithium salt in the electrolyte is in a range from about 6 mol. % to about 20 mol. %.

31. The electrolyte of claim 21, further comprising:
one or more charge-transfer additives selected from lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB).

32. The electrolyte of claim 31, wherein the one or more charge-transfer additives comprise the lithium difluorophosphate (LFO), the lithium tetrafluoroborate (LiBF₄), the lithium bis(fluorosulfonyl)imide (LiFSI), and the lithium difluoro(oxalato)borate (LiDFOB).

33. The electrolyte of claim 31, wherein a mole fraction of the one or more charge-transfer additives in the electrolyte is in a range of about 0.1 mol. % to about 6 mol. %.

34. The electrolyte of claim 33, wherein the mole fraction of the one or more charge-transfer additives is in a range of about 0.5 mol. % to about 1.5 mol. %.

35. The electrolyte of claim 21, further comprising:
one or more high-temperature storage additives selected from adiponitrile, 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile, 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether, 3-(triethoxysilyl) propionitrile, succinonitrile, benzonitrile, 4-(trifluoromethyl) benzonitrile, 1,2,2,3-propanetetracarbonitrile, triisopropyl borate, 1-propene 1,3-sultone, 1,3-propanesultone, phenyl disulfide, sulfolane, N,N,N,N-tetraethyl sulfamide, succinic anhydride, maleic anhydride, tris(trimethylsilyl)phosphite, tris(trimethylsilyl)phosphate, dimethoxydiphenylsilane, tris(trimethylsilyl) borate, 3-(triethoxysilyl)propyl isocyanate, 1,3,2-dioxathiolane 2,2-dioxide (DTD), and methylene methanedisulfonate (MMDS).

36. The electrolyte of claim 35, wherein a mole fraction of the one or more high-temperature storage additives in the electrolyte is in a range of about 0.1 mol. % to about 3 mol. %.

37. A lithium-ion battery, comprising:
an anode current collector;
a cathode current collector;
an anode disposed on and/or in the anode current collector;
a cathode disposed on and/or in the cathode current collector; and
the electrolyte of claim 21 ionically coupling the anode and the cathode.

38. The lithium-ion battery of claim 37, wherein:
the anode comprises a mixture of (A) silicon-comprising particles comprising silicon and carbon, and (B) graphitic carbon particles comprising carbon and being substantially free of silicon; and
a mass of the silicon is in a range of about 1.5 wt. % to about 60 wt. % of a total mass of the anode.

39. The lithium-ion battery of claim 37, wherein:
the anode comprises graphitic carbon particles comprising carbon and being substantially free of silicon.

40. An electrolyte for a lithium-ion battery, comprising:
a primary lithium salt; and
a solvent composition comprising fluoroethylene carbonate (FEC) and at least one linear carbonate;
wherein:
a mole fraction of the FEC in the electrolyte is in a range of about 2 mol. % to about 20 mol. %;
a total mole fraction of the at least one linear carbonate in the electrolyte is at least 40 mol. %;
the electrolyte is substantially free of four-carbon cyclic carbonates; and
the electrolyte is substantially free of any linear carbonate of molecular weight greater than 117.

41. The electrolyte of claim 40, wherein:
the at least one linear carbonate is selected from ethyl methyl carbonate and dimethyl carbonate; and
the total mole fraction of the at least one linear carbonate in the electrolyte is in a range of about 60 mol. % to about 75 mol. %.

42. The electrolyte of claim 39, wherein the primary lithium salt is LiPF₆.

43. The electrolyte of claim 41, wherein a mole fraction of the primary lithium salt in the electrolyte is in a range from about 6 mol. % to about 20 mol. %.

44. The electrolyte of claim 40, further comprising:
one or more charge-transfer additives selected from lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB).

45. The electrolyte of claim 44, wherein the one or more charge-transfer additives comprise the lithium difluorophosphate (LFO), the lithium tetrafluoroborate (LiBF₄), the lithium bis(fluorosulfonyl)imide (LiFSI), and/or the lithium difluoro(oxalato)borate (LiDFOB).

46. The electrolyte of claim 44, wherein a mole fraction of the one or more charge-transfer additives in the electrolyte is in a range of about 0.1 mol. % to about 6 mol. %.

47. The electrolyte of claim 46, wherein the mole fraction of the one or more charge-transfer additives is in a range of about 0.5 mol. % to about 1.5 mol. %.

48. The electrolyte of claim 40, further comprising:
one or more high-temperature storage additives selected from adiponitrile, 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile, 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether, 3-(triethoxysilyl) propionitrile, succinonitrile, benzonitrile, 4-(trifluoromethyl) benzonitrile, 1,2,2,3-propanetetracarbonitrile, triisopropyl borate, 1-propene 1,3-sultone, 1,3-propanesultone, phenyl disulfide, sulfolane, N,N,N,N-tetraethyl sulfamide, succinic anhydride, maleic anhydride, tris(trimethylsilyl)phosphite, tris(trimethylsilyl)phosphate, dimethoxydiphenylsilane, tris(trimethylsilyl) borate, 3-(triethoxysilyl)propyl isocyanate, 1,3,2-dioxathiolane 2,2-dioxide (DTD), and methylene methanedisulfonate (MMDS).

49. The electrolyte of claim 48, wherein a mole fraction of the one or more high-temperature storage additives in the electrolyte is in a range of about 0.1 mol. % to about 3 mol. %.

50. The electrolyte of claim 40, further comprising:
at least one non-FEC cyclic carbonate selected from ethylene carbonate and vinylene carbonate.

51. The electrolyte of claim 50, wherein a mole fraction of the at least one non-FEC cyclic carbonate in the electrolyte is in a range of about 1 mol. % to about 30 mol. %.

52. The electrolyte of claim 51, wherein the mole fraction of the at least one non-FEC cyclic carbonate in the electrolyte is in a range of about 15 mol. % to about 30 mol. %.

53. A lithium-ion battery, comprising:
an anode current collector;
a cathode current collector;
an anode disposed on and/or in the anode current collector;
a cathode disposed on and/or in the cathode current collector; and
the electrolyte of claim 40 ionically coupling the anode and the cathode.

54. The lithium-ion battery of claim 53, wherein:
the anode comprises a mixture of (A) silicon-comprising particles comprising silicon and carbon, and (B) graphitic carbon particles comprising carbon and being substantially free of silicon; and
a mass of the silicon is in a range of about 1.5 wt. % to about 60 wt. % of a total mass of the anode.

55. An electrolyte for a lithium-ion battery, comprising:
a primary lithium salt; and
a solvent composition comprising at least one three-carbon cyclic carbonate and ethyl trimethylacetate (ET);
wherein:
the at least one three-carbon cyclic carbonate comprises ethylene carbonate (EC);
a mole fraction of the ET in the electrolyte is at least about 50 mol. %; and
the electrolyte is substantially free of four-carbon cyclic carbonates.

56. The electrolyte of claim 55, wherein the mole fraction of the ET in the electrolyte is in a range of about 50 mol. % to about 80 mol. %.

57. The electrolyte of claim 55, wherein the primary lithium salt is LiPF₆.

58. The electrolyte of claim 57, wherein a mole fraction of the primary lithium salt in the electrolyte is in a range from about 6 mol. % to about 20 mol. %.

59. The electrolyte of claim 55, wherein a mole fraction of the at least one three-carbon cyclic carbonate in the electrolyte is in a range of about 20 mol. % to about 40 mol. %.

60. The electrolyte of claim 55, wherein the at least one three-carbon cyclic carbonate comprises fluoroethylene carbonate (FEC) and/or vinylene carbonate.

61. The electrolyte of claim 55, wherein the electrolyte is substantially free of linear carbonates.

62. A lithium-ion battery, comprising:
an anode current collector;
a cathode current collector;
an anode disposed on and/or in the anode current collector;
a cathode disposed on and/or in the cathode current collector; and
the electrolyte of claim 55 ionically coupling the anode and the cathode.

63. The lithium-ion battery of claim 62, wherein:
the anode comprises graphitic carbon particles comprising carbon and being substantially free of silicon.
